(19) United States
(12) Patent Application Publication
(10) Pub. No.: US 2005/0063596 A1
(43) Pub. Date: Mar. 24, 2005

(54) Encoding of geometric modeled images

(76) Inventors: Yosef Yomdin, Rehovot (IL); Yoram Elichai, Ashdod (IL)

Correspondence Address: William H Dippert;Reed Smith, 29th Floor, 599 Lexington Avenue, New York, NY, 10022-7650, US

(21) Appl. No.: 10/496,536

(22) PCT Filed: Nov. 21, 2002
(86) PCT No.: PCT/IL02/00935

Related U.S. Application Data
(60) Provisional application No. 60/332,051, filed on Nov. 23, 2001.
(60) Provisional application No. 60/334,072, filed on Nov. 30, 2001.
(60) Provisional application No. 60/379,415, filed on May 13, 2002.

(51) Int. Cl. G06K 9/36

(52) U.S. Cl. 382/232

(57) ABSTRACT

A method of generating a character from an image. The method includes providing an image depicting a character, identifying, automatically by a processor, characteristic lines in the image, receiving an indication of a character to be cut from the image, and suggesting border lines for the character to be cut from the image, responsive to the identified characteristic lines and the received indication.

### RELATED APPLICATIONS

This application claims the benefit under 119 (e) of U.S. provisional patent application Nos. 60/239,912, 60/304,415, 60/310,486, 60/332,051, 60/334,072 and 60/379,415, filed Oct. 13, 2000, Jul. 12, 2001, Aug. 8, 2001, Nov. 23, 2001, Nov. 30, 2001, and May 13, 2002, respectively. This application is also a continuation-in-part of U.S. patent application Ser. No. 09/716,279 filed Nov. 21, 2000, Ser. No. 09/902,643 filed Jul. 12, 2001 and PCT patent applications PCT/IL01/00946, filed Oct. 11, 2001 and PCT/IL02/00563 and PCT/IL0200564, filed Jul. 11, 2002, which designate the US. The disclosures of all of these applications are incorporated herein by reference.

### FIELD OF THE INVENTION

The present invention relates to representation of images, for example for transmission and/or storage.

### BACKGROUND OF THE INVENTION

Images, animation and video streams generally require very large amounts of storage space and transmission bandwidth. For many applications, therefore, it is required to compress images in order to allow for their storage on small storage capacity apparatus and/or for transmission on low bandwidth communication links.

Existing methods of image representation, processing and compression, such as DCT transform and the JPEG compression standard, as well as various wavelet transforms and compression schemes, provide compression of realistic images. These image representation methods, however, do not achieve high compression ratios (typically they achieve a compression ratio of about one to ten for high image quality). In addition, there is generally no relation between the representation and the view of the image, such that any processing of the image requires extracting the image from the compressed representation. Current methods of image representation are based on linear transformations of the image to a certain basis, which contains initially the same numbers of elements as the number of pixels in the original image. Subsequent quantization and filtering reduce the number of parameters, but in an unpredictable fashion. Also, visual interpretation of these reduced number of parameters may be quite difficult.

Moreover, because video sequences represent exactly the motion of certain objects and patterns (i.e. geometric transformations of the initial scene), the DCT or the wavelets representations behave in an incoherent and unpredictable manner. Therefore, existing video compression techniques such as MPEG, use JPEG compression for the first frame, while performing the “motion compensation” on a pixel level and not on the compressed data. This results in a reduction in efficiency.

Color in images can be represented in various formats, such as the red, green and blue RGB) representation and the YIQ representation. The JPEG compression method uses the YIQ representation, which allows using lower numbers of bits in quantization.

Content oriented representation of images is well known in the art. There exist some partial content oriented representations, known as “vector formats” or vectorizations”. Vectorization is the representation of a visual image by geometric entities, like vectors, curves, representative points and the like. Vectorized image formats are usually significantly more compact and easier to process than conventional image formats, including pixels formats. Still, for transmission, for example on wireless networks, it is desired to compress these vector formats beyond their compact form. Standard compression methods, such as ZIP compression may be used, but generally compression methods specific to the implementation would achieve better results.

There currently are methods that incorporate limited vector formats, such as Macromedia's Flash and Shock Wave, W3C Scaleable Vector Graphics (SVG) and others. However, these vectorization methods provide cartoon-like images and animations and fail to represent high resolution photo realistic images of the real world.

Various types of skeletons are used in computer graphics, and especially in virtual reality applications. Generally, a skeleton of a graphic is formed of a plurality of “bones”, each of which is associated with a structure of the graphic. In order to describe movements, a controller states the movements to be applied to each bone and the associated structures are moved accordingly, by a computer handling the graphic.

Existing skeletons are applied in conjunction with specially constructed geometric-kinematical models of the graphic. Generally, it is the construction of such a model and its association with the realistic picture of the object (gluing texture) that requires the most costly efforts of skilled professionals.

The above mentioned problems, related to the conventional skeletons, make them generally inapplicable to 2D animations. Indeed, the necessity to construct an auxiliary kinematical structure, supporting the object motion, pushes skeletons completely into the world of complicated 3D models, like polygonal models.

Transmission and reconstruction of images and animations is widely used in numerous applications. Generally, various compression schemes are used in order to reduce the data volume transmitted. Reconstruction of the transmitted images and animations is performed by “players”, which decompress and playback the transmitted visual content. Especially important are applications of raster players in the Internet and Wireless Communications, because of their relative simplicity. One existing raster player is provided by Macromedia Flash products (as a part of Flash player for a combined Flash vector-raster format).

Various players, such as raster players are commonly used. These players display on a screen of the player, images and animations, formed by a background and by possibly overlapping foreground raster layers.

There are several major problems in application of existing Raster players. First of all, only very simple transformations of layers are used (mostly translations, rotations and resealing). As a result of this restriction, each layer, whose motion is not linear, has to be additionally subdivided into smaller sub-layers. Roughly one sub-layer is to be assigned to each part of the image, which moves approximately linearly. For example, to capture more or less realistically a human hand motion, dozens of independent layers generally need to be created. This fact prevents almost completely use of existing raster or vector tools for photo-realistic animations.

Since in practice animators use much smaller number of layers, than required, visual quality is strongly compromised.

Another basic problem of the existing raster players is that although the layers may overlap (and even may create an illusion of a 3D rotation), the images and the scenes produced remain basically “flat” and “cartoon-like”. There is no possibility to show full 3D motions of 3D objects with the existing raster players. As a result, completely different (much more complicated) players are used to reconstruct 3D motions of 3D objects. This problem prevents a wide usage of the 3D imaging on the Internet (and completely excludes 3D imaging from the world of wireless applications).

A whole new industry of animation and multimedia content creation companies operates in this field, and even a faster growth is expected. The field of computer animation is naturally divided into two parts: “high-end” animations, mostly used in movies production and in TV advertising, and “low-end” ones, mostly used in the Internet based applications and in the world of wireless communications.

The “high-end” animation works with photo-realistic characters and scenes and with high-quality cartoon-like animations. However, it requires months and years of work of highly qualified teams of animators and computer graphics specialists, and huge amounts of computer power and memory. Even today, after years of incredible growth in computer power, it remains completely a sovereign domain of a couple of huge companies far away of mass applications. Besides difficulties in preparation, enormous data volume of “high-end” animations makes them very difficult to use, and, in particular, keeps them completely out from the Internet and especially from the Wireless applications.

The “low-end” animation works with low-quality cartoon-like characters and scenes. Mostly it assumes a serious compromise on a quality of the desired visual content. However, even under these severe restrictions the existing animation tools, like Adobe's “Director” and Macromedia's “Flash”, require long hours of a tedious work of professional animators to prepare a short animation fragment. Also here the data volume of the resulting “low-end” animations is prohibitive for most of the today Internet and wireless applications, pushing them rather to the CD-ROM domain.

As a result, most of the companies today, which actively advertise on the Internet, deliberately avoid using any visual content, besides very small still pictures or tiny two-three frames animations. Otherwise it would take a long time to load their page, and it is well known in the field, that after 15 seconds of waiting most of the Internet users would rather go to another site. Also preparing of even simplest animation requires today a long and expensive work of imaging professionals. For the same reasons, active Computer Animation remains far away from the world of non-professionals.

Creation of virtual worlds is mostly considered at present as a completely different field (although animation of virtual characters is a central part in computer games and similar applications). The tools and methods here are completely different (mostly, polygon-based 3D representation, texture mapping etc.), but the situation is very similar to that with animation. On the “high-end” a rather good image quality can be achieved, but it requires a lot of work and huge data volumes. On the “low end” serious compromises on the quality are assumed, while the data volumes are still too high for the Internet applications. On both levels a long and expensive work of imaging professionals is required to prepare even simplest virtual scene.

Making animations from one or several pictures, paintings or photographs has been used for a long time, mainly in advertising and entertainment applications. However, it is still a hard and tedious task even for a skilled animator to make computer animation from a single 2D image. The main difficulties in animating of a photo-realistic character, given by a still image, are the following:
1. Character separation. In addition to the problems, mentioned above, usually not all the contours of the character are clearly seen on the image. Consequently, automatic edge detection helps only partly, and a tedious “handwork” is required to complete these contours. Moreover, a skill of a professional painter is necessary to preserve the image quality in this process.
2. The position of the character and its pose usually are quite complicated and prevent an easy reconstruction: some parts of the body occlude others, the clothes patterns are normally quite different form those of the body, etc. Here even skilled animators give up and look for simpler positions.
3. The animation itself (using conventional tools) requires separation of each moving part, and then determining the key-frame positions for each of these parts separately. Clearly, the above professional skill requirements are essential at this stage. Moreover, absence of a unifying model of the whole character makes it virtually impossible to use previously prepared animations.

### SUMMARY OF THE INVENTION

An aspect of some embodiments of the invention relates to a semi-automatic tool for cutting an object out of an image. The tool allows a user to draw a border line around an object to be cut out from a picture. Based on a comparison of a segment of a border line drawn by the user and characteristic lines in the image, the tool suggests one or more possible continuation paths for the line segment. Optionally, in at least some cases the tool suggests a plurality of paths, so that the user may choose the most suitable path. If one of the suggested paths follows the border line desired by the user, the user may select that path and the tool automatically fills in an additional segment of the border line, responsive to the selection.

The suggested paths are optionally displayed when a characteristic line is found to coincide or be closely parallel to the segment drawn by the user.

In some embodiments of the invention, each suggested path is associated with an indication of an extent to which the path is recommended. Optionally, the recommendation level of a line increases with the separation extent of the line, i.e., the color difference between the line and its surrounding. The indication of the recommendation is optionally in the form of the thickness of the line of the suggested path and/or a text or number label.

In some embodiments of the invention, when there is a small gap between two suggested characteristic lines, the tool suggests a segment between the lines which will close the gap. The suggested segment optionally has a similar curvature to that of the connected lines.

In some embodiments of the invention, the user may request that the characteristic lines be displayed overlaid on the image. The user may select segments of the characteristic lines.

In some embodiments of the invention, the cut out object is completed into a raster image portion having a predetermined shape, for example a rectangular shape. Optionally, the pixels required for the completion are given a transparent color. The pixels within the cut-out object are given their original color and the pixels on the border are optionally given the color of the boundary line.

An aspect of some embodiments of the invention relates to a semi-automatic authoring tool for cutting an object, e.g., a character, out of a base image, and creating animation based on the image. A library character, referred to herein as a mold, is fitted (i.e., overlaid) by a user onto the character in the image. The character may designate a person, an animal or any other object. The fitting may include, for example, resealing, moving, rotating and/or stretching of part or all of the mold. After the mold is at least approximately fitted onto the image character, the tool optionally automatically performs fine tuning of the fit. Thereafter, based on size and shape of the mold and its fit to the character, the borders of the character are defined on the image, the character is broken up into separate limbs (referred to herein a layers), the separate limbs are completed in overlaying areas and/or depth is defined for the character. A skeleton of the mold is then optionally associated with the image character.

In some embodiments of the invention, the library mold is associated with one or more movement sequences which may be transferred to image characters with which the mold is associated. A user may instruct the semi-automatic tool to generate a video stream including a sequence of images that present a predetermined movement sequence from the library on the associated character.

Alternatively or additionally, the character from the image with which the mold is associated appears in a video stream designating movement of the character. Optionally, a user may instruct the authoring tool to fit the mold to the character in a sequence of frames of the stream. After identifying the borders of the character in the base image, the character is identified in further frames of the video stream for example using any video motion detection method known in the art. Based on the fitting of the mold to the character in the base image, the mold is optionally automatically fit to the character in the further frames of the image. The positioning of the mold in each of the frames of the sequence is compared in order to determine the movements of the character. Optionally, using interpolation, additional frames following the movement may be generated. Alternatively or additionally, the fitting of the mold to the character in further frames of the sequence is performed with the aid of the interpolation results. Alternatively or additionally, such fitting is used to extract a movement sequence from the image stream, which sequence may then be applied to other characters and/or molds, optionally with some user editing.

In some embodiments of the invention, display units optionally store the library molds. Data transmitted to the display units may optionally be stated relative to the molds.

An aspect of some embodiments of the invention relates to an animation tool for generating images. The animation tool allows a user to generate an image by indicating parameters of elements of a vector representation of the image. In some embodiments of the invention, the animation tool allows a user to indicate a color profile of a line and its surroundings.

A broad aspect of some embodiments of the invention relates to methods of compressing vector representations of images.

An aspect of some embodiments of the invention relates to a method of compressing a set of points of a representation of an image. The image is divided into a plurality of cells and for each cell the compressed format states whether the cell includes points or does not include points, optionally using only a single bit for each cell. The coordinates of each point are stated relative to the cell in which the point is located.

In some embodiments of the invention, the cells are rectangular shaped, optionally square shaped, for simplicity. Optionally, the width and length of the cells have sizes equal to a power of 2, allowing full utilization of the bits used to state the coordinates. In some embodiments of the invention, for simplicity, all the cells have the same size. Alternatively, some cells have different sizes than others, for example in order to cover an entire image which cannot be covered by cells of a single desired size.

Optionally, the size of the cells is selected according to the number of points in the image representation, such that on the average each cell has a predetermined number of points, e.g., 1, 2 or 0.5. In some embodiments of the invention, the same cell size is used, by a compression software, for all images compressed by the software. Alternatively, the software selects the cell arrangement to be used according to the number of points in the image currently being compressed, the distribution of the points and/or any other relevant parameter.

In some embodiments of the invention, the representation of the blocks in which the points are located is stated in a block hierarchy. For example, in a first, high, hierarchy level, the image is divided to 4 or 16 blocks, for each of which an indication is provided on whether the block includes any points. Those blocks which include points are divided into sub-blocks for which indications are provided on whether the sub-blocks include points. Optionally, whether to use of a block hierarchy is determined based on the distribution of the points in the image.

An aspect of some embodiments of the invention relates to a method of representing an image by lines and background points. Each line representation states the color of the area near the line, in addition to the color of the line itself. Background points indicate the background color in their vicinity. The color of each pixel of the image is interpolated from the background values of the lines and the background points. As is now described, the number of background points is optionally minimized in order to reduce the space required to state data of the background points.

In some embodiments of the invention, the image is divided into a grid of blocks, and for at least some of the blocks, background information is not recorded. Optionally, the blocks for which background information is not included, are blocks through which one or more lines pass. In some embodiments of the invention, any block through which a line passes does not include background points, and the background color in the block is extrapolated from the background information associated with the lines. Alternatively, background information is included for blocks that do not have at least a threshold length of lines passing through them and/or for blocks not including at least a predetermined number of lines.

Optionally, the background information includes one or more color values to be assigned to predetermined points within the block. Optionally, color values are given for a single central point of each block which does not have a line passing through the block. Stating the background color in a predetermined point, removes the need to state the coordinates of the point.

The color values of the blocks through which lines do not pass, are optionally stated in a continuous stream according to a predetermined order of blocks, without explicit matching of clocks and color values. This reduces the amount of data required for indicating the background points.

In some embodiments of the invention, the blocks which are not crossed by lines are indicated explicitly in the compressed image version. The explicit indication of the blocks not crossed by lines allows for exact knowledge of the blocks through which lines pass, without applying complex line determination algorithms. Optionally, the indication of the blocks through which lines pass is performed in a hierarchy, as described above. Alternatively, the blocks which are not crossed by lines are determined from the placement of the lines. In this alternative, there is no need to state for each block whether a line passes through it.

An aspect of some embodiments of the invention relates to a method of compressing a line of a geometrical image representation. The line is represented by a plurality of points and one or more geometrical parameters of segments of the line between each two points. In addition, one or more non-geometrical parameters of the line, such as color and/or color profile are stated for segments and/or points along the line. The one or more non-geometrical parameters of at least some of the segments are stated relative to parameters of one or more adjacent segments, rather than stating the absolute values of the parameters. In an exemplary embodiment of the invention, the parameters of a first segment of the line are stated explicitly, and the remaining parameters are stated relative to the parameters of the previous segment. In most cases, the values of at least some of the parameters of lines of images change gradually along the line and therefore the relative values are much smaller than the absolute values.

In some embodiments of the invention, all the parameters of the segment are stated relative to the previous segment. Alternatively, only some of the parameters of the segment are stated relative to the adjacent segments and the remaining parameters are stated explicitly. In some embodiments of the invention, the parameters stated with absolute values and the parameters stated relative to other segments is predetermined. Optionally, parameters which generally have similar values for adjacent segments are described using relative values, while parameters which are not generally similar in adjacent segments are stated explicitly. In some embodiments of the invention, the parameters stated relative to other segments are the same for all images. Alternatively, for each image, the parameters to be stated relative to other segments are selected separately. Further alternatively, for each line, segment and/or parameter it is determined separately whether to state a relative value or an absolute value. Optionally, when the difference has a small value which is generally not noticed by humans, the difference is ignored and is set to zero. Alternatively or additionally, depending on the compression level required, a threshold is set beneath which differences are ignored.

The line parameters may include, for example, one or more parameters of the segment curve (e.g., a height above the straight line connecting the end-points of the segment), a line color and/or one or more parameters of a line profile, as in the VIM image representation.

In some embodiments of the invention, a compression tool selects the points of the line defining the segments, such that as large a number as possible of segments have values close to the previous segment. Optionally, the compression tool examines a plurality of different possible segmentations of a line and for each possible segmentation determines the resulting compressed size of the line. The segmentation resulting in the smallest compressed size is optionally selected. Alternatively or additionally, segmentation points are selected where there are large changes in one or more parameters of the line, such as an “unexpected” bend and/or a substantial change in color profile.

Optionally, different compression tools with different processing powers may be used to compress images. Optionally, a tool having a large processing power performs an optimal or close to optimal compression. A tool having a lower amount of processing power optionally examines a smaller number of possible segmentations. When the compression is performed by a low power tool, a predetermined segmentation is used and alternative segmentations are not examined. Thus, the extent of processing power spent on optimization is determined according to the available processing power of the compression tool.

In some embodiments of the invention, some lines are represented in a multi-level scheme. In a coarse representation of the line, the line is described with a small number of segments and/or a relatively low accuracy (small number of bits) of the segment parameters. In a fine representation of the line, the line is represented relative to the coarse representation.

An aspect of some embodiments of the invention relates to a format of representing an image using at least lines and background points. The quantization of the color values of the lines optionally has a higher accuracy than of background points.

An aspect of some embodiments of the invention relates to a method of representing an image, in which the number of bits used in representing the color of elements of a vector representation of the image depends on the sizes of the elements. In some embodiments of the invention, the quantization extent of lines and/or patches depends on their thickness. Optionally, thinner lines and/or patches are allotted fewer bits for representing their color.

In an exemplary embodiment of the invention, the number of levels in a gray scale image is adjusted according to line thickness. Alternatively or additionally, The quantization extent of the I and Q portions of the YIQ representation are adjusted according to line thickness. Optionally, for relatively thin lines, the I and Q portions are set to zero.

In some embodiments of the invention, different quantization change levels are applied for different colors and/or for different color representations, according to the discerning ability of the human eye.

An aspect of some embodiments of the invention relates to a format of representing an image using lines, in which a plurality of lines are located close to each other in accordance with a predetermined structure. The lines may be parallel lines, crossing lines perpendicular lines, splitting lines and/or lines that otherwise are adjacent each other.

Optionally, for example, substantially parallel lines are represented together by a single complex format line, having a profile which represents the lines and the background area between the lines. The use of the complex line optionally preserves at least some of the accuracy typically desired when two lines are close to each other, such that the lines do not combine into one thick line during decompression.

An aspect of some embodiments of the invention relates to a method of representing three dimensional objects using a vector image representation. The vector image representation optionally represents objects based on their view from a single angle, stating their projection on a plane together with a depth parameter. The three dimensional object is divided into a plurality of sub-objects, each of which can be projected on the screen plane in a one-to-one correlation, i.e., without folds. That is, no two points of the outer surface of the original object are included in the same sub-object if they are to be projected on the same point on the screen.

The sub-objects optionally have common edges and/or surfaces such that they form the original object. In some embodiments of the invention, the sub-objects are not necessarily located on parallel planes.

The number of sub-objects forming the object is very low, optionally fewer than 20, ten or even five sub-objects are used. In some embodiments of the invention, only two objects are used, a front object and a back object. Optionally, the sub-objects are very large, such that their shape is clearly viewed when they are displayed. In some embodiments of the invention, the geometrical and/or topological shape of each sub-object is complex, not necessarily having a flat plane shape.

In displaying the three dimensional object, the sub objects are optionally rotated as required and then the points of each of the sub-objects are projected onto the screen, with a depth indication. When a plurality of points are projected onto the same pixel of the screen, the point with the smallest depth prevails.

In some embodiments of the invention, some of the points of the object may have a semi-transparent color, for example, of glass. Alternatively or additionally, the object may include other image mixing effects, such as semi-transparent cloths or banners.

In an exemplary embodiment of the invention, a sphere is represented by two half spheres, a front sphere and a back sphere, connected at a common circle.

In some embodiments of the invention, a three dimensional object is generated from a single side image of the object. A user indicates depth values to the elements of the object as depicted by the image. Thereafter, a second layer, depicting a back side of the object is automatically generated from the image with depth values. In the back layer, the meeting points of the layers have same depth values, while the other points have mirror depth values, providing a mirror back side of the character.

A broad aspect of some embodiments of the invention relates to dropping from video streams transmitted to low processing power and/or low resolution display units, image elements which have relatively small effect on the displayed stream but a relatively large effect on the required transmission bandwidth.

An aspect of some embodiments of the invention relates to identifying within an image and/or a video stream, objects having a size smaller than a predetermined value, and replacing these objects with predetermined library objects in a lossy manner. Due to the small size of the replaced object, the amount of information lost is relatively small. The gain in the compression of the image is, on the other hand, relatively large, due to the regularity achieved by the elimination of the need to compress the small object. The lossy replacement is optionally performed by inserting a library object not identical to the replaced object.

The library objects may include, for example, a person object, an animal object and/or a ball object. Alternatively or additionally, a plurality of person objects may be defined, for example a child object, a male object and a female object. Further alternatively or additionally, different library objects depicting the same object from different angles (e.g., front, back and profile) may be defined. Similarly, a plurality of different animal objects may be defined. In some embodiments of the invention, the library objects are defined with one or more parameters, such as shirt color and/or pants color.

In some embodiments of the invention, the library objects are predetermined objects included in all transmitters and receivers using the method of the present aspect. Alternatively or additionally, one or more of the library objects are transmitted to the receiver at the beginning of a transmission session or at the first time the object is used. Alternatively or additionally, at the beginning of a transmission session an indication of a sub-group of objects to be used in the present session is stated, thus limiting the number of bit required in identifying library objects in a specific frame.

Optionally, when a small object is found in an image to be transmitted, the small object is removed from the image and replaced by background values. The image and/or video stream is then compressed. An indication of the library object to replace the small object, with values of the one or more parameters, if required, are optionally annexed to the compressed image. The compressed image is transmitted to the display unit, which decompresses the image and overlays the library object on the displayed image. Thus, in an exemplary embodiment of the invention, the amount of data required for transmission is substantially reduced. It should be noted that the same method may be used for compressed storage of images and/or video streams.

In an exemplary embodiment of the invention, the replacement of small objects by library objects is performed in transferring live video streams of sports games, such as football and soccer. When a far shot of the field is shown, the players are replaced by library images. When a close view of the player is shown, the actual image of the player is transferred to the display unit. Thus, the viewer may not even be aware that the players shown in the far shots are not the actual players. Optionally, at the beginning of each game the colors of the players of each team are provided once, and thereafter the other end is optionally only notified the team to which each player belongs (optionally requiring only a single bit).

An aspect of some embodiments of the invention relates to identifying in consecutive frames of a video stream, objects that moved by only a small extent between frames, and canceling these movements before compression. The cancellation of the small-extent movements is optionally performed by replacing a portion of the frame in which the movement was identified, by a corresponding portion of the preceding frame. By performing the motion identification on an object basis rather than on a pixel basis more movements may be identified and their cancellation may be performed with less damage to the image, if at all.

Optionally, movements are considered small if the distance of a moving object between two consecutive images is smaller than a predetermined number of pixels, for example between 5-10 pixels. The effect of such cancellation on quality is relatively small, while the benefit in compression is relatively large.

In some embodiments of the invention, the compression used is a pixel based compression method, such as MPEG or animated GIF. In these embodiments, the motion detection is optionally performed using any motion detection method known in the art. It is noted, however, that the search only for small movements limits the amount of processing required in performing the motion detection.

Alternatively or additionally, the compression used is a vectorization based compression. In these embodiments, the motion detection is optionally performed by comparing positions of similar vector elements of the image.

An aspect of some embodiments of the invention relates to a method of identifying movement of an object in a stream of images. The images are optionally real life images, such as acquired using a motion video camera and/or a digital still camera, for example on a cell phone. A pair of images to be compared are optionally converted into a vector format and/or are provided in a vector format. The vector elements of the images are then compared to find similar vector elements in the compared images. For each pair of corresponding elements found in the pair of images, the relative movement of the element is determined. Vector elements having similar movements are then grouped together to determine the object that moved.

In some embodiments of the invention, the vector elements include patches, edges and/or ridges, for example as defined in the patent applications mentioned in the related applications section above. For patches, the centers of patches in consecutive images are optionally compared to find movement. For lines (e.g., edges and ridges), multiple comparisons are performed along the line, for example at each “scanning point” of the original line. In some embodiments of the invention, each segment of the line (of between about 5-20 pixels) is compared separately. Optionally, when a line is substantially monotonous, a movement vector is found for the direction perpendicular to the line and movements parallel to the line are ignored. Alternatively or additionally, the comparison of the line is performed for an entire finite line segment.

In some embodiments of the invention, the above motion detection method is used by a raster compression method in estimating motion on its own and/or in addition to other motion detection methods. A vector motion detection method is more accurate in some cases, for example, near edges.

An aspect of some embodiments of the invention relates to a format of representing images which includes both pixel raster information and vector line information. Optionally, the stored lines include both ridges and edges. Alternatively, the stored lines may include only ridges or edges and/or may include only specific lines for which sharpness is desired at the expense of additional storage space. Optionally, the vector line information is provided when additional accuracy is required and/or when zoom-in and/or zoom-out of the image is required. The use of the line vector representation in addition to raster information provides better visual quality, and reduces or eliminates aliasing effects.

Optionally, at least some of the pixels have information both in pixel format and in vector format. In some embodiments of the invention, the pixel information relates to all the pixels of the image. In displaying the image, the pixel raster information and the vector information are combined, for example by addition, selection and/or averaging. Optionally, when a zoom-in operation is performed, at least some of the line information is changed in a manner different from the raster information. For example, the size of the line maybe enlarged to a lesser extent than the raster information.

In an exemplary embodiment of the invention, the width of the line remains constant and/or is changed to a lesser amount than the zoom factor. Optionally, the color of pixels close to the line, which if the width of the line were adjusted according to the zoom factor would be covered by the line, are adjusted according to the background color of the profile of the line. Optionally, the adjustment is performed as a weighted average of the background value of the line and the pixel values, with weights adjusted according to the distance from the line. Thus, the pixels of the image close to the line, after the zoom, get the background color of the line which gradually turns to the raster color values. In some embodiments of the invention, the line information is used in performing dithering.

An aspect of some embodiments of the invention relates to a player of three-dimensional animation which is adapted to move raster images of objects represented by a plurality of pixel map layers and a skeleton. The player is adapted to render the pixel maps based on non-linear movements of the skeleton.

In some embodiments of the invention, the player is adapted to determine display portions which do not change between frames. These portions are not reconstructed by the player. Optionally, pixels which are farther than a predetermined distance from bones of the pixel that moved are not rendered and there view is taken from previous images.

An aspect of some embodiments of the invention relates to a method of representing a character of animation. The character of animation is associated with a library mold and the parameters of the character are encoded relative to the mold. The encoded parameters optionally include the color and/or shape of portions of the character. Optionally, the character includes information of a real life image, for example as acquired by a camera.

An aspect of some embodiments of the invention relates to a method of representing depth information of an image. A library of topographical shapes is searched for a shape most similar to the image. Depth parameters of the image are then encoded relative to the shape selected from the library. In some embodiments of the invention, at least some of the shapes in the library have a linear shape. Alternatively or additionally, at least some of the shapes have a shape which has values which are a function of the distance from the edges. In some embodiments of the invention, some of the difference values are set to zero for compression.

An aspect of some embodiments of the invention relates to a method of compressing a video stream. For every predetermined number of frames, the objects in the frame are identified and their parameters are recorded. Optionally, in addition, background parameters of the image, without the identified objects are recorded. The parameters optionally include information on the positions of the object in the frame, the orientation of the object and/or the color of the object. Based on the recorded data, the frame for which the data was recorded may be reconstructed. During display of the video stream, the non-recorded frames are optionally reconstructed by interpolating the recorded parameters of the objects and optionally of the background, based on the recorded frames before and after the reconstructed frame. Alternatively or additionally, one or more non-recorded frames may be extrapolated based on two or more preceding frames.

In some embodiments of the invention, one frame is recorded for similar frames, between about every 8-16 frames. Optionally, the interval between recorded frames is generally fixed. Alternatively, the interval between recorded frames depends on the similarity of the frames. Optionally, when a frame is substantially different from a previous frame, the frame is recorded regardless of which frame was previously recorded.

There is therefore provided in accordance with some embodiments of the invention, a method of generating a character from an image, comprising providing an image depicting a character, identifying, automatically by a processor, characteristic lines in the image, receiving an indication of a character to be cut from the image; and suggesting border lines for the character to be cut from the image, responsive to the identified characteristic lines and the received indication.

Optionally, the received indication comprises border lines at least partially surrounding the character. Optionally, suggesting border lines comprises suggesting based on identified characteristic lines which continue the indicated border lines. Alternatively or additionally, suggesting border lines comprises suggesting based on identified characteristic lines which are substantially parallel to the indicated border lines. Optionally, the received indication comprises an indication of a center point of the character. Optionally, determining which pixels of the image belong to the character comprises determining based on identified characteristic lines surrounding the indicated center point.

Optionally, the method includes displaying the identified lines overlaid on the image before receiving the indication. Optionally, suggesting border lines comprises suggesting a plurality of optional, contradicting, border lines. Optionally, suggesting border lines comprises suggesting at least a border portion not coinciding with an identified characteristic line. Optionally, suggesting border lines comprises suggesting at least a border portion which connects two characteristic lines. Optionally, the border portion which connects two characteristic lines comprises a border portion which has a curvature similar to that of the connected two characteristic lines. Optionally, the method includes generating a mold from the character by degeneration of the character.

There is further provided in accordance with some embodiments of the invention, a method of creating an animation, comprising providing an image depicting a character, selecting a library mold character, fitting the mold onto the character of the image; and defining automatically a border of the character, responsive to the fitting of the mold to the character.

Optionally, the selected library mold was generated from a character cut out from an image. Optionally, fitting the mold onto the character of the image comprises performing one or more of rescaling, moving, rotating, bending, moving parts and stretching. Optionally, the method includes identifying characteristic lines in the image and wherein fitting the mold onto the character comprises at least partially fitting automatically responsive to the fitting. Optionally, the method includes separating the character into limbs according to a separation of the mold. Optionally, the method includes defining a skeleton for the character based on a skeleton associated with the mold. Optionally, the method includes identifying the character in at least one additional image in a sequence of images. Optionally, the method includes identifying a movement pattern of the character responsive to the identifying of the character in the sequence of images. Optionally, the method includes identifying the character in at least one additional image of the sequence using the identified movement pattern.

There is further provided in accordance with some embodiments of the invention, a method of tracking motion of an object in a video-sequence, comprising identifying the object in one of the images in the sequence; cutting the identified object from the one of the images; fitting the cut object onto the object in at least one additional image in the sequence; and recording the differences between the cut object and the object in the at least one additional image.

There is further provided in accordance with some embodiments of the invention, a method of creating an image, comprising generating, by a human user, an image including one or more lines, defining, by a human user, for at least one of the lines, a color profile of the line; and displaying the image with color information from the defined color profile. Optionally, defining the color profile comprises drawing by the human user one or more graphs which define the change in one or more color parameters along a cross-section of the line.

There is further provided in accordance with some embodiments of the invention, an image creation tool, comprising an image input interface adapted to receive image information including lines, a profile input interface adapted to receive color profiles of lines received by the image input interface; and a display adapted to display images based on data received by both the profile input interface and the image input interface.

There is further provided in accordance with some embodiments of the invention, a method of compressing a vector representation of an image, comprising selecting a plurality of points whose coordinates are to be stated explicitly, dividing the image into a plurality of cells, stating for each cell whether the cell includes one or more of the selected points, and designating the coordinates of the selected points relative to the cell in which they are located.

Optionally, selecting the plurality of points comprises points of a plurality of different vector representation elements.

Optionally, dividing the image into cells comprises dividing into a predetermined number of cells regardless of the data of the image. Alternatively, dividing the image into cells comprises dividing into a number of cells selected according to the data of the image.

Optionally, dividing the image into cells comprises dividing into a hierarchy of cells.

Optionally, stating for each cell whether the cell includes one or more of the selected points comprises stating using a single bit.

There is further provided in accordance with some embodiments of the invention, a method of compressing a vector representation of an image, comprising dividing the image into a plurality of cells, selecting fewer than all the cells, in which to indicate the background color of the image; and indicating the background color of the image in one or more points of the selected cells. Optionally, dividing the image into a plurality of cells comprises dividing into a number of cells selected according to the data of the image.

Optionally, selecting fewer than all the cells comprises selecting cells which do not include lines of the image. Optionally, at least one of the lines states a color of the area near the line, in addition to the color of the line itself.

Optionally, selecting fewer than all the cells comprises selecting cells which do not include other elements of the image. Optionally, indicating the background color of the image in one or more points of the selected cells comprises indicating the background color in one or more predetermined points. Optionally, indicating the background color of the image in one or more points of the selected cells comprises indicating the background color in a single central point of the cell. Optionally, the method includes explicitly stating the selected cells in a compressed format of the image. Optionally, a compressed format of the image does not explicitly state the selected cells.

There is further provided in accordance with some embodiments of the invention, a method of compressing a vector representation of an image, comprising receiving a vector representation of the image, including one or more lines, dividing the line into segments; and encoding one or more non-geometrical parameters of at least one of the segments of the line relative to parameters of one or more other segments.

Optionally, encoding one or more non-geometrical parameters comprises encoding color information of a profile of the line. Optionally, dividing the line into segments comprises dividing into segments indicated in the received vector representation. Optionally, dividing the line into segments comprises dividing into segments which minimize the resulting encoded parameters. Optionally, encoding one or more parameters of at least one of the segments comprises encoding relative to a single other segment. Optionally, encoding one or more parameters comprises encoding a parameter of the color and/or a profile of the line. Optionally, dividing the line into segments comprises dividing the line into a plurality of different segment divisions. Optionally, dividing the line into a plurality of different segment divisions comprises dividing the line into a plurality of segment divisions with different numbers of segments, in accordance with a segmentation hierarchy. Optionally, the method includes encoding at least one parameter of the line relative to segments of both the first and second divisions into segments. Optionally, the method includes encoding at least one first parameter of the line relative to segments of the first division and at least one second parameter relative to at least one segment of the second division.

There is further provided in accordance with some embodiments of the invention, a method of compressing a vector representation of an image, comprising receiving a vector representation of the image, including one or more lines, dividing the line into segments, in accordance with a plurality of divisions, selecting one of the divisions of the line into segments, and encoding one or more parameters of at least one of the segments of the selected division relative to parameters of one or more other segments of the selected division.

Optionally, selecting one of the divisions comprises selecting a division that minimizes the resultant encoding. Optionally, encoding one or more parameters comprises encoding a geometrical parameter of the line. Optionally, encoding one or more parameters comprises encoding a non-geometrical parameter of the line.

There is further provided in accordance with some embodiments of the invention, a method of compressing a vector representation of an image, comprising providing a vector representation of the image, determining a size of at least one element of the vector representation; and quantizing the color of the at least one element with a number of bits selected responsive to the determined size.

Optionally, the at least one element comprises a patch and/or a line. Optionally, the size of the at least one element comprises a width. Optionally, a smaller number of bits are selected for smaller elements. Optionally, providing the vector representation comprises receiving an image and converting the image into a vector representation.

There is further provided in accordance with some embodiments of the invention, a method of generating a vector representation of an image, comprising identifying parallel lines in the image; and representing the parallel lines by a single line structure having a profile including the color of the parallel lines and the color between the lines. Optionally, the single line structure comprises an indication of the color beyond the parallel lines.

There is further provided in accordance with some embodiments of the invention, a method of generating a vector representation of a three-dimensional object, comprising partitioning the object into a plurality of sub-objects, at least one of the sub-objects having a form which cannot be included in a single plane; and representing each sub-object by a vector representation of at least lines and background points, at least some of the lines and background points having a depth parameter. Optionally, partitioning the object into a plurality of sub-objects comprises partitioning into fewer than 20 objects, 10 objects or 5 objects. Optionally, at least one of the sub-objects has at least five points. Optionally, at least one of the sub-objects is very large such that its shape is evident when the object is displayed.

There is further provided in accordance with some embodiments of the invention, a method of transmitting a video stream, comprising receiving a video stream, identifying in one or more frames of the video stream at least one object having a size smaller than a predetermined value, selecting a library object similar to the identified object, removing the identified object from the one or more frames, and transmitting the video stream from which the identified object was removed, together with an indication of the selected library object and coordinates of the removed object. Optionally, receiving a video stream comprises receiving a real time video stream. Optionally, identifying the at least one object comprises identifying a person. Optionally, transmitting the video stream comprises transmitting to a display unit with a relatively small screen. Optionally, transmitting the video stream comprises transmitting to a display unit with a relatively limited processing power. Optionally, transmitting the video stream comprises transmitting the stream in a compressed format.

There is further provided in accordance with some embodiments of the invention, a method of transmitting a video stream, comprising receiving a video stream, identifying in a first frame of the video stream, at least one object which moved relative to a consecutive previous frame in the stream, changing the first frame so as to cancel the movement of the object relative to the previous frame; and transmitting the video stream with the changed frame.

Optionally, identifying the at least one object that moved comprises identifying an object that moved by a small extent. Optionally, identifying the at least one object that moved comprises identifying an object that moved by not more than 10 pixels. Optionally, the method includes compressing the stream with the changes before transmission.

Optionally, compressing the stream comprises compressing according to an MPEG compression. Optionally, compressing the stream comprises compressing according to a vectorization based compression.

There is further provided in accordance with some embodiments of the invention, a method of identifying movements of objects in a stream of images, comprising providing a pair of images in a vector representation, finding similar vector representation elements in the pair of images, determining a movement vector between the two images, for each of the found similar elements; and identifying objects that moved between the pair of images, responsive to the determining of movement vectors. Optionally, the vector representation elements comprise line segments and patches.

There is further provided in accordance with some embodiments of the invention, a method of storing an image, comprising generating a pixel raster representation of the image, identifying representative lines of the image; and storing both the identified representative lines and the pixel raster representation. There is further provided in accordance with some embodiments of the invention, a method of encoding an animation character, comprising selecting a library model similar to the character, determining, for a plurality of parameters, the difference in values between the selected library model and the character; and indicating the selected library model with the determined difference values.

There is further provided in accordance with some embodiments of the invention, a method of encoding a three dimensional image, comprising providing depth values for a representation of the image, selecting a library topographic model having a similar depth arrangement as the image; and indicating the depth of the image relative to the selected model.

There is further provided in accordance with some embodiments of the invention, a method of displaying an image, comprising providing an image, determining characteristic lines of the image; and dithering the image at least partially based on the determined lines.

Optionally, dithering the image comprises making determined lines have the same color along their entire width

There is further provided in accordance with some embodiments of the invention, a method of decompressing a video stream, comprising receiving values, for two non-consecutive frames in the stream, of non-pixel parameters describing an object, interpolating for one or more frames between the two non-consecutive frames, parameter values of the object; and displaying a video stream generated using the interpolated parameter values.

Optionally, the parameters comprise a location of the object in the frame. Optionally, the parameters comprise a three dimensional orientation of the object. Optionally, the parameters comprise a color of the object in the frame.

There is further provided in accordance with some embodiments of the invention, a method of rendering an image including a character formed of a plurality of pixel map layers and a skeleton which describes the relative layout of the layers, comprising providing a plurality of pixel map layers generated relative to a base skeleton position; providing a current skeleton position, moved non-linearly relative to the base skeleton position; and determining an image for display based on the pixel map layers and the current skeleton position.

Optionally, the skeleton comprises a three dimensional skeleton. Optionally, determining the image comprises looping over at least some screen pixels of the displayed image and determining for each screen pixel looped over, the layer pixels determining its value. Optionally, determining the image comprises looping over the layer pixels and determining for each looped over layer pixel, the screen pixels affected by the layer pixel. Optionally, at least some of the layer pixels are moved according to the movement of a closest bone of the skeleton. Optionally, each pixel is associated with a closest bone once for an entire animation sequence including a plurality of frames. Optionally, at least some of the layer pixels are moved as a weighted average of the movements of a plurality of neighboring bones. Optionally, the weights of the weighted average are determined based on the distance of the pixel from the bone. Optionally, weights of the weighted average are determined once for an entire animation sequence. Optionally, determining the image comprises determining only for some of the screen pixels, not determining for pixels that have a high probability that they did not change.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a flowchart of acts performed in compressing a VIM vector representation of an image, in accordance with an exemplary embodiment of the invention; and

FIG. 2 is a schematic block diagram of a compressed VIM representation of an image, in accordance with an exemplary embodiment of the invention.

### DETAILED DESCRIPTION OF EMBODIMENTS

Overview

The following description provides examples of the features of the present invention with relation to the VIM data structure described in the patent applications referenced in the related applications section above.

In accordance with some embodiments of the invention, the following description assumes that images and/or video streams (as well as their compression) are generated by authoring tools optionally hosted by relatively powerful processing tools. In some embodiments of the invention, the determination of whether to use one or more compression methods and/or sophisticated authoring methods may depend on the extent of processing power of the processing tool. The compressed format of the images and/or video streams are optionally planned to allow display by low processing power tools, such as battery powered cellular units.

One property of VIM in accordance with some embodiments of the invention, is that one way to explain and illustrate the VIM representation is on cartoon-like images. In an exemplary embodiment of the invention, all the VIM structural aspects can be authentically represented by fairly simple such examples.

But VIM Authoring Tools allow one to produce as well VIM representations of complicated high-resolution images of real world images. The VIM structure remains the same also here. However, VIM elements become much more dense, and their visual role and visual interaction between different elements becomes more complicated.

Experiments performed by the inventor of the present application show, that the compression methods of the present application achieve a strongly better compression ratio, than a straightforward application of the Huffman Coding, as well as a much better utilization of the specifics of the Human visual perception.

In some embodiments of the invention, VIM coding (also referred to herein as compression) uses Y I Q color components. The quantization of the I and Q components is usually stronger than of the Y component. It is well known, that a human visual sensitivity to brightness of a visual pattern (and especially to its color) strictly decreases with the angular size of the pattern. The angular size of VIM Lines and especially Patches is usually rather small. Consequently, the Y and especially the I and the Q components of the Lines Color Profiles are optionally quantized much stronger (with more bits) than the corresponding components of the Area Color. In one Coding mode the I and the Q components of the Color Profiles and of the Patches are not stored at all. In an advanced Coding mode the quantization thresholds for Y, I and Q components of the Color Profiles and of the Patches depend on their width (size).

Experiments have shown that a visual sensitivity to some elements of the Color Profile is rather low. In particular, this concerns the interior brightness parameters RB₂ and LB₂. (“Bump” parameters. See the PCT/IL02/00583). However, the presence of the typical Profile shape, described by these parameters (margin “bumps”) is important for an overall image quality. Consequently, a prediction for these parameters is computed on the base of the others (and of the global image properties) and encode only the corrections to these predicted values. In one Coding mode, the parameters RB₂ and LB₂ are not stored at all.

It is well known that the human visual sensitivity to the geometric shapes is much higher for “geometrically near” visual patterns than for isolated ones. Rather strong geometric distortions in a position of a line, passing far away from other patterns, will not be perceived at all, while even a small distortion of one of a couple of closely neighboring lines immediately “pops to the eyes”. This fact is taken into account in the VIM structure already in the explicit definition of the Crossings and Splittings of the Lines. The geometric parameters of the Terminal Points, representing Crossings and Splittings, are stored with a higher accuracy than that of the usual Line Points. In Advanced Coding mode the “Aggregated Crossing” and the “Aggregated Color Profile” are used, which capture the most common cases of VIM elements visual aggregation. Also in Lines quantization their mutual position is taken into account.

In an exemplary embodiment of the invention, for a screen of 500×700 pixels with 24 bits RGB color, the area color of an image is compressed using 3-6 bits for the Y parameter, and 2-4 bits for each of the I and Q components. Thus, the area color is represented by between about 7-14 bits instead of 24. The color of line profiles is optionally encoded by 2-5 bits for the Y component, and 1-4 bits for the I and Q components. Different values may be used for special conditions in which lower or higher resolution is desired. A resolution of between about 0.125 to 0.5 pixels is optionally used for visually aggregated geometric parameters, and of 1-2 pixels for non-aggregated parameters.

Encoding of VIM Parameters

The VIM Texture comprises various parameters with different mathematical meaning and visual significance. The following main groups of parameters are encoded separately:
“Centers”—This includes encoding coordinates of the Lines Terminal Points and coordinates of the centers of Patches (and, in an “explicit” Coding mode, coordinates of the Area Color Points), together with the data specifying the type of the encoded point. The main aggregation tool here is the encoding of points with respect to a certain regular cell partition of the image plane. This eliminates redundancy related with an explicit memorizing of the order of the points and allows one to take into account expected points density.
“Terminal Points”—At Terminal Points the “topological” structure of the system of the Lines is optionally stored. This is achieved by storing the branching structure of these points and by associating the adjacent Lines to the corresponding Terminal Points. Also the accurate coordinates of the starting Line Points of the adjacent Lines may be stored at Terminal Points. In an Advanced Coding mode, at a Terminal Point an accurate geometry of the corresponding Crossing of the Lines is stored, together with a color data, allowing for a compact representation of the Color Profiles of the adjacent Lines.
“Lines”—Encoding of Line Geometry follows the representation, disclosed in PCT/IL02/00563. After quantizing the coordinates of the Line Points, the vector of the first Line Segment is stored, together with the offsets of the subsequent Line Segment Vectors from the preceding ones. However, in one the implementations, aggregation with the Terminal Points is used, since the starting and the ending Line Points are already stored at the corresponding Terminal Points. The present invention provides also a powerful authoring method, which allows one to strongly improve compression of Line Geometry.
“Area color”—In the regular Coding mode, the coordinates of the Area Color Points (AC's) are not explicitly stored. Instead, their brightness (color) values are aggregated with respect to a certain regular cell partition of the image plane. This eliminates redundancy related with an explicit memorizing of the position of the Area Color Points (this precise position is usually visually insignificant) and allows one to take into account expected points density. A portion of the Area Color parameters is associated with Lines Color Profiles (margin color or brightness). These color values at the Line margins are stored together with other Color Profile parameters. Further aggregation of the Area Color data is achieved in the “Two—Scale Area Color Coding”, where, in particular, a redundancy is eliminated between the Area Color values at the AC's and at the margins of Lines Profiles.
“Color Profiles”—The parameters of the Color Profiles allow for a natural aggregation, taking into account their visual role and typical behavior. Thus, Profile “bumps” parameters, which normally reflect the image origin and behave in a coherent way at all the parts of the image, are represented as corrections to certain predicted values. The Central Color of non-separating Ridges (and of Patches) is naturally stored relative to the Area Color at the corresponding points. In the next step Color Profiles are naturally aggregated along the Lines. Thus only the Profile at the starting Line Point and the subsequent differences are stored. To further eliminate data redundancy along the Lines, sub-sampling is applied to the Line Points, at which the Color Profiles are stored. Finally, Color Profiles of different Lines at their common Terminal Points (Interior Points, Crossing and Splittings) are naturally aggregated between them.
“Patches”—The coordinates of the centers of Patches are encoded as the “Centers”, as described above. The rest of the geometric and the color parameters of the Patches are stored in a straightforward way. Some of attributes of the human visual perception are taken into account: as the size of the Patch decreases, its accurate shape (and color!) become visually insignificant, and the corresponding data is quantized with a coarser step, or is not stored at all.
“Depth”—Depth data is optionally stored in three main modes. In a “direct” mode, the depth values are stored as an “additional color component”, thus appearing as part of “Area Color”, “Color Profiles” and “Patches”, exactly as the color components. The only difference is that the “Depth Profile” of Lines is very simple, comprising only one value at the center. In a second mode, only analytic depth models are stored, one for each Sub-Texture. In the decoding process the depth at each relevant point of a Sub-Texture is computed through the stored model. In a third, “mixed”, mode the depth values are stored as corrections to the “predictions” of the models.

These elements are described in more detail in the following documents:
7573—VIM Texture Syntax
7574—VIM Texture Integration
7753—VIM Texture Coding
   available, for example, at http://mpeg.nist.gov/docreg58.html. These documents are incorporated herein by reference.
   “Multi-layer” Area Color Coding.

In VIM Texture some Sub-Textures may occur “on-top” or “under” other Sub-Textures. In raw form, where the Area Color Points are stored together with their coordinates, depth & color values and the index of the Sub-Texture they belong to, no interpretation problems appear. However, in a procedure of the Area Color Coding, described above, where the brightness (color) and the depth values of the Area Color Points are aggregated with respect to a certain regular cell partition of the image plane, the cell partition is to be duplicated for each layer of Sub-Textures. Also a separate bounding rectangle is memorized for each Sub-Texture, to avoid storing of irrelevant cells.

Multi-Scale Coding

The Coding scheme, as described above, is augmented by application of a Multi-Scale approach. Essentially in each of the groups of the parameters it is possible first to encode data on the coarse scale, and then to represent the fine-scale data as corrections to the coarse-scale predictions. Multi-Scale approach is used in the encoding of the Lines geometry, Lines Color Profiles and of the Area Color and Depth. The basic VIM structure distinguishes right away fine scale details—patches and short ridges. These elements are naturally excluded from the coarse-scale data

On the coarse scale Lines are optionally approximated with a smaller number of Line Segments and with a coarser quantization of the coordinates of the Line Points and Vectors and of the Line Segments Heights. On the fine scale the coordinates of the new Line Points are given in the coordinate system, associated with the coarse-scale curves, and hence appear as “corrections” to the coarse-scale data. The size of these corrections optionally does not exceed the allowed error of the coarse-scale approximation.

On the coarse scale a larger cell-size of the regular partition is chosen (usually, twice or four times the original cell-size). The Area Color data are aggregated with respect to the coarse partition, and the corresponding Area Color representation is formed. Later the fine-scale Area Color is represented as corrections to the coarse scale. Here also the encoding procedure can be built in such a way that the maximal possible size of the corrections is known a priori. Exactly the same procedure can be applied to the Depth values.

In VIM, Texture Color Profiles are optionally stored at the Line Points (bounding the Line Segments). On the coarse scale Color Profiles are optionally stored only at a sparser sub-sampling of the Line Points. The stored values are interpolated to the rest of the Line Points, thus providing a coarse-scale prediction of the Profiles. At the fine-scale Profiles are stored as corrections to these predictions.

VIM Data Streaming and Error Resiliency

The natural multi-scale structure of the compressed VIM data, as described above, is important in two central problems of data transmission: data streaming and data error resiliency. When streaming VIM data, the coarse VIM image is optionally transmitted first, providing a reasonable quality approximation to the original image (the lines geometry is less accurate, the color values are somewhat “low-pass filtered” and certain fine scale details disappear). Then the fine-scale corrections and elements (Patches and short Ridges) are streamed, gradually enhancing the image visual quality.

As far as the error resilience is concerned, only the coarse-scale data (whose data size is usually a fraction of the total size) is to be carefully error-protected in the transmission process. Any error or even a total misinterpretation of the fine-scale data leads to only limited (and usually local) degradation of the image quality. Indeed, as it was stressed above, the maximal size of the corrections is known a priori. Consequently, any error in their transmission cannot lead to a larger discrepancy of the image than this a priori bound.

The “raw” VIM representation, described in the patent applications described in the related applications section can be realized in a form of a computer memory structure, or can be stored as a file (textual or binary). The size of such files may be reduced using any standard loss-less statistic compression, like Zip.

In some embodiments of the invention, however, as is now described, compression methods (referred to herein also as coding methods) adapted specifically for image vector representations are used to compress the VIM representation and/or any other vector representation. These compression methods optionally utilize data on visual correlation between different spatially associated parameters of the vector representation, to eliminate significant redundancy in raw data and to take into account specifics of human visual perception.

In some embodiments of the invention, the compressed format is kept simple and transparent so as to allow decompression by low processing power apparatus, such as cell phones. The compression tools in accordance with the present invention may optionally have any processing power level, allowing for different levels of compression. Optionally, high power apparatus, perform all the compression optimizations described below, while low processing power apparatus perform only some of the optimizations or perform the compression without optimizations at all.

It is noted that many data streams in RVIM present strong non-uniformity in their statistical distribution, as well as strong inter-correlation. In the overall coding organization one can either remove these redundancies at a final statistical loss-less encoding (Huffman Coding) stage or eliminate them in an earlier stage, by a proper Data Aggregation.

The VIM structure optionally provides a full control on all the geometric and the color features of the image, and thus a possibility for a clever Data Aggregation on all the levels. Experiments show, that this aggregation provides a strongly better data compression than a straightforward application of the Huffman Coding, as well as a much better utilization of the specifics of the Human visual perception. Organization of virtually any of the Data Streams, described below, gives examples of Data Aggregation.

In some embodiments of the invention, VIM coding uses Y I Q color components, rather than standard RGB components. The quantization of the I and Q components is usually stronger than of the Y component.

Optionally, the color of non-separating lines and/or of patches is represented relative to the background color. In compression of the image, this generally provides a better compression than in using absolute color coding.

Low Color Sensitivity for a Small Angular Size

Human visual sensitivity to brightness of a visual pattern (and especially to its color) generally decreases with the angular size of the pattern. The angular size of VIM Lines and especially Patches is usually rather small. Consequently, the Y and especially the I and the Q components of the Lines Color profiles are optionally quantized much stronger (i.e., fewer bits are used to represent the I and Q components) than the corresponding components of the Area Color. In one Coding mode the I and the Q components of the Color Profiles and of the Patches are not stored at all. In an advanced Coding mode the quantization thresholds for Y, I and Q components of the Color Profiles and of the Patches depend on their width (size).

Visual Redundancy of Color Profiles

Experiments have shown that a visual sensitivity to some elements of the Color Profile is rather low. In particular, this concerns the interior brightness parameters RB₂ and LB₂. (“Bump” parameters. See the PCT/IL02/00583) However, the presence of the typical Profile shape, described by these parameters (margin “bumps”) is important for an overall image quality. Consequently, a prediction for these parameters is computed on the base of the others (and of the global image properties) and encode only the corrections to these predicted values. In one Coding mode the parameters RB₂ and LB₂ are not stored at all.

Different Visual Sensitivity to “Near” and “Non-Near” Geometry

It is well known that the human visual sensitivity to the geometric shapes is much higher for “geometrically near” visual patterns than for isolated ones. Rather strong geometric distortions in a position of a line, passing far away from other patterns, will not be perceived at all, while even a small distortion of one of a couple of closely neighboring lines immediately “pops to the eyes”. This fact is taken into account in the VIM structure already in the explicit definition of the Crossings and Splittings of the Lines. The geometric parameters of the Terminal Points, representing Crossings and Splittings, are stored with a higher accuracy than that of other Line Points. In Advanced Coding mode the “Aggregated Crossing” and the “Aggregated Color Profile” are used, which capture the most common cases of VIM elements visual aggregation. Also in Lines quantization their mutual position is taken into account.

In particular, polygonal surfaces, used in conventional 3D representation, satisfy the above restriction. Hence they can be used as the “geometric base” of the VIM 3D objects. However, the visual texture of these polygons need to be transformed into VIM format.

Usually the proposed method gives serious advantages in representation of 3D objects and scenes. First of all, the number of layers in the above described VIM representation is usually much smaller than the number of polygons in the conventional representation. This is because VIM layers have a depth—they are not flat, as the conventional polygons. The second reason is that the boundary Lines of the VIM layers on the surface of the 3D object usually depict visually significant features of the object: they coincide with the object's corners, with the edges on its surface, etc. In the VIM structure these Lines serve both as geometric and as color elements, that reducing significantly the data volume.

The VIM structure fits exactly to the structure of the rendering process, as described above. The VIM player accepts the VIM data as the input and back-plays it in an optimal way.

In the present application, as in the documents listed in the related applications section above, the following terms are used interchangeably:

The specific format for vector representation of images and scenes, disclosed in the present invention, is below referred as VIM (Vector Imaging) images, VIM Textures and VIM scenes.

The lines used to define the images are referred to as Characteristic Lines and Lines (LN). The lines are formed of segments referred to as Line Segments (LS), Links and Arcs. A single point along a characteristic line is referred to as a Line Point (LP) or a vertex. Along the lines there are one or more Line Color Profiles (LC), referred to also as Cross-Sections, which define the change in the image across the line.

In the compressed format, the image is further defined by points each of which is referred to as an Area Color Point (AC), a Background representing point or a Background point. Some images may be defined by a plurality of separate portions referred to as Sub-Textures (ST) and Layers.

Compression Method

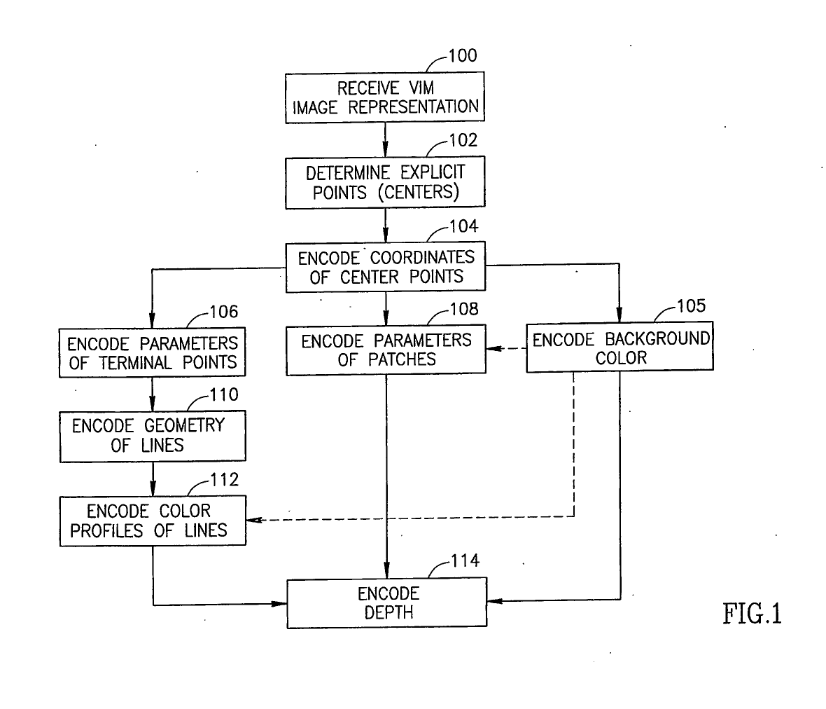

FIG. 1 is a flowchart of acts performed in compressing a VIM vector representation of an image, in accordance with an exemplary embodiment of the invention. A VIM representation of an image is received (100) by a processing unit adapted to, compress the image, for example for transmission over a wireless network. The representation includes lines, which may be either edges or ridges, patches and area color points (AC), which define the background of the image. The lines are represented by Terminal Points (TP), segment parameters and color profiles which define the color cross sections of the line. The patches are optionally defined by Central Points (CP) and one or more geometry parameters. A more complete description of these parameters appears in PCT/IL02/00563.

In some embodiments of the invention, points which are to explicitly appear in the compressed form are determined (102). These points are referred to herein as center points. Optionally, the coordinates of TPs and CPs are always stored explicitly. In some embodiments of the invention, one or more AC points may be marked in the VIM uncompressed representation as requiring explicit statement in the compressed form. Optionally, the coding status of the AC's is determined in the uncompressed format by a flag AC.Flag, assigned for the entire image. If the flag is set to “regular”, the AC's coordinates are not stored explicitly in the compressed format. If the AC.Flag is set to “explicit”, the AC's are included in the center points, and their coordinates are stored explicitly, as described below.

Thereafter; the coordinates of the center points are encoded (104). In addition, as described below, in areas of the image not including lines, area color information is encoded (105). For terminal points, the parameters of the terminal points, such as the identities of the lines meeting at the terminal point are encoded (106), as described in detail below. Similarly, for patch points, the parameters of the patches are encoded (108). Further to encoding the parameters of the terminal points, the geometry parameters of the lines connecting the terminal points are encoded (110). In addition, the color profiles of the lines are encoded (112). In some embodiments of the invention, the color profiles of the lines and the colors of the patches are encoded using absolute values. Alternatively or additionally, the colors of the patches and/or the color of at least some of the lines, e.g., non-separating lines, are encoded relative to the background color, as indicated by the dashed lines in FIG. 1. Thereafter, the depth of the elements of the image are encoded (114). As described below, the depth may be encoded using absolute values and/or relative to a selected library model.

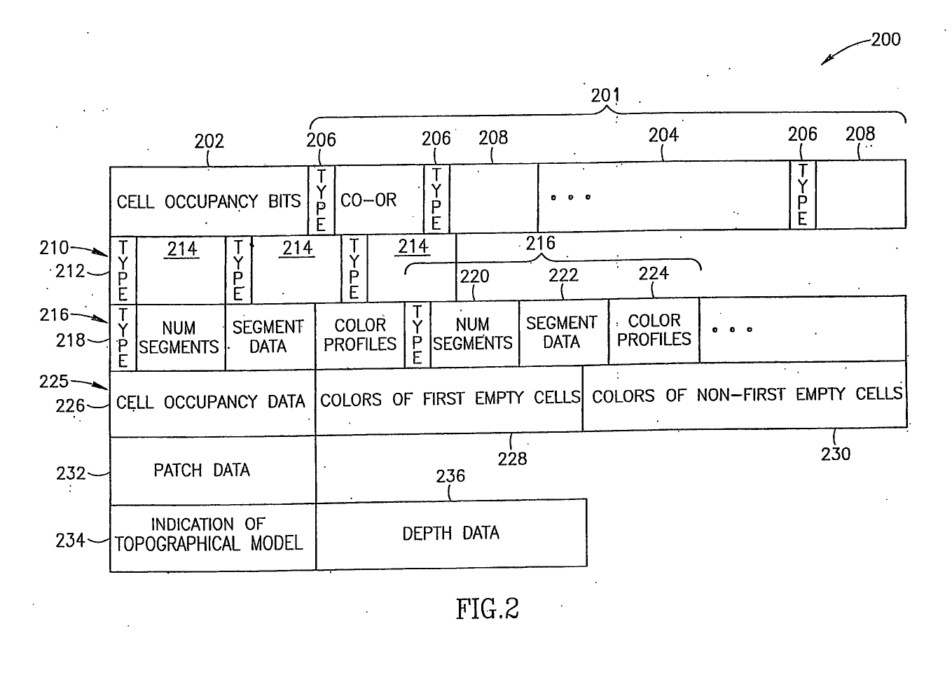

FIG. 2 is a schematic block diagram of a compressed VIM representation 200 of an image, in accordance with an exemplary embodiment of the invention A point description portion 201 encodes coordinates of points in the VIM representation. A cell occupancy bit field 202 indicates for each cell whether the cell includes points and/or the number of points in the cell. Thereafter, a point array 204 optionally indicates, for each point, the type 206 of the point and the coordinates 208 of the point, optionally relative to the cell. A second field 210 states for each terminal point, as identified by the type fields 206, the type 212 of the terminal point as described in detail below, and branching information of lines connecting to the point (214). A line field 216 indicates for each line, a type 218 (e.g., edge, ridge, non-separating), a number of segments 220, segment data 222 and color information 224.

An area color field 225 optionally includes a cell occupancy field 226 which indicates for which cells there is background data (i.e., empty cells). In addition, field 225 includes an absolute color field 228 for indicating the color of empty cells not having preceding adjacent empty cells, and a relative color field 230 for indicating the color of empty cells having adjacent preceding cells. A patch data field 232 optionally provides data on the patches, and a field 236 optionally provides depth data, in a manner similar to the provision of color data In some embodiments of the invention, the depth data is provided relative to a selected library topographical model, which is indicated in field 234.

It is noted that the structure of FIG. 2 is brought only as an example and other data structures, including same data in a different arrangement or including different data, may be used.

Optionally, the image is partitioned into cells. In some embodiments of the invention, the image is subdivided into CBgp×CBgp pixel cells, starting, without loss of generality, from the top left corner of the texture bounding rectangle. CBgp is a Coding parameter, described below. If necessary, on the bottom and on the right sides of the texture bounding rectangle auxiliary rows and columns of CBgp×CBgp pixel cells are added, in such a way that the numbers of cells in a row and in a column is divisible by 4. The CBgp×CBgp pixel cells (or their half-size sub-cells, if the Tree.Depth.Flag, described below, is set to 4) are called “basic cells”.

This is an integer parameter of the Center Coding. It may take, for example, values 32, 24, 16, 12, 8, 6 and 4 pixels. Default value of CBgp is 8 pixels. Usually the parameter CBgp is equal to the cell-size parameter Bgp of the Area Color Coding, but if necessary, these two parameters can be set independently. As described below, if CBgp=Bgp, some additional data redundancy can be eliminated. To simplify notations, below in this section CBgp is shortly denoted by C.

In some embodiments of the invention, pixel cells (referred to herein as “Free Cells” (FC)) not including center points, are identified (106). Optionally, the FCs are marked according to a “tree structure of free cells”: first free 4×4 blocks of basic cells are marked, then 2×2 blocks, etc. The depth of this tree can be 3 or 4, according to the Tree.Depth.Flag, having values 3 and 4. If this Flag is set to 4, an additional subdivision of the basic CBgp cells into half-size sub-cells is performed.

In an exemplary embodiment of the invention, the blocks of the size 4C×4C pixels are first considered (4-cells), starting from the top left corner of the texture bounding rectangle. Those of 4-cells, which contain all the 16 free C×C cells (1-cells), are marked by 0. Those of 4-cells, which contain at least one non-free 1-cell, are marked by 1.

In the last case, each of the four 2-cells, forming the 4-cell, is marked by 0, if all its 1-sub-cells are free, and by 1 in the opposite case. Finally, each of four 1-cells, forming a 2-cell, marked by 1, are marked by 0, for the free cell, and by 1 for a non-free one.

If the Tree.Depth.Flag is set to 4, each 1-cell is subdivided into four ½-cells (each having a pixel size ½CBgp). In this case each of four ½-cells, forming a 1-cell marked by 1, are marked by 0 for the free ½-cell, and by 1 for a non-free one.

Forming “Cell Marking Strings”.

The “Cell Marking Strings” CMS1 and CMS2 are formed as follows: CMS1 comprises all the bits, marking all the 4-cells. CMS2 is obtained by writing subsequently all the 4 bits words, corresponding to each of the 4-cells, marked by 1, in their order from left to right and top down on the image. Then all the 4-bits words are written, corresponding to each of the 2-cells, marked by 1, in the same order. This completes the CMS2 string for the Tree.Depth.Flag set at 3. For a setting of the Tree.Depth.Flag at 4, the CMS2 string contains, in addition, all the 4-bits words, corresponding to each of the 1-cells, marked by 1, in the same order, as above—from left to right and top down on the image.

Forming “Center Marking String”.

The Center Marking String CMS consists of the Neighboring Marking for each Center (if necessary), followed by its Type marking of the Center and by its coordinates. These data are written into the CMS string in the order of the Centers, described above.

“Occupancy” Marking.

The free lowest level cells (of the size C×C or ½ C×½ C pixels, according to the setting of the Tree.Depth.Flag) may contain one or more Centers. Those which contain more than one Center (“over-occupied”), are marked as follows, via the above tree structure:

Those of non-free 4-cells, which do not contain “over-occupied” low-level cells, are marked by an additional bit 0. The non-free 4-cell, which contain “over-occupied” low-level cells, is marked by an additional bit 1. Each of the four 2-cells, forming the 4-cell, additionally marked by 1, is marked by 0, if it does contain “over-occupied” low-level cells, and by 1 in the opposite case. The procedure is continued for 2-cells (and for 1-cells, if the Tree.Depth.Flag is set to 4).

Forming “Occupancy Marking Strings”.

The “Occupancy Marking Strings” OMS1 and OMS2 are formed as follows: OMS1 comprises all the bits, representing the “Occupancy Marking” of all the non-free 4-cells. OMS2 is obtained by writing subsequently all the 4-bits words, formed by the “occupancy bits”, corresponding to each of the 4-cells, with the occupancy marking 1, in their order from left to right and top down on the image. Then all the 4-bits words are written, corresponding to each of the 2-cells, with the occupancy marking 1, in the same order. This completes the OMS2 string for the Tree.Depth.Flag set at 3. For a setting of the Tree.Depth.Flag at 4, the OMS2 string contains, in addition, all the 4-bits words, corresponding to each of the 1-cells with the occupancy marking 1, in the same order, as above—from left to right and top down on the image.

The Centers are processed in the order of the non-empty basic cells (1-cells or ½-cells, according to the setting of the Tree.Depth.Flag), from left to right and top down on the image. If one of the basic cells is “over-occupied”, the centers, belonging to this cell are ordered in a certain specific order (essentially, reflecting their appearance in the Encoding process, and not having any geometric meaning). This arbitrary ordering, which is stored explicitly, represents a data redundancy, which can be easily eliminated. However, usually this overhead is fairly negligible.

Each of the Data Streams formed in Centers coding is optionally organized according to the Reference Ordering of the Centers, described in this section.

Center Neighboring Marking.

The first Center in an over-occupied basic cell has no Neighboring Marking (since it is known that there are more Centers in this cell). The second Center has a one-bit Marking, which is 0, if there are no more Centers in the cell, and which is 1 elsewhere. In the last case the third Center has one-bit Marking, which is 0, if there are no more Centers in the cell, and which is 1 elsewhere, and so on.

Each center point is optionally encoded (104) by an indication of the type of the encoded point and the coordinates of the point. In some embodiments of the invention, if the AC.Flag is set to “regular”, the Center Type Marking is a one-bit Flag, taking value 0 if the Center is a Terminal Point, and taking value 1, if the Center is a Patch Center. If the AC.Flag is set to “explicit”, the Center Type Marking is a two-bits Flag, taking value 00 if the Center is a Terminal Point, taking value 01, if the Center is a Patch Center, and taking value 10, if the Center is an Area Color Point.

Center Coordinates.

Optionally, coordinates of each Center are given with respect to the basic cell to which it belongs. The bit-length of each of the coordinates is defined by the cell-size parameter CBgp and by the coordinate quantization parameters for each type of the Centers (TT's, PC's and possibly AC's). For example, if CBgp is 8, and the coordinate quantization parameters is 0.125 pixel, 6 bits are given to each of the coordinates.

Quantization thresholds for TP's and CP's (and possibly AP's) coordinates can be set independently.

Loss-Less Encoding

Optionally, the generated point representations are concatenated into a string. In some embodiments of the invention, the resultant point representation string is loss-less encoded, for example by the Huffman coding. Alternatively, only some portions of the string are loss-less encoded. In an exemplary embodiment of the invention, the strings CMS1, OMS1 and CMS are concatenated into one string CCS1, and this string is stored as it is, without additional statistical compression. Conversely, the strings CMS2 and OMS2 are optionally concatenated into one string CCS2, which is further compressed by the Huffmann coding, as described in section “Loss-Less Coding”.

Aggregating with Area Color Coding

One of the elements of the Area Color Coding (in case of the AC.Flag set to “regular”) is a construction of the image partition by Bgp×Bgp pixels cells and marking those of them, which do not contain any part of Lines. In particular, the cells marked as free in the Area Color Coding, cannot contain Terminal Points. If the cell-sizes Bgp and Cbgp are chosen to be equal, this information can be easily incorporated into the Center Coding: the Centers, belonging to basic cells, marked as free in the Area Color Coding, cannot be Terminal points. Since the AC.Flag set to “regular”, they cannot be Area Color Points either. Hence, the only possibility is Patches Center, and no “Center Type Marker” is necessary in such cells.

Coding of Terminal Points

At Terminal Points the “topological” structure of the system of the Lines is stored. This is achieved by storing the branching structure of these points and some of the data of the adjacent Lines. Terminal Points define the final structure of the entire part of the VIM Compressed Data String, which is related to the Lines, and in this way form, essentially, the overall structure of Compressed VIM.

The coordinates of the Terminal Points themselves are stored in the “Centers” Data Stream (together with the type flag, specifying that this specific Center is a Terminal Point), as described above.

Optionally, the following Global Terminal Points Coding Flag allows one to set a specific Coding mode:

Coding.Type.Flag, with two settings: “regular” and “advanced”. In a regular mode there is no “Aggregated Crossing” type for Terminal Points. In an advanced mode the “Aggregated Crossing” type appears, and for most of Terminal Point Types, a special Color Profile information (described in detail below) is stored.

In some embodiments of the invention, the following Properties of Terminal Points are explicitly stored:
1. The type of the Terminal Point: End Point, Interior Point, Splitting and Crossing.
2. In case of Interior Point, Splitting, or Crossing, the number of Lines, branching from this Terminal Point. For Interior Point this number may be 1 (for a closed Line) or 2, for Splitting 2 or 3, for Crossing 3 to 4.
3. The number of the “exiting” branching Lines, according to the Lines predefined orientation. The exiting Lines are numbered first among all the branching Lines. This number may be 0 or 1 for the End Point, 0, 1 or 2 for the Interior Point, 0 to 3 for the Splitting, and 0 to 4 for the Crossing. All the Lines, branching from this Terminal Point, are ordered in such a way that the “exiting” branching Lines precede the “corning” branching Lines, but besides this requirement the ordering is arbitrary, reflecting the actual processing order.

Optionally, the types of the terminal point may have one of the following values:
End Point.—This Type of Terminal Point is adjacent to exactly one Line, and exactly to one Line Point in this Line. This Line Point is either the starting or the end point of the Line.
Interior Point—may be adjacent to one or two Lines. If the Interior Point is adjacent to one Line, this Line is necessarily closed, and the starting and the ending Line Points of the Line are adjacent to the Terminal Point. If the Interior Point is adjacent to two Lines, these Lines necessarily have the same type (Edge or Ridge), and exactly one of the Line Points of each Line (their starting or their ending Line Points, according to the Lines orientation) are adjacent to the Terminal Point. In RVIM the Color Profiles are stored independently at each of the adjacent Line Points (while these Profiles normally coincide). This redundancy is removed in the “regular” (and advanced) Coding modes, as described in section “Color Profiles Coding”.
Splitting.—At the Terminal Point of this Ridge splits into two Edges, or Ridge degenerates into one Edge. Two or three Lines are adjacent to this type of Terminal Point: one Ridge and one or two Edges. At a Splitting, the starting points of the Edges are, essentially, determined by the Width and the direction of the Ridge. The starting direction of the Edges usually continues the Ridge direction, and the Edges Color Profiles are the Ridge “half-profiles”. All this data redundancy is taken into account in the “regular” (and, of course, also in “advanced”) coding modes. See section “Color Profiles Coding”.
Crossing.—This Type of Terminal Point corresponds to three or four Lines, coming together at their common point. It is normally assumed (and supported by the Authoring Tools) that those Crossings, that exhibit “Splitting pattern” described above, are marked as Splitting type Terminal Points. Consequently, normally Crossings do not have Splitting data redundancy. However, also for Crossings there are strong correlations between the Color Profile and the Geometric Data of the adjacent Lines. Section “Aggregated Color Profile and Geometric data at Crossings” below describes how this redundancy is partially) removed in the “advanced” coding mode.
Aggregated Crossing.—This Type of Terminal Point appears only in the Advanced coding mode. It represents relatively rare effects, which, however, may strongly contribute to a clever compression of many classes of images. First of all, if more than four Lines come to a Terminal Point, this fact cannot be captured directly in “raw” RVIM (which does not have “Aggregated Crossing” type for its Terminal Points). RVIM provides in such cases a visually authentic, but less compact solution: the Lines beyond the fourth will get their own independent Terminal Points, geometrically roughly coinciding with the first one.

Advance Coding mode captures such situations with the “Aggregated Crossing”, at which the number of the branching Lines maybe up to 255.

Moreover, the “Aggregated Crossing” stores an information, which allows for a reconstruction of an accurate shape of the Crossing: how the branching Lines come together from the point of view of their geometric and color behavior.

A feature, distinguishing “Aggregated Crossings” (together with “Aggregated Color Profiles” in the “Color Profiles Coding”) from other Coding schemes is the following: certain high level patterns, which do not exist in RVIM, are represented and stored in a compact form. These patterns include aggregations of several Lines and Terminal Points.

In the Encoding process such RVIM patterns are analyzed and approximated by the corresponding Aggregated Crossings patterns.

It is noted that identifying and representing explicitly “Aggregated Crossing” and “Aggregated Color Profiles” is justified not only from the point of view of compression. It is well known that our visual sensitivity to the geometric shapes is much higher for “geometrically near” visual patterns than for isolated ones. Rather strong geometric distortions in a position of a line, passing far away from other patterns, will not be perceived at all, while even small distortions of one of a couple of closely neighboring lines immediately “pops to the eyes”. This fact is taken into account in the VIM structure already in the explicit definition of the Crossings and Splittings of the Lines. The geometric parameters of the Terminal Points, representing Crossings and Splittings, are stored relatively to the Terminal Point itself and with a higher accuracy than that of the usual Line Points. In Advanced Coding mode “Aggregated Crossings” and “Aggregated Color Profiles” give additional tools to preserve a high visual quality while reducing strongly the data size.

Quantization of Data at Terminal Points

In some embodiments of the invention, in a regular Coding mode (and Texture Type) the data, explicitly stored at Terminal Points, is described above. The data is of a “marker” type and it is stored as it is, without quantization. If the Texture Type is “advanced”, the shape parameters of the End Points are stored at the corresponding Terminal Points. These parameters are quantized according to the chosen quantization thresholds for the End Point Shape.

Data Strings of Terminal Points

The “Terminal Points” Data Strings TPS1 and TPS2 are organized according to the Reference Ordering of the Terminal Points. This Ordering is the same, as described in section “Center Coding” (for all the Centers):

Shortly, TP's are processed and referenced in the order they appear in the list of all the Centers.

For each Terminal Point the following data enter the data string TPS1:

The type of the Terminal Point, represented by two bits: 00—End Point, 01—Interior Point, 10—Splitting and 11—Crossing.
In case of Interior Point, Splitting or Crossing, the number of Lines, branching from this Terminal Point This number is given by one bit: For the Interior Point 0 corresponds to one Line, and 1 to two Lines, for the Splitting 0 and 1 correspond to 2 or 3 Lines, and for the Crossing to 3 or 4 Lines, respectively.
The number of the “exiting” branching Lines, according to the Lines predefined orientation. The exiting Lines are numbered first among all the branching Lines. Their number is given by one bit for the End Point, by two bits for the Interior Point with two branching Lines and for the Splitting, and by three bits for the Crossing. (The Interior Point of the closed Line always has exactly one exiting Line).
   The words, formed for each of the Terminal Point, follow one another in the TPS1 Data String in the Reference Ordering of the Terminal Points.
   Loss—Less Coding of Data String TPS1
   The string TPS1 usually presents a strongly non-uniform statistical distribution of data, since some types of Terminal Points are usually much more frequent than other (End Points are typically the most frequent, then Interior Points, which, in turn, are more frequent then Splittings and Crossings). Consequently, the TPS1 string is optionally further compressed by a Huffman Coding.
   Decoding of Terminal Points Data (Regular Coding Mode)

Decoding the Terminal Points data from the Data String TPS1 is straightforward. It assumes that the Centers Data String is available. Then the words from TPS1 are read in the Reference Order of the Terminal Points, and all the Terminal Points data, as required in VIM Texture, is restored. Notice, that the order of Terminal Points after Decoding may differ from their order in the original VIM Texture.

The Area Color Points AC's are optionally processed and referenced in the order of the non-empty basic Center Coding cells (1-cells or ½-cells, according to the setting of the Tree.Depth.Flag in Center Coding), from left to right and top down on the image. If one of the basic cells is “over-occupied”, the AC's, belonging to this cell are taken in the order, in which they appear in the Center's order.

Coding of Lines Geometry

VIM Coding of Lines Geometry illustrates well one of general principles of VIM: Simple Structure versus powerful Authoring Tools.

The structure of VIM itself, in both its levels (“raw” VIM Texture, and compressed, CVIM) is kept simple and transparent. On the other side, the authoring tools are assumed to be sophisticated enough to provide authentic images representation and high compression

The encoding scheme for the Lines geometry, as described below, is very simple and straightforward. It is based on the Lines representation, as disclosed in PCT/IL02/00563. It constructs and statistically encodes difference vectors between subsequent Segment vectors of the Line. As far as the encoding of the first and the last Line Points is concerned, in one embodiment it is done by reference to the corresponding Terminal Points and to their Data Stream. In another embodiment, also the first and the last points are stored according to the general scheme.

Type of the Line, its Flags and the Number of Segments

The Type of the Line, its Flags and the number of Segments in it are optionally stored exactly in the same form as they appear in the VIM Texture Technical specifications, given in U.S. provisional patent application Nos. 60/304,415, 60/310,486, 60/332,051, 60/334,072 and the PCT Patent application PCT/IL02/00563.

Coding of the First and the Last Line Points

Interaction with the Terminal Points Data Stream

As it is explained in detail in sections “Coding of Terminal Points”, Coding of the Lines data is organized according to the Terminal Points, from which these Lines exit. Consequently, both in the Line Encoding and in the Line Decoding steps, the starting Terminal Point is assumed to be known (with its quantized coordinates).

Encoding and Decoding of the end Line Points in Two Modes

There are two modes for encoding the end Line Point in each Line, determined by setting of the flag “EndPointFlag”. For a “regular” setting of this flag, the end point of each Line is encoded via the encoding of the Line Segments, described below. The terminal Point, corresponding to this end point, is excluded from the list of the Terminal Points, encoded with the Centers, and the header of this Terminal Point is stored together with the Lines Data streams.

If the EndPointFlag setting is “search”, the end Point of the Line is not encoded via the encoding of the Line Segments. Instead, it is identified among the neighboring Terminal Points by a special pointer. This encoding mode is described in detail below.

Encoding of the Line Segments

Quantization

In this step the coordinates of all the Line Points (LP's), except the first and the last one, are quantized, according to the chosen quantization thresholds for the Line geometry. All the quantized coordinates are represented by integers (interpreted according to the quantization step).

It is a default assumption, that the quantization thresholds for the Line Points coordinates coincide with the quantization thresholds for the Terminal Points coordinates.

Constructing the vectors of the Line Segments

The integer vectors Vi=(Vxi, Vyi) of the subsequent line segments LSi are obtained as the differences of the corresponding coordinates of the Line Points at the ends of these segments. The vectors Vi are constructed for all the Line Segments, except the last one.

For the first Line Segment, its vector is obtained by subtracting from the coordinates of its end point the coordinates of the starting Terminal Point of the Line.

Notice that in the encoding process direct quantization of the coordinates of the vectors of the Line Segments, stored in the Raw VIM representation VIMR, is undesirable, since it may lead to error accumulation. Respectively, we first restore the coordinated of the Line Points, then quantize them, and finally construct the Line Segments vectors. In the decoding process the reconstructed Line Segments vectors enter the VIM Texture representation as they are.

Constructing the differences of the Line Segments Vectors

The vector of the first Line Segment is stored as it is. For each of the subsequent Line Segments LSi (except the last one), the difference VVi=Vi−Vi−1 of its vector and the preceding one is formed. All the vectors Vi and VVi are integer ones (with the dynamic range at most 0-255. This last requirement is provided by relating the Line Points quantization threshold with the maximal Line Segment length allowed).

Forming First Two Line Geometry Data Streams

At this stage of the Encoding two Data Streams are formed: LGS1 and LGS2. Eight bits are allocated for each of the x and the y coordinates of the vectors Vi and the differences VVi.

To form the stream LGS1, for each of the Lines, exiting a certain Terminal Point, first the x-coordinate and then the y-coordinate of the vector of the first Line Segment are written, in the order of the exiting Lines, defined at the processed Terminal Point. The words, formed by these coordinates for each Terminal Point, follow one another in the LGS1 Data String in the Reference Ordering of the Terminal Points. (This order of Lines will be referred below as the “Reference Ordering” of Lines).

To form the stream LGS2, for each of the Lines, exiting a certain Terminal Point, first the x-coordinate and then the y-coordinate of the first Difference VV1 are written, then of the difference VV2, and so on, till the last formed difference for this Line. Remind that the number of the Segments in each Line is explicitly stored in the Header. The resulting sub-strings are written in the order of the exiting Lines, described above. The longer strings, formed in this way for each of the Terminal Point, follow one another in the LGS2 Data String in the Reference Ordering of the Terminal Points. (Thus the sub-strings, formed for each Line, follow one another in the “Reference Ordering” of Lines).

The string LGS2 normally presents a strongly non-uniform statistics. The Authoring process causes the Difference coordinates to concentrate around zero (and frequently to be exactly zero). Consequently, Huffman Coding is further applied to the stream LGS2. The global LGS1 string usually exhibits a fairly uniform statistics. This happens because both the size and especially the direction of the first Segment Vector are globally distributed in a rather uniform way, for most of images. Consequently, in a regular Coding mode, Huffman Coding is not applied to LGS1 string.

Identifying the Last Point in the Line

The starting Line Point of the last Line Segment in the Line has been already encoded, as the end point of the previous Line Segment. As it was stated above, the end point of this segment coincides with the Terminal Point, where this Line ends. Accordingly, only an “End-Point Pointer” to this Terminal Point (and to the corresponding branch at this Terminal Point, if necessary, according to the Type of the Terminal Point and to the Coding mode) is stored for the last Line Segment. To reduce the bit-size of this pointer, it refers only to the Terminal points within a certain prescribed distance from the end point of the previous Line Segment. This distance is a global coding parameter LN. In a regular Coding mode it specifies the size of the block, formed by the CBgp-cells, neighboring to the one, containing the end point of the previous Line Segment. All the Terminal Points inside the LN×LN block of the CBgp-cells, identified in this way, are ordered in their Reference Order. The End-Point Pointer identifies one of these points.

Since the number of the segments in each line is encoded in the Header, and is restored before the rest of the parameters, the use of different encoding schemes for the first and the last Line Segments does not lead to any confusion.

If the Type of the starting Terminal Point of a certain Line is “Interior Point” and the number of the Lines, branching from this Terminal Point is 1 (in other words, if the Line is closed), the Last Segment Pointer is not stored, since the end Terminal Point of this Line necessarily coincides with its starting Terminal Point.

The default setting of the parameter LN and the default bound on the maximal number of the Centers in a CBgp cell limit the maximal possible number of Terminal points in any LN×LN block of CBgp cells by 256. Consequently, eight bits are allocated to the End Point Pointer. The third Data Stream LGS3 is formed by these 8 bits words following one another in the Reference Order of Lines, described above (excluding closed Lines).

The string LGS3 usually presents a fairly uniform statistical behavior. Consequently, the loss-less encoding of this string takes into account only the fact, that for typical images not all the 8 bits, allocated for the End Point Pointer, are used. No Huffman Coding is further applied to the LGS3 string.

Encoding the Heights of the Line Segments

In the regular Coding mode the heights of the Line Segments of each Line are quantized according to the height quantization threshold chosen, and stored without any additional processing. They form 8 bits words, which follow one another in the order of the segments in the Line. The sub-strings, obtained for each Line, are concatenated into the Data String LGS4, following one another in the Reference Order of Lines, described above. Huffman Coding is further applied to the LGS4 string.

Decoding of the Lines Geometry

Decoding of the line geometry is performed in the following steps (assuming that all the Terminal Points have been already reconstructed, and that all the Line Geometry Data Strings have been Huffman decoded):
1. All the Lines are optionally processed in their Reference Order. Since all the Line Geometry Data Strings have been formed in the same order, the data in these strings is optionally read consequently, step by step.
2. The starting Line Point is reconstructed from the corresponding Terminal Point. In this stage the coordinates of the starting Line Point are set identical to the coordinates of the Terminal Point.
3. The first Line Segment vector is read from the Data String LGS1.
4. All the Line Segment vectors Vi, except the last one, are consequently reconstructed, using the differences VVi (read from the Data String LGS2).
5. Coordinates of all the Line Points, except the first and the last one, are consequently reconstructed, using the coordinates of the starting Line Point and the already reconstructed vectors Vi.
6. The CBgp-cell, containing the before-the-last Line Point in the Line, is identified, together with its neighboring LN×LN block of CBgp-cells.
7. The list of the Terminal Points inside the restored LN×LN block of Bgp-cells is formed. The End Point Pointer of the processed Line is read from the Data Stream LGS3. Applying this pointer, the end Terminal Point of the Line and its appropriate branch are found. In this stage the coordinates of the last Line Point are set identical to the coordinates of the End Terminal Point.
8. Finally, the heights of the Line Segments are optionally directly restored from the Data String LGS4.
   Uniform Subdivision of Lines

The method of encoding the Lines Geometry, described above, produces very compact Lines representation, as applied to typical Lines on various kinds of images. In some embodiments of the invention, the segments of the lines are those used in the non-compressed VIM representation. Alternatively or additionally, when the compression is performed by a powerful processing tool, the compression tool attempts to redefine the segments before compression, so that the compression achieves a better compactness.

This part of Authoring process optionally includes rearranging of the Line partition into Segments in such a way, that one projection of the Segment Vectors is the same for as many subsequent Segments on the Line, as possible. Consequently, the encoded differences are zero. It is optionally achieved in the following steps: first, the “corners” and the high curvature parts of the Line are identified and separated. The remaining parts are further subdivided in such a way that the direction of each piece has an angle smaller than 45 degrees with one of the coordinate axes. Finally the resulting pieces are subdivided into the Segments, having the same projections on the corresponding coordinate lines. The number of the Segments in subdivision is determined by the required accuracy of approximation. The quantization is performed in such a way that the property of having equal projections is preserved (at least till the last segment). The requirement of “equal projections” can be relaxed to “almost equal”, still providing a high compression ratio.

Predictive Coding of the Segments Heights

In some embodiments of the invention, in an advanced Coding mode, some of the Lines are marked as “smooth” ones. For such smooth Lines only the height of the first Line Segment is explicitly stored. For each subsequent Line Segment a prediction of its height is produced, based on the smoothness assumption and on the knowledge of the Line Points. Then the subsequent heights are either stored as the corrections to these predicted values, or are not stored at all.

The Height prediction is organized as a subsequent computation of Segments Heights along the Line, starting with the second Segment. It is assumed that all the Line Points are known, and in each step it is assumed that the Height of the preceding Segment is also know. Under these assumptions the Height of the next Segment is given by elementary geometry expression. To guaranty a computational stability of the Heights reconstruction, a Relaxation-type computation can be applied.

Multi-Scale Coding of Lines Geometry

In Multi-scale Coding of Lines Geometry the Line is first approximated in a Coarse Scale. This approximation uses a smaller number of Line Segments and a coarser quantization of the coordinates of the Line Points and of the Heights.

In a Fine Scale the Line, if necessary, is further subdivided into a larger number of Segments. The new Line Points coordinates and the new Heights are stored relative (as corrections) to the Coarse Scale data. In particular, this relative representation can be arranged as follows: a coordinate system is associated to the Coarse Scale Line, as described in the Skeleton section of PCT/IL02/00563. The new Line Points coordinates are represented and stored in this Line coordinate system. The new Heights are stored relative (as corrections) to the Coarse Scale Segments Heights, recomputed to the Fine Scale Segments.

Predictive Coding of the first Line Segment Vectors

As mentioned above, the global Data String of the first Segment Vectors LGS1 usually exhibits a fairly uniform statistics. This happens because both the size and especially the direction of the first Segment Vector globally are distributed in a rather uniform way, for most of images. Consequently, in a regular Coding mode, Huffman Coding is not applied to LGS1 string.

On the other hand, on a semi-local scale (of tens of pixels) the size and the direction of the first Segment Vector of the Lines usually are concentrated around a small number of values (which reflect the prevailing Lines direction and shape in the area).

In the advanced Coding mode, using VIM geometric data structure, these “typical values” are identified on the semi-local scale and properly associated with the corresponding VIN parameters. They are stored on the semi-local scale (i.e. at the regular partition cells of the corresponding size) and are used as predictions for the actual parameters. In this case, the “corrections” strongly concentrate around zero, and Huffman Coding provides a strong data reduction.

Moreover, the fact of a vanishing of the “corrections” (and/or the number of bits to store them) can be encoded on the same semi-local scale. Also this last Aggregation step turns out to be strongly preferable to a straightforward Huffman Coding.

Coding of Color Profiles

The Line Color Profiles (LC) are stored at the Line Points, i.e. at the endpoints of the Line Segments.

Typically Color Profiles behave coherently along the Line. The colors and the width mostly change in a monotone fashion along the Line. If this is the case, a linear interpolation of the profile between the End Line Points of the Line, or between subsequent points in a certain pre-defined sub-chain of the Line Points (called below Active Line Points) gives a sufficiently good approximation of the original profiles. It is also quite natural in this case to keep for each Active Line Points not the Profile itself but its difference with the preceding one.

Some profile parameters, after a correct aggregation with the others, have a minor visual significance. This fact is taken into account by the proposed encoding scheme.

The “Bumps.Flag” has three possible settings: “explicit”, “default” and “color default”. In the “explicit” setting all the Profile parameters are explicitly stored. In the “default” setting the corrections LBB2 and RBB2 to the “bump” parameters IB2 and RB2 are not stored at all, and the predicted values, as described below, are used.

In the “color default” setting the corrections LBB2 and RBB2 to the “bump” parameters LB2 and RB2 are stored only for Y color component, while the predicted values are used for I and Q. The recommended setting of the “Bumps.Flag” is at “color default”.

The “Int.Point.Flag” has two possible settings: “explicit” and “default”. In the explicit setting, the Color Profiles at two Line Points, adjacent to a Terminal Point of the Type “Interior Point” are stored independently. In the default mode only one of these Profiles is stored, and the second is reconstructed from the first one.

Encoding Procedures

The Profile parameters are optionally aggregated as follows:

The width parameters W_{L} and W_{R} are represented as the corrections WW_{L} and WW_{R} to the global (stored) predicted values WE and WR. (For Edge and Ridge, respectively. These predicted values are normally computed as the average width values for all the Edges and for all the Ridges, respectively. Remind that default assumption is that both for Edges and for Ridges always W_{L}=W_{R}).

In some embodiments of the invention, the color of substantially all the vector elements is represented by the components Y, I and Q. The “color values” or “color parameters” are understood as the vectors, formed by these components Y, I and Q.

The “margin” color values LB1 and RB1 (interpreted by the expand as the Background values) are stored as they are.

The ‘inner’ brightness values LB2 and RB2 are represented as the corrections LBB2 and RBB2 to certain predictions, as follows:
for Edges:
   LB2=LB1+PE*(LB1−RB1)+LBB2,
   RB2=RB1+PE*(RB1−LB1)+RBB2,
   and for ridges:
   LB2=LB1+PR*(LB1−CB)+LBB2,
   RB2=RB1+PR*(RB1−CB)+RBB2.
   Here PE and PR are the global (stored) profile parameters. In other word, the “bump” heights LB2−LB1 and RB2−RB1 are predicted as a certain fraction of the “total height” LB1−RB1 for Edges (LB1−CB or RB1−CB for Ridges). The values of PE and PR are usually determined as the average ratio of the “bump” heights to the total heights of the Edges and the Ridges, respectively.

Finally, the middle value CB of the ridge profile is stored as the difference CBB of the CB and 0.5(LB1+RB1), the last expression representing the expected “background value” at the middle of the ridge. Their typical value may be of order of 0.075.

For non-separating Ridges the value of CB is stored as the difference CBB of CB and the background value at the middle of the Ridge. In this case the reconstruction of the values of CB may require preliminary reconstruction of the background. An exemplary embodiment of this procedure is described below.

In the main default mode, the brightness values LB2 and RB2 for the non-separating Ridges are not stored in the VIM compressed file CVIM (although these values present in the VIM raw representation RVIM. These values are reconstructed through the expressions:
LB2=LB−PR*CBB and RB2=RB−PR*CBB,
where LB and RB are the background values at the corresponding points.

In the main default mode, the left and the right widths of the Ridges and of the Edges are always assumed to be equal.

Quantization of the Profile Parameters

The values of each of the Profile parameters (after aggregation, as described above) are quantized according to the quantization level chosen. In a default mode the quantization thresholds values for the “Area Color parameters” LB1 and RB1 are the same, as for the Area Color Coding, while the thresholds values for the “interior” Color Profile parameters are much coarser. This reflects a well known fact, concerning human visual perception: our sensitivity to the brightness and especially to the color of an image pattern strongly decreases with the angular size of this pattern.

As it was stated above, in a default mode the color components Y, L Q are used instead of R, G, B. The quantization thresholds values for I and Q are coarser than for Y.

Recommended values of encoding parameters (in particular, of various quantization thresholds) are given in “Recommended Encoding Tables”. See the corresponding section below.

Defining the Sub-Chain of the Active Line Points

The density of the Line Points, at which the LC's are stored (Active Line Points, ALP's) is determined by the encoding parameter CD.

The Profile is always stored at the starting and at the ending Line Points of each Line. The described procedure identifies the ALP's in their natural order along the Line, as follows: the next ALP is the first one, for which the sum of the “quasi-lengths” of the Line Segments from the previous ALP is greater or equal to CD.

The “quasi-length” of the Line Segment is a certain simply computed integer function of the vector coordinates of this segment, which approximates its usual length For example, the sum of the absolute values of the vector coordinates of the Segment can be taken. Another choice, which provides a better approximation of the usual length, is as follows: for a, b the coordinates of the vector of a Segment S, its quasi-length q′(S) is defined by

| | |
|---|---|
| q′(S) = Abs(a), | if Abs(a) is greater than 3Abs(b), |
| q′(S) = (3/4)(Abs(a) + Abs(b)), | if Abs(b) = <3Abs(a)<9Abs(b), and |
| q′(S) = Abs(b), | if 3Abs(a) is smaller than Abs(b). |
| q(S) is then optionally | |
| defined as 17/16 q′(S). | |

Notice, that this simple formula gives an approximation of the square root of a²+b² with a rather high accuracy. It is noted that other expressions for a “quasi-length” may be used.

If after completion of the construction of the ALP's it turns out that the sum of the “quasi-lengths” of the Line Segments from the before-the-last ALP to the terminal point of the Line is smaller than 0.5CD, this before-the-last ALP is excluded from the list of ALP's.

Constructing Differences

Each of the Profile parameters (aggregated and quantized, as described above) is now represented as follows: the value at the starting Line Point is stored as it is. The value at each ALP, except the starting Line Point, is replaced by the difference with the corresponding value at the preceding ALP.

Forming Color Profiles Data Strings

As explained above, different statistical behavior is expected from different parameters of the Color Profiles. Accordingly, the following separate Data Strings are optionally formed (and loss-less encoded separately):
1. The strings CPS1.Y, CPS1.I and CPS1.Q comprise the “margin (Area Color) parameters” LB1 and RB1 at the starting Line Points (separately for Y, and for 1 and Q). These strings are not formed for non-separating Lines
2. The strings CPS2.Y, CPS2.I and CPS2.Q comprise the Differences of LB1 and RB1 for the rest of ALP's (separately for Y, and for I and Q). These strings are not formed for non-separating Lines
3. The strings CPS3.Y, CPS3.I and CPS3.Q comprise the Corrections LBB2 and RBB2 for all the ALP's (separately for Y, and for I and Q, for the “explicit” setting of the Bump.Flag. If this Flag is set to “color default”, only the string CPS3.Y is formed For the “default” setting the CPS3 strings are not formed)
4. The strings CPS4.Y, CPS4.I and CPS4.Q comprise the “central color” CB for Ridges at the starting Line Points (separately for Y, and for I and Q)
5. The strings CPS5.Y, CPS5.I and CPS5.Q comprise the Differences of the “central color” CB of Ridges for the rest of ALP's (separately for Y, and for I and Q)
6. The string CPS6 comprises all the Width corrections WW for all the ALP's

Eight bits are allocated for each of the parameters in the strings CPS. For each Line the 8 bits words follow one another in the order of the Line Points in the Line. The resulting sub-strings follow one another in the Reference Order of Lines in the final Data Stream.

Loss-Less Encoding

In the regular Coding mode the strings CPS1 and CPS2 are not Huffman encoded (being the color values at the Lines starting Points, they usually are uniformly distributed on the entire image). Only the actual number of bits, necessary for the encoding, is taken into account.

The rest of the strings are Huffman encoded. The strings for I and Q color components (for the same parameters) are concatenated before Huffman. See “Loss-Less Coding for further details.

Decoding Procedures.

Decoding of the Color Profiles data assumes that the Line Points have been already reconstructed (with the starting and the end Line Points identified with the corresponding Terminal Points).

Reconstruction of the ALP's

The Active Line Points (ALP's) are reconstructed by the same procedure, as in the Encoding, applied to the Line Points. Since the encoding procedures for Active Line Points involve only integer computations and since the quantized coordinates of the Line Points are exactly the same before and after the Coding, the reconstructed chain of the ALP's is identical to the ALP's chain, constructed in the Encoding process.

Reconstruction of the Parameters at the ALP's

The Color Profile parameters are reconstructed in the following order: first the Margin (Area Color) parameters LB1 and RB1 are produced. Then the half-sum of the Margin colors at each Ridge Profile is computed and the Central Color parameters CB of the Ridges are reconstructed through these half-sums and the stored differences CBB (see 4.3.1 above).

In the next stage the predictions for the “Bump” parameters LB2 and RB2 are computed through the Margin and the Center Color parameters, as described above. Then the “Bump” parameters themselves are reconstructed, using the stored corrections LBB2 and RBB2 to the predicted values. The Width parameter W is reconstructed the last.

The (quantized) Margin and Center Color parameters values at the starting Line Points are stored as in the Data Strings as they are. Consequently, in the Decoding process they are read from the corresponded decoded data strings and put into the corresponding fields of the RVIM Structure.

At each subsequent ALP the values of these parameters are reconstructed by adding the Differences (read from the decoded Data Strings) to the reconstructed values at the preceding ALP. Since all the computations are in integers, and the decoded values are identical to the encoded (quantized) values, no error accumulation occurs.

The corrections to the predicted values (for the “Bump parameters” and for the Width) are read from the decoded Data Strings directly.

Reconstruction of the Parameters at the Rest of the Line Points

To form a correct raw RVIM representation, the Profile parameters are optionally reconstructed at each Line Point. This is achieved by the linear interpolation of the values at the ALP's. To simplify computations, the “quasi-length” of the Line Segments, as defined above, is used in this interpolation.

Aggregation of Profiles at Splittings and at Interior Points Splitting

Coding of Ridges Color Profiles is not affected by a presence of a Splitting. The Profiles of Edges at their starting or ending Points, adjacent to Splitting, are not stored explicitly, but rather reconstructed from the Profile of the adjacent Ridge.

An Edge Profile is reconstructed from a Ridge Profile as follows:

If the Edge is adjacent to the right side of the Ridge, the Edge width W is set to be equal to the Ridge's right width WR. The Edge parameters BR1 and BR2 are set to be equal to the Ridge's BR1 and BR2. The parameters BL2 and BL1 of the Edge are set to be equal to the Central parameter CB of the Ridge. In this way the Edge Profile captures the Ridge “right half-profile”. If the Edge is adjacent to the left side of the Ridge, its parameters are set in the same way, through the left-side parameters of the Ridge.

Now, the Encoding of the Color Profiles, till the stage of forming the Data Streams (i.e. data Aggregation and forming Differences) is performed exactly as described above. However, the data of the Edges starting or ending Points, adjacent to the Splittings, are not inserted into the corresponding Streams.

In the Decoding, first the Huffman decoding of the corresponding Streams is performed. Then the Profiles at the starting or ending Points of the Edges, adjacent to the Splittings, are reconstructed from the corresponding data in Ridges Streams, as described above.

Interior Points

If the Int.Point.Flag is set to “explicit”, the presence of the Terminal Points of the Type “Interior Point” does not influence the Coding Process, as described above, and the Color Profiles at two Line Points, adjacent to the Interior Point, are stored independently.

In the “default” setting only one of these Profiles is stored, and the second is reconstructed from the first one. This is done as follows:

The Encoding, until the stage of forming the Data Streams (i.e. data Aggregation and forming Differences) is optionally performed as described above. However, the data of one of the starting or ending Points of the Lines, adjacent to the Interior Point, are optionally not inserted into the corresponding Stream. Namely, the Profile at the starting point of the second Line (in their order at the Interior Point) is not stored (if both starting points are adjacent), or at the only starting point, or at the end point of the second Line, if both Lines are adjacent to the Terminal Point with their end Points. If the Interior Point belongs to a closed Line, the Profile at the starting Point is not stored.

In the Decoding, first the Huffman decoding of the corresponding Streams is performed. Then the Profiles at the starting or ending Points, adjacent to the Interior Points, where they were not stored explicitly, are reconstructed from the corresponding Profiles at the second adjacent Point. This reconstruction consists in just copying the corresponding parameters, possibly switching the right and the left Profile sides, according to the orientation of the adjacent Lines.

Aggregated Color Profiles

Characteristic Lines with more complicated Color Profiles than Edges and Ridges appear both in photo-realistic images of real world and in synthetic images of various origin. Their authentic capturing and representation is important for preserving visual quality and improving compression in most of applications.

“Aggregated Color Profiles” is the main VIM structure, answering an important feature of human visual perception: high sensitivity to perturbations of a “near geometry”.

It is well known that our visual sensitivity to the geometric shapes is much higher for “geometrically near” visual patterns than for isolated ones. Rather strong geometric distortions in a position of a line, passing far away from other patterns, will not be perceived at all, while even a small distortion of one of a couple of closely neighboring lines immediately “pops to the eyes”.

As a result an important Coding problem arises: how to store efficiently “near geometry”? The following (quite common) example illustrated this problem. Assume an image presents a system of uniform parallel lines (say, black on a white background) of a width of two pixels, in a distance two pixels from one another. In VIM this image is represented by a system of black parallel Ridges. Now the Line Points coordinates are quantized with a quantization threshold of half a pixel (and hence with a maximal error of a quarter of a pixel). This can be done in two ways: either for each Line independently, or at once for all the system of the parallel Lines, represented by one Characteristic Line with an Aggregated Profile. The result in the first case is a strong visual distortion. This happens since the quantization errors are independent and visually stress one another. In the second case the visual quality is preserved, although the quantization error is the same. This is because the structure of an Aggregated Profile strongly reduces visual effect of quantization errors. Also the data size is dramatically smaller in the second approach.

In VIM compression complicated Color Profiles are represented as aggregations of the elements of the basic Edge and Ridge profiles. In this approach Aggregated Profiles do not appear in the basic RVIM structure, but only in the Aggregation and Coding levels. For the expand purposes, Characteristic Lines with more complicated Color Profiles than simple Edges and Ridges, are translated into “bundles” of virtually parallel edges and ridges. (In another implementation, more complicated profiles are recognized by the Expand module).

An Aggregated Color Profiles is characterized by the following parameters:
1. The Flag “Wave.Flag”, with two settings: “wave” and “no wave”. If the Wave.Flag is set to “wave”, the entire Aggregated Profile is given by a repetition of a “Wave”, which is a “no wave” Aggregated Profile.
2. If the Wave.Flag is set to “wave”, the number of the “Waves” in the Profile.
3. If the Wave.Flag is set to “wave”, the description of the “Wave” Aggregated Profile, by the parameters, described below.
   The following parameters specify an Aggregated Profile in the “no wave” case:
4. The number of the usual Profiles (Edge or separating Ridge) in the entire Aggregated Profile.
5. The parameters of each of the usual Profiles.
6. The “bump prediction” parameters PE and PR, separately for each aggregated Profile (see 4.3.1 above).
7. The Widths Wi between the subsequent Edge and/or Ridge Profiles in the Aggregated one. The color of the Aggregated Profile is linearly interpolated along the intervals between the subsequent Edge and Ridge Profiles.
   Usually, “bump prediction” parameters, as well as the Widths of the subsequent Edge and/or Ridge Profiles and the Intervals Widths Wi between them, are explicitly stored only with the Profile at the first Line Point in the Line. For the rest of the Profiles on the Line only the total Profile Width is stored, while the Widths above are corrected proportionally.

The same concerns also the Color parameters. They are explicitly stored only with the first Profile. For the rest of the Profiles on the Line only the common color transformation (usually, s linear one) is stored.

Characteristic Lines with complicated Aggregated Profiles are identified by the VIM Authoring tools already in the stage of analysis of the original image and producing its Raw VIM representation (See Patent Applications quoted above). Alternatively (or in combination) VIM Authoring tools can use an input RVIM data, and identify Aggregated Profiles in the Encoding Process.

In the Decoding Process, Characteristic Lines with Aggregated Profiles are translated back into RVIM by replacing them by a system of “parallel” Edges and Ridges. This translation is done in the following steps:
1. At each Line Point of the Line, the normal interval to the Line is constructed The points in the distances, corresponding to the widths Wi, from the Line are constructed. These constructed Pints are interpreted as the Line Points of the Edges and Ridges to be constructed.
2. Segments between the constructed Line Points are built, with the heights, equal to the corresponding Height of the original Line.
3. Terminal Points are placed at the ends of the reconstructed Edges and Ridges.
4. Color Profiles are filled in the corresponding fields of the reconstructed Edges and Ridges. These Profiles are taken directly from the corresponding parts of the Aggregated Profiles.
5. If entire free Bgp×Bgp pixels cells appear between the areas of the reconstructed Edges and Ridges, Area Color Points with the corresponding colors are constructed inside these free cells.
   Coding of Area Color

In the VIM Texture representation the Area Color (the “Background”) is defined geometrically by “cutting” the image plane along all the separating Characteristic lines (Lines, LN).

The Area Color is captured by the margin values of the Line Color Profiles (LC) along the separating Lines and by the Area Color Points (AC).

In the basic Coding mode, encoding of the margin values of the Line Color Profiles is performed together with the rest of the LC parameters, and is described in the section “Coding of Color Profiles”.

Below the color representation is always assumed to be by the Y, I, Q color components. Also the recommended Coding Tables are given in the section “Recommended Coding Tables” under this assumption. If other representations are used (for example, the original RGB components), the Coding parameters have to be transformed accordingly. For gray level images with only one brightness component, normally the Coding parameters of the Y component are recommended.

It is important to stress that the Data String, representing Color Area, is formally independent from the Lines data. This choice is motivated by stability reasons; it forces us to store explicitly a certain redundant information, concerning the “free cells”, that could be reconstructed from the Lines geometry. However, building the structure of the VIM Compressed Data String on the combinatorial-geometric data, reconstructed in the Decoding process, (in particular, on the intersection combinatorics of the Lines with the auxiliary cell partition) would make this Data Structure oversensitive to the accuracy of geometric computations. Moreover, it would make inevitable certain a priori assumptions on the geometry of Lines and their mutual intersections, that would be difficult to impose on the “raw” VIM Texture in most of applications.

Encoding of Area Color Points (AC).

VIM Coding has two basic modes of the encoding of AC: explicit encoding of AC's coordinates, and AC's aggregation via regular cell partition. The choice of the specific mode is defined by a setting of the AC.Flag, described in section “Center Coding”.

Encoding of AC's with Coordinates.

This mode corresponds to the setting of the AC.Flag to “explicit”.

In this mode the Area Color Points are encoded with their coordinates and the corresponding color values inside the “Center Coding” procedure. In this mode the coordinates of all the AC's, of all the Terminal Points (TP's) and of all the Patches PA's centers are encoded compactly, according to the position of these points with respect to a certain regular grid. The special heading then allows one to separate between the cases.

Forming the “Explicit Area Color” Data String

The “Explicit Area Color” Data String EACS is organized according to the Reference Ordering of the Area Color Points. This Ordering is the same, as described in section “Center Coding” (for all the Centers):

The Area Color Points AC's are processed and referenced in the order of the non-empty basic Center Coding cells (1-cells or ½-cells, according to the setting of the Tree.Depth.Flag in Center Coding), from left to right and top down on the image. If one of the basic cells is “over-occupied”, the AC's, belonging to this cell are taken in the order, in which they appear in the Center's order.

Shortly, AC's are processed and referenced in the order they appear in the list of all the Centers.

The Data String EACS comprises three sub-strings: EACS.Y, EACS.I and EACS.Q. EACS.Y is formed by 8 bits words, representing Y component of the color at each of the AC's, going in the order of AC's, described above. EACS.I and EACS.Q are formed in the same way, with I and Q color components of the AC's.

Decoding Area Color in the Explicit Mode

In the explicit mode the Decoding (i.e. the reconstruction of the corresponding data in the Raw VIM format) is straightforward: the Area Color Points are processed in the order of their appearance in the Center List. Their coordinates are read from the data stream. Their color components Y, I, Q values are read from the data streams EACS.Y, EACS.I and EACS.Q.

Encoding of AC's via Regular Cell Partition.

This mode corresponds to the setting of the AC.Flag to “regular”.

In this mode the actual Area Color Points are replaced by a certain regular grid of AC's, with roughly the same density. Usually this mode provides a much higher compression (since there is no need to store explicitly AC's coordinates) while preserving a desired visual quality. Below this encoding mode (which splits into two sub-modes: the single scale and the two-scale ones) is described in detail for the single-scale version. The multi-scale version, which involves aggregation with the Margin Area Color Data, is described in section 5.4 below.

Basic Cell size Bgp.

This is an integer parameter of the Background Coding. It may take values 32, 24, 16, 12, 8, 6 and 4 pixels. Default value of Bgp is 8 pixels.

Compare with the CBgp parameter of the Center Coding. It also takes values 32, 24, 16, 12, 8, 6 and 4 pixels. Default value of CBgp is 8 pixels. Usually the parameter CBgp is equal to the above cell-size parameter Bgp, but if necessary, these two parameters can be set independently. As described in section “Center Coding”, if CBgp=Bgp, some additional data redundancy can be eliminated.

Marking Free Cells.

“Tree Cells” in the Area Color Coding (FC's) are those Bgp×Bgp pixel cells which do not contain any piece of any separating Line.

Identification of the FC's is performed by a special procedure in the process of encoding. No “absolute accuracy” is assumed in this procedure. Equally, it is not assumed, that after the decoding the reconstructed Lines cross exactly the same cells as before the encoding. It is enough to guarantee that the Area color points remain on the same side of each of the separating Lines. If this requirement is not satisfied, after decoding certain AC's may occur on an incorrect side of separating Lines, causing undesirable visual artifacts (which are, however, local in nature, and do not destroy the entire picture).

Marking of the free cells in the Area Color Coding is, essentially, identical to the marking of free cells in the Center Coding. The differences are as follows:
The tree depth is always 3. Respectively, no Area Color “Tree.Depth.Flag” is used
No “Occupancy marker” is used

First the image is subdivided into Bgp×Bgp pixel cells, starting from the top left corner of the texture bounding rectangle. If some of the cells (on the low and right sides of the texture bounding rectangle) have smaller dimensions, they are treated as the “full” ones.

The FC's are marked as follows:

First the blocks of the size 4Bgp×4Bgp pixels are considered (4-cells), starting from the top left corner of the texture bounding rectangle. Those of 4-cells, which contain all the 16 free Bgp×Bgp cells (1-cells), are marked by 0. Those of 4-cells, which contain at least one non-free 1-cell, are marked by 1.

In the last case, each of the four 2-cells, forming the 4-cell, is marked by 0, if all its 1-sub-cells are free, and by 1 in the opposite case.

Finally, each of four 1-cells, forming a 2-cell, marked by 1, are marked by 0, for the free cell, and by 1 for a non-free one.

If some of the 4Bgp×4Bgp pixels cells occur to be incomplete, they are completed by non-free 1-cells, and marked respectively.

Forming “Area Cell Marking Strings”.

The “Area Cell Marking Strings” AMS1 and AMS2 are formed as follows. AMS1 comprises all the bits, marking all the 4-cells. AMS2 is obtained by writing subsequently all the 4-bits words, corresponding to each of the 4-cells, marked by 1, in their order from left to right and top down on the image. Then all the 4-bits words are written, corresponding to each of the 2-cells, marked by 1, in the same order.

Defining the Area Color Value (ACV) for each Free Cell

For each FC its “Area Color Value” ACV is defined as an average of the colors of all the AC's inside this cell. ACV is a vector with three color components Y, I and Q. If the accuracy assumptions above are satisfied, all the AC's inside the same Free Cell are on the same side of any separating Line, and hence their averaging is meaningful.

Quantizing the Area Color Values (ACV's) for each Free Cell

For each FC its ACV vector is now quantized up to a prescribed accuracy. The quantized vector is denoted QACV. The allowed quantization threshold QT, which is a vector of quantization thresholds for Y, I, Q, is a Coding parameter.

Scanning Free Cells

All the FC's are scanned starting with the top row left cell, and proceeding first to the right and then down. The FC's are ordered according to their appearance in the scanning.

Forming differences DACV's of the quantized ACV's

In this step the QACV's in each FC are replaced by their differences DACV's with the predicted values PACV from the preceding FC's. The prediction is performed as follows: for any FC the template of neighboring cells is considered (This template consists of exactly all the direct neighbors of the original cell, which precede it in the scanning order, described above). For any FC, the predicted value PACV is the average of the QACV's in the corresponding template cells. PACV is quantized with the same quantization threshold QT, as in the Quantization step above. By the choice of the template, all the FC's in the template precede the processed FC in the above scanning order. (Other templates, having this property, can be used in forming differences).

For some cells, for example, for those shown on the template does not contain any preceding FC. In this case the prediction PACV is not formed, and the difference DACV is equal to the original value QACV. These Free Cells without any preceding FC in the template, are called Leading Free Cells (LFC's).

Forming the DACV's Data Strings

Six Data Strings are formed with the Area Color Differences. The string ACS1.Y consists of eight bit words, representing the Y color component at the Leading Free Cells, in order of appearing of the LFC's among all the FC's. The strings ACS1.I and ACS1.Q are formed in the same way with the I and the Q components.

The string ACS2.Y consists of eight bit words, representing the Y color component at the Free Cells, which are not Leading Free Cells, in the same order, as above. The strings ACS2.I and ACS2.Q are formed in the same way with the I and the Q components.

The reason to keep the color data at the Leading Free Cells separately is that usually the differences with the predicted color values, which are stored at the Free Cells, which are not Leading Free Cells, are much smaller and require less bits to encode than the original color values, stored at the Leading Free Cells. The same concerns the reason for separating data streams for different color components Y, I and Q. However, in the stage of loss-less encoding some of these strings can be concatenated into longer streams. In particular, this is always done for the streams with I and Q color components.

Decoding Area Color in the Cell Partition Mode

Decoding Area Color in the Cell Partition mode is performed in several steps:
1. First of all the difference color values DACV's are reconstructed at all the Free Cells FC's. At the Leading Free Cells the colors Y, I, Q are read from the data strings ACS1.Y, ACS1.I and ACS1.Q, respectively. At the Non—Leading Free Cells the colors Y, L Q are read from the data strings ACS2.Y, ACS2.I and ACS2.Q. The cells are processed in the natural order, described above.
2. The original (quantized) color values QACV's are reconstructed from DACV's step by step, in the order of the Free Cells FC's. The reconstruction process is described below.
3. The representative Area Color Points are constructed in each cell. This last step is described below, and it can be performed in different ways.
   Reconstructing QACV's from DACV's

This procedure is performed in the natural order of the Free Cells. The first Free Cell in this order is necessarily a Leading Free Cell. Hence the difference value at this cell coincides with the value to be reconstructed.

Assume that all the QACV's have been reconstructed for the FC's up to a certain place, in their order, defined above. Consider the next Free Cell. Form its template, and compute the predicted value PACV as the average of the QACV's in the corresponding template cells. (By the choice of the template, all the FC's in the template precede the processed FC in the above scanning order, so the QACV's for these cells have been already reconstructed).

Then the computed PACV is quantized with the same quantization threshold QT, as in the Encoding Quantization step above, and the value of DACV, stored at the processed cell, is added to the quantized PACV. The result is the desired reconstructed value th for the processed cell.

Constructing Representing Area Color Points AC's in each Free Cell

This last operation can be performed in different ways. It is important to stress here that in a Cell Partition mode of the Area Color Coding, the accurate positions of the original AC's are not reconstructed at all. Instead new AC's are constructed in each Free Cell, carrying the stored color values. This last operation can be performed in different ways.

At least one Area Color Points has to be constructed in each Free Cell, not to lose stored color information More AC's can be constructed in order to preserve image quality in the Animation Rendering (involving motion of the VIM objects and of their VIM elements, including Area Color Points).

The following specific procedure is applied in the Default mode: four Area Color Points are constructed in each Free Cell. The points are placed at the corners of the twice smaller cell with the same center.

In the Default mode the colors associated to the constructed Area Color Points are optionally identical to the color value QACV, reconstructed in the processed Free Cell. The advantage of this choice is that no “low-pass filter” effect is imposed on the reconstructed color data.

In a “linear” mode, the color values at the four constructed AC's are optionally corrected taking into account the values QACV, reconstructed in the neighboring Free Cells. The correction coefficients are chosen in such a way that produced values are the correct ones, under the assumption that the color value is a linear function of the image coordinates. The recommended choice is 11/16, ⅛, ⅛, 1/16 for the processed Free Cell and the three neighboring Free Cells.

Encoding Based on Subdivision of Cells

In an alternative implementation the empty cells are not marked. All the partition cells are further subdivided by the separating Lines; and the Area color values (including the Margin color values) are stored at the subdivision pieces. For this purpose the average is formed of all the color values of the Area Color Points inside the subdivision piece, and of all the Margin color values of the Color profiles of the Lines, bounding the subdivision piece. Those pieces, where more than one Area color value has to be stored, are identified in the encoding process. They are those subdivision pieces, for which the Margin color values of the Color profiles of the Lines, bounding this subdivision piece, differ from one another more than to a prescribed threshold. These pieces are marked accordingly.

The predicted color values are formed exactly as described above, but taking into account the adjacency of the subdivision pieces: only pieces, adjacent to the processed one, are included into its “preceding pieces”. The corrections to the predicted values are explicitly stored.

Multi-Scale Area Color Coding

Further aggregation of the Area Color data is achieved in the Multi-Scale Area Color Coding. In this mode Area Color data is stored exactly as described above, but with respect to a larger regular cell partition. Usually, for a fixed Bgp parameter, the cells of the size 2 Bgp or 4 Bgp are chosen. On the base of the large scale data the predictions of the Area color for the lower scale are computed oust as the Area color values at the centers of the lower scale cells). On this lower scale of the Bgp-size only the necessary corrections to the predicted values are stored.

In one embodiment, more than one Area color value can be stored at the free cells of the larger scale. The stored values are used as predictions not only for Area color at smaller free cells, but also as predictions of the Margin color values of the Line profiles. In this case special pointers are stored with the Lines, indicating which of the Area color values stored at the cell is taken as a prediction of the Margin color on each side of the Line.

This construction of the two-scale representation can be applied more than once, for example, for cells of the size Bgp, 2 Bgp and 4 Bgp, forming a multi-scale representation and coding of the Area color.

Coding of Patches

The coordinates of the Centers of Patches are encoded as Centers, as described above. The rest of the geometric and the color parameters of the Patches are stored in an aggregated way. This aggregation is motivated by some of the attributes of the human visual perception: as the size of the Patch decreases, its accurate shape (and color!) becomes visually insignificant. This allows one to quantize the corresponding data with a coarser threshold, or not to store it at all.

Another feature, characterizing usage of Patches in VIM is a possibility to use them in three quite different roles:

First, Patches capture fine scale image patterns conglomerates, where no individual element is visually important by itself. In such situations all the area is visually appreciated as a kind of a “texture”, creating a definite visual impression as a whole. In this role Patches are normally small (at most couple of pixels in size), their specific shape and orientation are not visually appreciated, and the I and the Q components of their color have a very law visual significance (if any at all).

Secondly, elongated Patches can replace short Ridges. (This replacement if possible, can save a half of the free parameters to store). VIM Authoring tools perform the replacement on a base of the analysis of Ridges geometry and color. In Ridges role Patches still represent fine-scale textures, but now this texture is visually polarized in the Ridges main direction. Patches, appearing in this way, have the bigger semi-axis of order of 8 pixels, and the smaller semi-axis—couple of pixels. The visual importance of their orientation grows with their size, while the I and the Q components of their color still have a very law visual significance (if any at all).

Thirdly, fairly big Patches, with completely arbitrary (and visually important) shape, orientation and color, appear in VIM in the role of “radial gradients”. In this role Patches may form synthetic images or contribute to a very compact representation of the Area Color.

A necessity to utilize Patches in all these three possible roles, while preserving compactness of the encoded representation, motivates the introduction of the Patches.Type.Flag below, as well as different encoding schemes for different Patches appearance.

Patches Global Flags

Patches Type Flag

As it was explained above, there are three typical sorts of Patches: “Texture Patches”, “Short Ridges” and “Synthetic Patches”. The “Patches.Type.Flag” has seven possible settings, specifying any possible combination of the above types. The most frequent settings of the “Patches.Type.Flag” are:
i. “Texture Patches”
ii. “Texture Patches” and “Short Ridges”
iii. “fill”, i.e. all the three above types
iv. “Synthetic Patches”
   Patches Color Flag

The “Patches.Color.Flag” has two settings: “explicit” and “regular”. In the “explicit” setting all the three color components Y, I and Q of “Texture Patches” and of “Short Ridges” are explicitly stored (each one quantized with its chosen quantization threshold). In “regular” setting the I and Q color components of “Texture Patches” and of “Short Ridges” are not stored. (As described below, all the parameters of the “Synthetic Patches” are always stored explicitly).

Coding of each Type of the Patches

Optionally, two global parameters are stored for Texture Patches: S_{M} and Sₘ. S_{M} is the maximal size of the Patch, Sₘ is the minimal size. In the Authoring process there are two main possibilities to fix the parameters S_{M} and Sₘ: either they are simply set to the maximum and minimum of the Patch sizes in RVIM, or these parameters are determined on the base of a more sophisticated analysis of the Patches distribution. In this last case, after the parameters S_{M} and Sₘ have been fixed, the Authoring Tools perform a filtering and a rearrangement of the Patches, in such a way that their sizes are always between the bounds S_{M} and Sₘ.

The interval S_{M}−Sₘ is divided into 2ⁿ−1 equal subintervals, where n is the number of bits, allocated for the Patch size. Normally, n is 1 or 2. First, the bigger semi-axis is encoded. The smaller semi-axis is encoded with the minimal number of bits, sufficient to represent those of the 2ⁿ possible size values, which are smaller than or equal to the size of the bigger semi-axis.

If the bigger semi-axis takes its minimal value, the smaller one is not stored, as well as the Patch orientation. If the difference between the bigger semi-axis and the smaller one is zero, the Patch orientation is not stored. If this difference is at most ½(S_{M}−Sₘ), one bit is allocated for the orientation (i.e. only vertical and horizontal Patch orientations are reconstructed). If this difference is greater than ½(S_{M}−Sₘ), two bits are allocated for the orientation (i.e. only four orientations are reconstructed: vertical, horizontal and two diagonal).

The color of the Texture Patches is stored according to the setting of the Patches.Color.Flag and to the quantization threshold chosen. In an advanced Coding mode the quantization threshold may depend on the size of the Patch.

“Short Ridges”

Four global parameters of the “Short Ridges” are stored: S_{M} and Sₘ, W_{M} and Wₘ. S_{M} is the maximal size of the bigger semi-axis of the Patch, Sₘ is its minimal size. W_{M} and Wₘ are the corresponding bounds for the smaller semi-axis. The remark above, concerning the identification of the parameters S_{M} and Sₘ for Texture Patches, remains valid for the four parameters S_{M} and Sₘ, W_{M} and Wₘ of “Short Ridges”.

Once more, the number of allocated bits is specified for each of the semi-axes, and the quantization of the corresponding size values is performed, as described above. If the size of the bigger semi-axis of the Patch is at most ½(S_{M}+Sₘ), three bits are allocated for the orientation. If this size is larger than ½(S_{M}+Sₘ), four bits are allocated for the orientation. The color of the “Short Ridges” is stored according to the setting of the Patches.Color.Flag and to the quantization threshold chosen. In an advanced Coding mode the quantization threshold may depend on the size of the Patch.

In some embodiments of the invention, the parameters of the “Synthetic Patches” are stored as they are in RVIM, quantized with the chosen quantization thresholds.

In some embodiments of the invention, a combination of some of the above Patch Types may be encoded (for example, as indicated by setting of the Patches.Type.Flag), the appropriate global parameters are stored for each of the participating Types. In addition a “Patch Type Marker” is stored for each Patch, identifying the Type of each specific Patch.

Coding of Depth

Summary

Depth data is stored in four main modes. In the “explicit” mode the depth values are stored as they are, in a separate Data String. In the “regular” mode the depth values are stored as an “additional color component”, thus appearing in the “Area color”, the “Color Profiles” and the “Patches” exactly as the other color components. The only difference is that the “Depth Profile” of Lines is at present very simple, comprising only one value at the center. In the third, “analytic” mode, only analytic depth models are stored, one for each Sub-Texture. In the decoding process the depth at each relevant point of a Sub-Texture is computed through the stored model. In the last “mixed” mode the depth values are stored as corrections to the “predictions” of the models. The corrections are encoded via either explicit or regular modes. The most practical modes are “analytic” and “mixed” ones.

Depth Coding Flags

In an exemplary embodiment of the invention, the Flag Depth.Coding.Flag has four possible settings: “explicit”, “regular”, “analytic” and “mixed”. Its setting defined the Coding mode, as described in detail below. If the Depth.Coding.Flag has been set to “mixed” mode, the “Corrections.Flag” specifies on of the “explicit” or “regular” modes, in which the Depth corrections are encoded.

The Flag Depth.Models.Flag optionally has two possible settings: “default” and “library”. Its setting defined the possible range of analytic Depth Models used: either the default (very limited) choice, described below, or a Models Library, which is specified separately.

Depth Coding Modes

“Explicit”

All the Depth values (at Line Points, at Patches and at Area Color Points) are encoded in one string. This mode is compatible only with the “explicit” mode of encoding of Area Color Points. Eight bits are allocated to each Depth value. The String is built in the following order: first all the Depth values of Area Color Point, in their Reference Order, then all the Depth values of Patches, in the same order, then all the Depth values of Line Points, in the orientation order on each Line and in the Reference order of Lines.

This mode becomes practically important only if these explicitly stored Depth Points are interpreted as Control point of a certain analytic Depth representation scheme, like NURBS.

“Regular”

The Depth values are interpreted and encoded as one of the color components. In this case the Depth values at the Line Points are stored as one of the Profile parameters (without any aggregation, by the full value at the first Line Point and the Differences with the previous value at the subsequent Line Points). The Depth values at the Area Color Points are stored as any other color component: an average Depth value is stored at each free Cell of Area Color Coding. The Depth values at the Patches are stored relative to the “Area Color” Depth value at the corresponding point (i.e. exactly as the Y color component).

It is important to stress that the Depth values can be reconstructed at each pixel, using the usual VIM Expand Procedure. To do this the Depth values are extended (in RVIM) to all the data field in the Line profiles (identically, with the same value as in the Profile Center). After such extension, mathematically, Depth sits in RVIM exactly as the color components Y, I, Q. Consequently, the VIM Expand will produce Depth values at each of the image pixels, exactly in the same way, as the color values are produced.

“Analytic”

For each Sub-Texture an analytic Depth Model is stored. Since the Depth in RVIM is a z-coordinate value at a given point with the coordinates (x, y) on the image plane, any Depth Model is a specific function z=D(x,y) of two variables. According to a setting of the Depth.Model.Flag, this model may be chosen either from a very limited list of default models, given below, or from an external Models Library, which is specified separately.

“Mixed”

For each Sub-Texture an analytic Depth Model is stored, as in 7.3.3. All the Depth values (at Line Points, at Patches and at Area Color Points) are interpreted as corrections to the “analytic” Depth values. These corrections are encoded by any of the “explicit” or “regular” methods, described above, according to the setting of the “Corrections.Flag”.

The following depth models are used: Plane, Paraboloid, Distance to the Boundary (with a couple of parameters), and simple mixtures of the above.

Depth Models

In some embodiments of the invention, one or more of the following Depth models are used in the “default” VIM Depth representation:
Plane—given by a linear function z=ax+by+c. Each coefficient is optionally stored with 8 bits, unless a stronger quantization is explicitly chosen.
Paraboloid—given by a quadratic function z=dx²+exy+fy²+ax+by+c. The coefficients are optionally stored as for Plane.
Distance to the Boundary—given by z=Ds(x, y) is defined for each Sub-Texture, having an exterior contour Line L, marked as a Contour Line, as follows:
   z=Ds(x, y)=De*[d(x, y)/DsP]s, for d(x, y)<DsP, and
   z=Ds(x, y)=De, for d(x, y) greater or equal than DsP.
      Here d(x, y) is the distance of the point (x, y) from the Line L, DsP is the Model parameter, specifying the width of the “transition band” around the contour L, De is the parameter, specifying the Depth inside the Sub-Texture, and S is the parameter, specifying the transition shape. S maybe ½, 1 or 2.

In some embodiments of the invention, combinations of the above depth models are allowed, for example their sums and differences, as well as taking a maximum and/or a minimum of their Depth values. Optionally, the Depth Models Libraries, allowed in the VIM Depth representation, are specified separately. Basically, they include more complicated analytic expressions, piecewise-analytic functions and Splines, like NURBS and Bezier Splines. More complicated models, reflecting the shape of the Sub-Texture, are also allowed.

Depth Driven Multi-Layer Area Color Coding

In the Raw VIM Texture some Sub-Textures may occur “on-top” or “under” other Sub-Textures. In Raw form, where the Area Color Points are stored together with their coordinates, depth & color values and with the index of the Sub-Texture they belong to, no interpretation problems appear.

However, in a procedure described in section “Area Color Coding”, where the brightness (color) and the depth values of the Area Color Points are aggregated with respect to a certain regular cell partition of the image plane, this construction has to be performed separately for each of the “overlapping” Sub-Textures.

Consequently, the Area Color cell partition is duplicated for each Sub-Texture of a multi-layer VIM Texture. The parameters of a separate bounding rectangle are memorized for each Sub-Texture, to avoid storing of irrelevant cells. The centers of all the Sub-Textures are encoded with respect to the same Center cell partition.

In another implementation, each Sub-Texture (layer) is encoded separately.

Encoding, Data String and Decoding

All the Encoding and Decoding Procedures and the structure of the Data String for each SubTexture in a multi-layer mode are identical to the corresponding structures, described in single-layer Area Color Coding. The only differences are as follows:
The Bounding Rectangle of a Sub-Texture is used instead of the Bounding Rectangle of the entire texture
The “free cells” are those which do not contain any Line, belonging (at least on one side) to the processed Sub-Texture
The average Area Color values for each free cell are formed taking into account only the Area Color Points, belonging to the processed Sub-Texture (as usual, the Depth value on the AC's is treated as one of the colors)
The same Data Strings, as described in “Area Color Coding”, are formed for each Sub-Texture separately
In the Decoding process (which is also performed separately for each Sub-Texture), the reconstructed Area Color Points are equipped with their corresponding color and depth values, and with the Sub-Texture index
   Coding of Skeleton and Animations

A VIM Skeleton as described in PCT/IL02/00583, is optionally represented as a collection of Lines. Accordingly, it is stored in the same way as Lines geometry. Key frame positions of the Skeleton are stored either independently, or as corrections to the preceding positions. In one embodiment, the bone coordinates are stored for each Key frame. In another embodiment, the angles between the subsequent bones of the Skeleton are stored at the Key frames. All the rest of the Animation parameters (the global geometric parameters, the color parameters and all the rest of the date, which represent subsequent frames) are stored either independently, or as corrections to the preceding positions.

Tuning of quantization and other coding parameters optionally depends on the type of images to be represented, the quality and compression requirements. Usually (for photo-realistic images, shown on a Personal Computer screen), quantization thresholds of “global geometric parameters” (Centers coordinates, Line Vectors and Heights) is between 0.1 pixel to 5 pixels, quantization thresholds of “local geometric parameters” (Widths of Profiles, Geometric parameters of Crossings, Splittings and Aggregated Crossings) are between 0.02 to 1 pixel (and usually a fraction of absolute thresholds). Color quantization thresholds are optionally between 1 gray level to 32 gray levels. However, the above figures are not restrictive for the present invention. In other applications (like visual quality control or big screen imaging) the thresholds may be much smaller or much larger.

VIM Transmission and Playback

VIM Transmission

The present invention discloses a method for VIM transmission and playback, which combines the advantages of the VIM encoding, as described above, and of a fast playback, as described below. This combination is crucially important for the Internet, and especially for the wireless applications, where both the data volume transmitted and the power of the end devices are strongly limited.

In some embodiments of the invention, the transmission is performed as follows:

The VIM data is compressed, as described above, and the compressed data is transmitted. On the receiving device, the compressed data is decoded, as described above. In one implementation, the decoded VIM data is played back by the VIM reconstruction process (and player) disclosed in the PCT/IL02/00563.

In another implementation, the decoded VIM data is transformed to the raster form by the process, disclosed in the PCT/IL02/00563. In this stage the raster layers are formed, corresponding to the VIM layers. This process consists in reconstruction of the raster image from the VIM representation. The pixels inside the contour Lines of the VIM layer obtain the color of this reconstructed image. The pixels outside the contour Lines of the VIM layers are marked as transparent. The animation data (including the skeletons motions) is decompressed. This process usually includes interpolation between the Key frames. Finally the raster layers and the animation data are transferred to the Raster player, described below, and this Raster player produces the final animation on the screen of the device.

Transforming VIM into Raster Form

Transforming VIM Layers into Raster Form

This process consists in reconstruction of the raster image from the VIM representation, for each layer. This is done by the method and player, disclosed in the PCT/IL02/00563. The pixels inside the contour Lines of the VIM layer obtain the color of this reconstructed image. The pixels outside the contour Lines of the VIM layers are marked as transparent. The animation data (including the skeletons motions) is decompressed. This process usually includes interpolation between the Key frames. Finally the raster layers and the animation data are transferred to the Raster player, described below, and this Raster player produces the final animation on the screen of the device.

Transforming VIM Animation into Motions of Layers

Generally, in the 3D rendering process, each (plane) layer, as seen from the chosen viewer position, undergoes a projective transformation.

To simplify the VIM-R expand Procedure, affine transformations are used instead of the projective ones. Such an approximation is well justified if the viewer position is in a sufficiently big distance form the scene, in comparison with the size of the objects.

The required affine approximation to a projective transformation of a certain 3D object, as seen in the viewer screen plane, three points are chosen on the object. For a new 3D position of the object, the affine transformation of the viewer screen plane, is uniquely defined by the condition that the initial positions on the screen of the three chosen points are transformed into their new positions.

A different choice of the three reference points may lead to another affine transformation. But if the viewer position is in a sufficiently big distance from the scene, in comparison with the size of the objects, any affine transformation, found in this way, will provide a sufficiently good approximation to the original projective one.

Transforming Skeleton Motion

The general procedure described above takes the following specific form, as applied to transforming Skeleton motion into layers affine transformations:

Each layer is assumed to be rigidly connected to one of the Skeleton Bones. The affine transformation of any layer is found through the corresponding Bone. To make this Bone a well defined rigid 3D object, it is included into the original Skeleton plane (this reflects the structure of the VIM animations).

To apply the above procedure, the starting point of the Bone, A=(x0, y0) is chosen as the first from the three required points. The end point of the Bone, B=(x1, y1) is chosen as the second one. The vector AB is denoted by V1. The third point is chosen in the original plane of the Skeleton, as the end-point C of the vector V2, obtained by a clockwise 90 degrees rotation of V1.

In a coordinate form, the vector V1 is optionally expressed as V1=(a, b)=(x1−x0, y1−y0) and V2=(b, −a) and its end-point B has the coordinates (x0+y1−y0, y0−x1+x0). For any point Z=(x, y) the vector V=AZ=(x−x0, y−y0) can be expressed as a linear combination of the vectors V1 and V2: V=pV1+qV2, where:
p=r[a(x−x0)+b(y−y0)], q=r[b(x−x0)−a(y−y0)], and r is 1/(a²+b²).
   Now assume that after a 3D motion of the Skeleton and of its initial plane the three chosen points A, B, C have been transformed into the three points A′, B′, C′. Only the projections of these points onto the screen plane are required. In the computations above the screen plane is identified with the original Skeleton plane: Thus only two coordinates x, y of the points A, B, C can be used, assuming that their third coordinate is zero. For the points A′, B′, C′ only their coordinates (x, y) on the screen plane are considered.

So let A′=(x0′, y0′), B′=(x1′, y1′), C′=(x2′, y2′). All these coordinates are obtained by applying the corresponding 3D transformation, specified by the animation data. In the current procedure these coordinates are considered as the input. The affine transformation AT to be found is uniquely defined by the requirement that for the point Z′=(x′, y′)=AT(Z), the vector V′=A′Z′ is the linear combination of the vectors V1′=A′B′ and V2′=A′C′ with the same coefficients c, d as above:
V′=pV1′+qV2′.
Substituting into this formula the expression, obtained above gives
V′=pV1′+qV2′=p(x1′−x0′, y1′−y0′)+q(x2′−x0′, y2′−y0′)=p(a′, b′)+q(c′, d′),
where a′=x1′−x0′, b′=y1′−y0′, c′=x2′−x0′, d′=y2′−y0′.

Finally, the following expression is obtained for the affine transformation AT to be found:
AT(x, y)=(x′, y′), with x′=K₁x+L₁y+M₁ and y′=K₂x+L₂y+M₂.
where
K1=r(aa′+bc′), L1=r(ba′−ac′), M1=x0′+r[−(aa′+bc′)x0−(ba′−ac′)y0], and
K2=r(ab′+bd′), L2=r(b′−ad′), M2=y0+r[−(ab′+bd′)x0−(bb′−ad′)y0].
   This expression gives the coefficients of the transformation AT through the input data: the coordinates of the starting and the end points A, B of the Bone, and the coordinates of the images A′, B′ of the points A, B, and the image C′ of the auxiliary point C, constructed as described above.

In a special case, where the transformation AT is known to be a rigid plane motion, or a combination of a rigid plane motion with a uniform resealing, the same in any direction (i.e. AT preserves angles between vectors) the input data can be simplified: since the orthogonality and the lengths ratio is preserved, the vector V2′ is obtained by a clockwise 90 degrees rotation of V1′, and hence c′=b′, d′=−a′. Hence it is enough to know only the images A′ and B′ of the Bone ends A and B. Then a′ and b′ are computed, c′ and d′ are expressed through a′ and b′ as above, and all these data are substituted into the expression above.

More Accurate Approximation of Projective Transformations

Mathematically, the transformation from the Layer plane to the screen plane, imposed by a certain positioning of the Layer in the 3D space (and the inverse transformation from the screen plane to the Layer plane) are projective transformations. Accurate formulae for projective transformations are relatively complicated, in particular, involve divisions for each pixel. So to provide a fast expand implementation it is desirable to use certain approximation instead of the fill projective transformations. One possibility is to use affine transformations, as specified above. However, better and still relatively computationally simple approximations exist. Below bi-linear transformations on the bounding rectangles as a reasonable approximation are described. Another possibility (used in many commercial 3D imaging systems) is to subdivide Layers into triangles and to use linear (affine) transformations on each triangle.

Raster layers may be reproduced on the screen by two main methods: the direct mapping and the inverse mapping. In the first method the pixels of the layer are mapped onto the screen (according to the layer actual position) and in this way define the color at each pixel of the screen. In the second method screen pixels are back-mapped to the layers, in order to pick the required color.

Both implementation variants: the direct mapping and the inverse mapping—can be incorporated in the framework of the present invention.

VIM Playback in Raster Form

Comparison of the Direct and the Inverse Methods

Direct mapping realization has the following main advantages:
It turns out to be computationally simpler (especially in the implementation, based on a skeleton, described in the PCT patent application no. PCT/IL02/00563).
The direct algorithm is geometrically and computationally much more stable and natural than the inverse one (for nonlinear transformations; for linear ones, both implementations are roughly equivalent). The reason is that the original posture of the character is usually the simplest and the most convenient for animations. It does not contain too sharp angles between the skeleton bones, too strong overlapping of one part over another etc. However, as a result of the animation, all these effects may occur in the final character posture. To “straighten them out” by the inverse mapping may be very tricky, if not impossible.
The proposed algorithm is strongly based on comparing distances of each pixel to different bones. If, as a result of the animation, one part of the skeleton approaches another, in the inverse algorithm certain pixels may be strongly influenced by the wrong bone. This will not happen in the direct algorithm, since the source skeleton and the source Layer are fixed for all the run of the animation.
The direct mapping algorithm automatically takes into account possible occlusion of some parts of the layer by other parts of the same layer or by other layers. Indeed, layer's pixels are mapped to the screen frame buffer together with their depths. Then z-buffering is performed in the frame buffer, as described below, which leaves on the screen only not occluded pixels. In particular, the “horizon lines”—the boundaries between the visible and invisible parts of the layers—are produced completely automatically, without any explicit treatment.

There is an obvious disadvantage of the direct mapping algorithm: as a zoom of a Layer is performed, some pixels in the “target” (on the screen) may not be covered by the “directly mapped” pixels of the source Layer. However, this problem is roughly equivalent to the aliasing problem in the inverse mapping implementation, and it can be solved roughly by the same methods. Below a certain specific computationally inexpensive solution of this problem is disclosed. Other possible solutions are also described below.

Z-Buffering

In some embodiments of the invention, the compression level of each player may be adjusted as a trade-off between compression and player complexity, related to z-buffering. In one version, the VIM-R animation file contains, for each frame (key frame) explicit ordering of the Layers according to their distance to the viewer. In another version the depth is computed for each pixel and z-buffering is performed on the pixel level.

VIM-R1 Player (Inverse Mapping Realization)

The description below mostly remains valid for each of the realizations, mentioned above: the Direct and the Inverse mappings. However, the details here are given for the Inverse mapping realization.

The VIM-R1 Player optionally contains three sub-modules, a decoding sub-module that decodes the data of the VIM animation file, reconstruction module that transforms the VIM layers into the raster layers, and a rendering module that for each frame of the animation prepares the data for the expand block. In some embodiments of the invention, the following operations are performed by the Rendering in the VIM-R1 player:
1. Computing a Skeleton position for each frame (interpolation between key-frames).
2. Computing the character and the camera 3D position for each frame (interpolation of the character and the camera 3D positions between the key frames).
3. For each Layer the new screen positions and the new depth of the corners of the Layer's bounding rectangle are found.
4. For each Layer the smallest rectangle R is found, containing the new corners. The depth values at the corners of R and the coordinates of the “inverse images” of the corners of R are found by linear interpolation of the depth values (of the original coordinates, respectively) at the new positions of the corners of the Layer's bounding rectangle. This procedure is described in detail below.
   Computing the “Inverse Images” and the Depth at the Corners of R
   The proposed way to compute the “inverse images” and the depth at the corners of R is to subdivide the image of the Layer rectangle into two triangles by its diagonal, and to use linear interpolation from the corners of the appropriate triangles to the corners of R.
   Expand Module

In some embodiments of the invention, the VIM-R1 Player optionally contains an expand sub-module, which for each frame of the animation computes the final bitmap, starting with the input, produced by the Rendering sub-module.

First, a data structure (or a frame buffer), called Aexp, is organized, in which to any pixel p on the image plane a substructure is associated, allowing to mark this pixel with certain flags and to store some information, concerning this pixel, obtained in the process of computation.

More accurately, for each pixel of the screen rectangle to be filled in, three color values R, G, B, and the depth D are stored and updated in the process of computations. In order to save operational memory, local links to the Color Table can be used at this point.

The Expand sub-module optionally comprises two Procedures: “Main” and “Layer”.

The Main Procedure optionally calls for “Layer” Procedure for each of the Layers in the VIM-R scene (after rendering). The main procedure optionally receives for each pixel of a certain rectangle its color values and depth. If the depth received is smaller than the depth already stored at this pixel in the Aexp structure (and if the color value received is not “transparent”) the current values at this pixel in the Aexp structure are replaced by the received ones. If the received color value is “transparent” or if the new depth is bigger than the old one, the data is not updated. (In an advanced profile, the degrees of transparency are used. In this case a corresponding average color value is computed).

The Layer Procedure optionally performs the following steps:
1. To each pixel p of R the transform A is applied, which transforms the new positions of the vertices of the Layer into the old ones. This transform consists in a bi-linear interpolation of the “inverse coordinates” of the corners of R. (These “inverse coordinates”, as well as the bounding rectangle R of the new corners positions, have been found by the Rendering).
2. For each pixel p of R its color is found by averaging the colors of the pixels, neighboring to A(p) in the original Layer bitmap. A certain procedure for assigning transparency should be adopted, according to the transparency of the neighboring pixels. (If transparency levels are used, the transparency can be interpolated along with other colors). If A(p) is out of the original Layer—then the full “transparent” value is assigned to p. Probably, it is completely enough to map A(p) onto a twice denser grid in the original Layer bitmap. The averaging for such grid is very simple: it assigns to each point of the new grid the average color of its nearest neighbors (1, 2 or four, according to a position of the point in the grid).
3. For each pixel p of R its depth is found by applying bi-linear interpolation to the depth values at the corners of R. (Depth values at the corners of R have been found by the Rendering).

The bi-linear interpolation may be performed using any method known in the art. One exemplary realization of a bi-linear interpolation is described in detail below.

If the occlusion structure of the layers is explicitly stored, the computations may be simplified: the depth of pixels is not computed at all. The Main Procedure processes Layers in order (pre-stored) of their distance to the viewer, starting with the closest one, and inserts their colors into Aexp. As the next Layer is processed, its pixels colors are inserted into Aexp at the “free” pixels, and at those previously processed pixels, which have been marked as “trasparenf”.

Efficient Realization of a Bi-Linear Interpolation

A general formula for a bi-linear interpolation is as follows:

If the values at the corners to be interpolated are A, B, C, D, the values A and C (B and D, respectively) are first linearly interpolated along the vertical edges of the rectangle. Then the values on the vertical edges are linearly interpolated along the horizontal lines. For a and b the horizontal and the vertical dimensions of the rectangle, we interpolated value V(x,y) at the point (x,y) of the rectangle is obtained as:
V(x,y)=[A(y/b)+B(1−y/b)](x/a)+[C(y/b)+D(1−y/b)](1−x/a).
However, as V(x,y) is to be computed on a regular grid, a much simpler realization can be proposed, which requires (for big arrays) roughly one addition per grid point.

First we notice, that for the grid size n×m as we pass from one point to its neighbor on the left vertical edge of the grid, V receives a constant increment DV1=(C−A)/m. On the right vertical edge of the grid the increment is DV2=(D−B)/m.

Similarly, as we move along the first horizontal row, the increment is DH1=(B−A)/n, and along the last horizontal row, the increment is DH2=(C−D)/n. As we move along the i-th horizontal row, the increment is DHi=DH1+(i/m)(DH2−DH1).

Accordingly, the algorithm as arranged as follows: first we compute DV1 and DV2, DH1 and DH2. Then moving along the left vertical edge, we compute there V and DHi (adding at each step the increments DV1 and (DH2−DH1)/m to the preceding values). Finally, the horizontal rows are scanned, adding (on the i-th row) on each step to the preceding value the increment DHi.

Direct Algorithm (VIM-R2)—General Principles

General block structure of the direct algorithm is the same as for the inverse one, described above. Accordingly, the description below concentrates on the expand block (raster player).

The proposed direct algorithm is organized as follows. Layers are processed one after another. Pixels of the Layer are mapped onto the screen and are used to update the color and the depth of the corresponding pixels in the frame buffer. The mapping of the Layer's pixels may be nonlinear, and it is produced by several skeleton bones, and not necessarily by exactly one bone.

An input layer is a rectangular raster image with marked transparent pixels and with a depth value at each pixel (this depth value may be constant per Layer, in specific restricted implementations). The Player receives also the skeleton, as described in the PCT patent application no. PCT/IL02/00563: its original position, and, for each frame, its moved position. For each Layer there may be more than one bone of the skeleton, affecting this Layer. Thus, for each Layer L, the list BL of the bones of the skeleton, affecting this Layer, is the part of the input. The matrices of the affine transformations per each bone are used in the preferred implementation. These transformations may be two or three dimensional, according to the mode chosen. However, these matrices do not need to be transmitted independently: they are computed in the Player from the skeleton information. In the embodiment of the invention the affine transformations is the (uniquely defined) affine transformation, which maps the initial position of the bone to its new position, while resealing the distances in the orthogonal to the bones directions LL times, L being a transmitted (or computed) parameter. If computed, LL is preferably defined as the ratio of the bone lengths after and before the motion.

The computations for each Layer are performed independently. The pixels colors and their image coordinates and depth, computed for each Layer, are used to update the frame buffer (FB).

The new screen position S(p) (“shift”) and the new depth are computed for pixels p inside the bounding rectangle LBR of the Layer. (More accurately, only those pixels p are being processed, which are covered by at least one of the bounding rectangles BR of the bones from the list BL). The Layer bounding rectangle LBR is assumed to be parallel to the coordinate axes and to be placed at the left upper corner of the scene.

The shifts S(p) of all these pixels p (and their new depth values), are accumulated (and updated in the computations process) in the additional “shift buffer” (SB). This buffer, essentially, consists of several additional fields, stored for each pixel p of the Layer bounding rectangle LBR, in addition to the original Layer's color, depth and transparency, stored in the buffer DCT. The final run over this buffer SB produces the new position S(p) (and the new depth) for each pixel p in LBR. These data (together with the color and transparency from the DCT buffer), are transmitted to the procedure, updating the frame buffer FB, and the color and the depth of the frame buffer pixels, neighboring to S(p), are accordingly updated.

In the proposed method certain preliminary computations (producing averaging weights for shifts, imposed by different bones) are performed once per animation, not per frame, before the actual animation rendering starts. These weights are stored at the pixels of the bones bounding rectangles BR.

For each animation frame, the computation of the shifts S(p) is performed step by step. In each step exactly one bone Bᵢ from the list BL of bones, affecting the Layer, is processed. The order of bones in BL may be arbitrary, but it is natural to use the bone order, reflecting the structure of the skeleton.

The size of the buffer SB can be reduced, if necessary, to only a couple of the additional fields per pixel. Also transparency of some of the pixels in LBR can be taken into account to reduce computations.

Direct Algorithm (VIM-R2)—Implementation

Block Diagram

One of the basic procedures in the proposed algorithm (Updating the Frame Buffer: UFB) updates the Frame Buffer FB subsequently, Layer after Layer. UFB calls (for each Layer) for the procedure SLCD (Shifted Layer Color and Depth), which scans the original Layer, and provides for pixels p inside the bounding rectangle LBR of the original Layer, their color, their new screen position S(p) and their new depth. These data are returned, for each pixel p, to the procedure UFB. On this base UFB updates the Frame Buffer. Optionally, in the proposed implementation, the procedure SLCD is reduced to just reading the buffers SB and DCT, and transferring their data to UFB.

Shift Buffer-SB

The Shift Buffer SB allows one to store and to update, for pixels p of the bounding rectangle LBR of the Layer, the coordinates x(p) and y(p) and the depth d(p) of the new positions S(p) of these pixels. It is initialized before the processing of a new Layer starts.

Assume that the list BL contains the bones from B₁ to Bₖ. For each bone Bᵢ, a bounding rectangle BRᵢ of this bone is constructed. The construction of BRᵢ is described below. It is important to stress that for each bone Bᵢ, its bounding rectangle BRᵢ is contained in the bounding rectangle LBR of the processed Layer. The bones bounding rectangles are constructed for each Layer once per animation.

Although the buffer SB corresponds to all the pixels of the Layer bounding rectangle LBR, actually processed are only those pixels p, which are covered by at least one of the bone's rectangles BRᵢ. The rest of the pixels of the LBR preserve a special flag (for example, a negative number), which they get in the beginning of the processing of the Layer.

Shift Weights Swᵢ(p)

Shift Weights Swᵢ(p) are constructed for each Layer once per animation. They do not change from frame to frame, and they are stored at the pixels of the bone's bounding rectangles (the weight Swᵢ(p) is stored at the pixels of BRᵢ). The computation of the weights is described below.

Procedure USB: Updating Shift Buffer

This procedure is optionally performed for each Layer and for each frame of the animation. For each Layer L (which is assumed from now on to be fixed), and for an input set of affine matrices of the direct transformations (one matrix per bone), the buffer SB is updated subsequently, by processing one after another the skeleton bones Bᵢ in the list BL of the bones, affecting the Layer L. The list BL optionally contains the bones from B₁ to Bₖ. At the i-th step the bones B₁ to Bᵢ₋₁ have been already processed. At this moment the buffer SB contains the coordinates x(p) and y(p) and the depth dep(p) of the new position S(p) for each pixel p inside the union of the bone bounding rectangles BR₁ to BRᵢ₋₁.

Computations on the i-th Step.

The computation of the new coordinates xᵢ(p), yᵢ(p), depᵢ(p) of the shift S(p) for the bone Bᵢ is performed for each pixel p of the bone bounding rectangle BRᵢ. The affine transformation, computed (or obtained as an input) for the bone Bᵢ is applied to the initial three-dimensional coordinates of each pixel of the rectangle BRi (as stored at the corresponding layer), producing the new three-dimensional coordinates xᵢ(p), y), depᵢ(p) of this pixel.

Now the updated shift coordinates are obtained by averaging the just computed coordinates xᵢ(p), yᵢ(p), dᵢ(p) with the old ones x_{old}(p), y_{old}(p), dep_{old}(p) already stored for this pixel in the buffer SB, with the weights Swᵢ(p) and 1−Swᵢ(p), respectively:
(x(p), y(p), dep(p))=Swᵢ(p)(xᵢ(p), yᵢ(p), depᵢ(p))+(1−Swᵢ(p))(x_{old}(p), y_{old}(p), dep_{old}(p))
These updated values replace the old ones x_{old}(P), y_{old}(p), dep_{old}(P) in the buffer SB. As all the k bones Bi from the list BL have been processed, the procedure USB is completed, and the shift buffer SB is transferred to the procedure SLCD.

In two-dimensional mode the depth coordinate dep does not participate in these computations. To keep the occlusion information in two-dimensional mode, constant depth values are stored one per layer.

Computing the Shift Weights Swᵢ(p)

This computation is performed once per animation for each Layer. From frame to frame the weights Swᵢ(p) remain unchanged. For each Layer L (which is assumed from now on to be fixed) the weights are computed subsequently, by processing one after another the skeleton bones Bᵢ in the list BL of the bones, affecting the Layer L. The computation uses an auxiliary buffer DB, which allows one to store and to update, for some pixels p in the Layer's bounding rectangle LBR (as usual, exactly for those, contained in the union of the bones bounding rectangles BR1) the distance of this pixel to the bones.

Let, as above, the list BL contain the bones from B₁ to Bₖ. At the i-th step the bones B₁ to Bᵢ₋₁ have been already processed. At this moment the buffer DB contains the distance from the pixels p (covered by BR₁ to BRᵢ₋₁) to the part of the skeleton, formed by the bones B₁ to Bᵢ₋₁. The weights Sw₁(p) to Swᵢ₋₁(p) have been computed to this moment. Each weight Swᵢ(p) has been computed for all the pixels p in the corresponding bone bounding rectangle BRᵢ.

Now the i-th step starts, in which the bone Bᵢ is processed.

Computing the Distance from the New Bone

We assume that the bones Bᵢ are straight segments. (This does not contradict a possibility to perform bond bending, as described below). Denote the line of the bone by l₁, and the two lines, orthogonal to the bone at its ends, by l₂ and l₃, respectively.

In fact, not exactly the Euclidean distance to the bone is computed. Indeed, the distance computed is used to define the “influence area” of the bone, and it is desirable that this “influence area” has a size, proportional to the size of the bone itself. Mathematically this is achieved as follows:

Let L₁ be a linear function, which vanishes on the line l₁, and which takes value 1 on the line ll₁, parallel to l₁ and shifted from it to the distance W*LB, where LB is the length of the bone, and W is the “influence width” parameter. Let L₂ be a linear function, which vanishes on the line l₂, and takes value one on the line l₃. For any pixel p, the distance dᵢ(p) from this pixel to the bone Bi is defined as follows:

For L₂(p) between 0 and 1, dᵢ(p) is equal to the absolute value abs(L₁(p)). For L₂(p) greater than one, dᵢ(p) is equal to abs(L₁(p))+(L₂(p)−1). For L₂(p) smaller than 0, dᵢ(p) is equal to abs(L₁(p))−L₂(p).

One efficient computing of any linear function on a pixel array is described below.

Updating the Distance d(p), Stored in the DB Buffer

The distance d(p), stored in the DB buffer prior to the i-th step, is the distance of the pixel p to the part of the skeleton, formed by the bones B₁ to Bᵢ₋₁. It has been computed and stored only for the pixels p in the union of the bone's bounding rectangles BR₁ to BRᵢ₋₁. As the bone Bᵢ has been added, the new distance d(p) is updated for pixels p in the rectangle BRᵢ as follows:
d_{new}(p)=min(dᵢ(p), d_{old}(p)).
Here d_{old}(p) is the distance to the part of the skeleton, formed by the bones B₁ to Bᵢ₋₁. This distance was stored in the buffer DB prior to the i-th step. For pixels p in the rectangle BRᵢ, which are not contained in the bone bounding rectangles BR₁ to BRᵢ₋₁, the new distance is defined as
d_{new}(p)=dᵢ(p).
Before updating distances in the DB buffer, the weights computation for the pixels in the rectangle BRᵢ is performed, as described in the next section 2.3.6.3 (this computation requires both the new distances dᵢ(p) and the old ones d_{old}(P)). As this computation has been completed, the distance values in the DB buffer are updated according to the expressions above.
Computing the Weight Swᵢ(p) in the i-th Step

The weights Swᵢ(p) for the pixels p in the bone bounding rectangle BRᵢ are computed as follows (the distances dᵢ(p) and d_{old}(p) have been defined above):
If dᵢ(p) is smaller than c₁.*d_{old}(p), the weight Swᵢ(p) is one.
If dᵢ(p) is greater than c₂*d_{old}(p), the weight Swᵢ(p) is zero.
If dᵢ(p) is between c₁*d_{old}(p) and c₂*d_{old}(p), the weight Swᵢ(p) is defined by
Swᵢ(p)=q(c₂−dᵣₑₗ(p)), where dᵣₑₗ(p)=dᵢ(p)/d_{old}(p), and q=1/(c₂−c₁).

The values of the distance d_{old}(p) are taken from the buffer DB, while the new distance dᵢ(p) is computed for the new bone, as described above.

The parameters c₁ and c₂, 0<c₁<1<c₂ define the opening of the sector between the new bone Bᵢ and the previous ones, where the averaging of the old and the new shifts happens. Normally one can take this parameter to be symmetric: c₂=2−c₁. For c₁ about 0.7, the averaging operation is performed normally for at most 10% of the processed pixels. Only for these pixels the computations include division (computing dᵣₑₗ(p)).Remind that all these computation are performed once per animation for each Layer (and not once per frame).

The procedures above complete the i-th step of computing the weights. After all the bones from B₁ to Bₖ in the list BL have been processed, all the weights Swᵢ(p) have been computed (each one for the pixels p in the corresponding rectangle BRᵢ). The updated buffer DB contains the final distances of all the pixels in the union of the rectangles BRᵢ to the part of the skeleton, formed by the bones B₁, . . . , Bₖ.

In an alternative implementation of the algorithm, for each bone Bᵢ, all the computations above, as well as computing the image color for each pixel and updating the frame buffer are performed in one cycle over all the pixels of the bounding rectangle BRᵢ of the bone Bᵢ.

Computing the Bounding Rectangle BRᵢ for Each Bone Bᵢ.

The bounding rectangle BRᵢ for each bone Bᵢ can be computed as follows: First, its size may be explicitly determined from the size of the part of the Layer to be affected by the bone. However, in some embodiments of this case, the parameters of the rectangles BRᵢ should either be included into the transmitted file, or computed inside the player. Another possibility is to compute BRᵢ as a certain fixed neighborhood of the bone Bᵢ, proportional to the size of the bone itself. This method is described below. Its further simplification is achieved by setting each BRᵢ just as a “slice” of the Layer's bounding rectangle LBR, having an appropriate height.

Let the bone endpoints have coordinates (x₀, y₀) and (x₁, y₁), respectively. Denote by v₁=(a, b) the bone vector (x₁−x₀, y₁−y₀). The orthogonal vector to the bone (of the same length as the bone itself) is v₂=(−b, a). Then the vectors, defining the “influence zone of the size S” of the bone are Sv₁, −(S−1)v₁, SWv₂ and −SWv₂, all these vectors starting at the point (x₀, y₀). Here S is the global “size parameter” and W is the “influence width” parameter, which defines the relative width of the bone's influence zone. Now the bone's bounding rectangle has the borders parallel to the coordinate axes. The borders positions are defined by the maxima and the minima of the appropriate coordinates of the corners of the “influence zone of the size S”, as it was described above. If the “slice” bounding rectangles are chosen, then only the y coordinates are used.

Bones Processing Rectangles BPRᵢ

The analysis of the procedures above shows, that in fact the averaging of the shifts S(p) in the i-th step happens only for the pixels p, which belong both to the bounding rectangle BRᵢ of the bone Bᵢ, and to the union of all the previous BR's. Consequently, if BPRᵢ is defined as the minimal coordinate rectangle, containing the intersection of the bounding rectangle BRᵢ of the bone Bᵢ with the union of all the previous BR's, the computation of the weights and averaging the shifts above can be performed only in the rectangles BPRᵢ. For most skeleton configurations, these rectangles cover only a small part of the Layer's pixels, and their use can save both the storage space and the processing time. Notice, that the distances may be computed on BRᵢ's (and not on BPRᵢ's), as described above, since it is not known in advance, where exactly the next bone approaches the preceding ones. The distance to the bones is optionally computed at all the nearby pixels.

Updating the Frame Buffer

This procedure is performed as follows:

As the processing of one of the subsequent layers has been completed, and the shift buffer SB for this layer has been filled in, this buffer SB is scanned. For each pixel p, which is not marked as transparent, four neighboring pixels to the shift S(p) are defined, as the corners of the pixel square, containing the point on the screen with the coordinated x(p), y(p) (where the shift S(p) are x(p), y(p), dep(p)).

Now at each of this four neighboring pixels the new depth dep(p) is compared with the depth already stored at this pixel in the frame buffer. If the depth dep(p) is smaller than the depth already stored at this pixel in the frame buffer (and if the color value received is not “transparent”) the current color and depth values at this pixel in the frame buffer are replaced by the color of the pixel p and by dep(p), respectively. If the received color value is “transparent” or if the new depth dep(p) is bigger than the old one, the data is not updated.

If the occlusion structure of the layers is explicitly stored, the computations may be simplified: the depth of pixels is not computed at all. The layers are processed in order (pre-stored) of their distance to the viewer, starting with the closest one, and their colors are inserted into the frame buffer. As the next layer is processed, its pixels colors are inserted into the frame buffer only at the “free” pixels, and at those previously processed pixels, which have been marked as “transparent”.

Filling the “Empty Pixels” in the Frame Buffer

As it was mentioned above, a “direct mapping” algorithm has an implementation problem, which is to be addressed: as a zoom of a Layer is performed, some pixels on the screen (in the frame buffer FB) may not be covered by the “directly mapped” pixels of the source Layer. “Uncovered” pixels may appear even without any zoom, as a result of a discretization errors in the computations of the shifts S(p).

The “uncovered” pixels may be provided with certain “natural” colors in the run of frame computations. This can be done in two ways: creating and directly mapping additional pixels in the original Layers, or completing the colors of the “uncovered” pixels via the additional processing of the frame buffer.

Pixels Duplication in the Original Layers

Ultimately, one can keep and process the original Layer's bitmaps with a doubled (or tripled) resolution, according to the degree of a zoom, expected in the animation. However, this solution requires a serious increase in the buffer space required. To overcome this difficulty, one can produce “new pixels” dynamically.

More accurately, after the computation of the shifts S(p), as described above, has been completed, and the shift buffer SB has been finally updated, the following procedure is applied:

Local Filling Procedure

This procedure is performed according to the required density of the new pixels. This density is specified by the parameter ZD, which may have integer values 1, 2, 3, etc. Typical values of ZD are 1, 2 and 3.

Let us illustrate the procedure for ZD=2. It is performed while the final run over the shift buffer SB (and the Depth, Color and Transparency buffer DCT). The “new pixels” are added, as follows: one between any two neighbor original pixels, and one in the center of each cell, formed by four neighbor original pixels.

If the new pixel is between two original pixels, it gets the shift, equal to the half a sum of the shifts of the two neighboring pixels. The same for the color and for the depth. If the new pixel is in the center of the cell, formed by four neighbor original pixels, it gets the shift, equal to the quarter of a sum of the shifts of the four neighboring pixels. The same for the color and for the depth.

This completion is performed while running over the pixels of the original grid, each time for the (say) right lower cell of the processed pixel.

If the color palette is used, which does not allow for linear operations on the colors, the new pixels get the color of one of their direct neighbors (for example, the left one). The same rule is applied to the transparency marker.

For ZD=3, 4 etc., the pixel grid is subdivided into the sub-grid with the cell-size ⅓, ¼ etc., and the new pixels are added accordingly. Also the averaging weights for extending the shift, the color and the depth values from the neighbors, are corrected according to the new grid geometry.

The completion of the new pixels, computing of their shifts, color, depth and transparency, and their mapping to the frame buffer is optionally performed while running over the pixels of the original grid.

Color Completion in the Frame Buffer

In an alternative implementation, the color of the “uncovered pixels” is completed in the frame buffer. If all (or some of) the neighbor pixels of the pixel p in the frame buffer got new colors while processing a certain Layer, the pixel p itself cam be provided with the average color of the updated neighbors. The “zoom parameter” ZD defines the number of completion steps required to complete the color of all the uncovered pixels.

However, the proposed procedure involves some “combinatorial” decisions: how far away from the updated pixels may we go, how not to mix the color of the Layer and of the background behind it, etc. All these problems can be solved in a relatively easy way, if averaging is available. In the case of a “non-linear” color palette, a tree of discrete choices is built.

In both the algorithms above it is very desirable to have information on the actual zoom factor in each region of the Layer. This information can be easily produced via the affine matrices of bone transformations. On its base the “zoom parameter” ZD may be computed locally.

In processing of 3D images, the completion procedure described above has some advantages: pixel duplication in the original layers usually improves the quality of visual 3D effects (in particular, of the “horizon lines”).

Bending of Bones

It is mathematically natural and convenient to perform bending, assuming that the bone forms a straight segment, and “bending” it in a normal direction to the amount, prescribed by the bending amplitude parameter bb. In the three-dimensional mode this normal direction is an input parameter, as described in PCT/IL02/00563. In the framework of the algorithm, described above, bending is done at the same time as the affine transformation (i.e. in the procedures described above), over the pixels of the corresponding rectangle BR.

Algorithmically this approach is expressed (in two dimensional mode) as follows: the shift coordinates xᵢ(p), yᵢ(p) are computed by the formula:
(xᵢ(p), yᵢ(p))=(xxᵢ(p),yyᵢ(p))+bb*L2(p)(1−L₂(p))(r, s).
Here xxᵢ(p),yyᵢ(p) are the shift coordinates, computed as in the current direct algorithm, through the affine matrix, associated to the processed bone Bi. The parameter bb is the bending amplitude parameter, and (r, s) is the unit vector, orthogonal to the image bone (under the affine transformation).

As the coordinates xᵢ(p), yᵢ(p) (taking into account the prescribed bending) have been computed, the rest of operations in the procedures of the averaging and updating the SB buffer are performed exactly as before. In the three dimensional mode the depths coordinate dep is processed in the same way as the plane coordinates x and y, according to the three dimensional bending parameters. This concerns equally the procedures, described below.

Computing Hierarchical Motions

The hierarchy of bones exists in the VIM skeleton, as described in PCT/IL02/00563. Some bones may be attached to the other ones, and they move, following the global movements of the “parent” bones. In addition, these “children” bones may be provided with their own relative movement. Optionally, the motion produced by the bones of the second level, is relative to the first level motion. This fact can be expressed in two ways: first, the motion, imposed by the second level bones, can be defined from the very beginning as a “correction” to the first level motion. The affine matrices for the second level bones are computed accordingly. These bones are processed after the first level bones, and their motion is added to the first order motion as a correction, in their appropriate vicinity. The more detailed description is given below.

The second way utilizes the fact, that by the construction of the skeleton, the “children” bones always move in a coherent way with the “parent” ones. Consequently, the affine matrices for the second level bones are computed in the usual way. The difference is, that the motion, produced by the bones of the second level, dominates, in a certain neighborhood of these bones, the motion of the parent bones. This happens even for those pixels, which are closer to the first level bones. Below this algorithm is described in more detail.

Computing Second Level Motions as Corrections to the First Level.

Algorithmically, this approach is implemented as follows: first the “first level” image coordinates x₁(p), y₁(p) are computed and stored in the PB buffer, as described above, using only the first level bones. Next the second level corrections x₂(p) and y₂(p) are independently computed and stored in the same way, using the second level bones. (No interaction between levels is assumed. In particular, the distances to the bones are compared only for the bones of the same level). Finally, the actual image coordinates x(p) and y(p) are computed as
(x(p), y(p))=(x₁(p), y₁(p))+w(p)(x₂(p), y₂(p)).
Here the weight function w(p) is defined as 1 for the distance d₂(p) from p to the second level bones smaller than a fixed threshold D₁, it is (d₂)−D₁)/(D₂−D₁), for d₂(p) between D₁ and D₂, and it is zero for d₂(p) greater than D₂.
Computing Second Level Motions in a General Procedure

In this second approach the second level bones participate in the general procedure, as described above. The main difference is that in the process of the weights computation for the second order bones, only the distances to the other second order bones (and not to the first order ones) are taken into account. Also the weights of the second level bones gradually decrease to zero near the borders of their influence zones. This arrangement guarantees that for a typical second order bone, the pixels inside its influence zone are moved by this bone only, while on the borders of the influence zone the pixels motion gradually returns to the “first level” (or “global”) motion. Besides this, all the rest of computations remain as in the one-level algorithm, described above. Notice, that the size of the influence region (and, consequently, of the bounding region) for the second level bones is normally defined specifically for each bone by the animator.

Bounding Region of Bone Influence

Bounding the bone influence “far away” from this bone is achieved by multiplying the relative motion, produced by this bone, by the weight w(p), defined as follows: let for a processed bone Bi, dᵢ(p) be the distance from the pixel p to the bone, computed as above.

The weight function wᵢ(p) is defined as 1 for the distance dᵢ(p) from p to the bone smaller than a fixed threshold D₁, it is (dᵢ(p)−D₁)/(D₂−D₁), for dᵢ(p) between D₁ and D₂, and it is zero for dᵢ(p) greater than D₂.

Now, in the process of computations, described above, the weight functions Swᵢ(p) are multiplied by the weights wᵢ(p).

When bounding the influence zone of a certain bone, it is desirable to separate “global” and “relative” components of the motion: while the processed bone provides the “relative” or the “local” motion component, it should be blended, on the borders of the influence zone, with the “global” motion. This “global motion component” may be provided by the “parent bones” or by a rigid 3D motion of the character.

Computing a Linear Function on the Pixels Array

This is a special case of computing a bi-linear function, as described above. The increments of a linear function between neighboring pixels are constant along the array, and can be computed once per bone. Consequently, the average amount of operations per pixel (for big arrays) in computing linear functions is one addition per pixel. The proposed algorithm is organized in such a way, that utilizing a linear functions subroutine in this form improves accordingly the overall performance.

Improving Efficiency by Marking Inactive Layers

In most animations only a part of the objects actually move between consecutive frames. Consequently, big areas of the screen do not need to be updated from one frame to another. This fact can be used to improve efficiency of both VIM-R1 and VIM-R2 players. In some embodiments of the invention, for each frame, each of the layers is marked with one bit marker M. M is zero if the layer does not move from the current frame to the next one, and M is one, if the layer does move. Background layer is included into the marking.

For each pixel p of the screen, the color at this pixel does not change from the current frame to the next one, if the closest to the screen layer, covering the pixel p, is marked with 0. Accordingly, only the pixels, which do not satisfy this condition, need to be updated.

To simplify the implementation, rectangular areas on the screen, not intersecting moving layers at all, are constructed in the inverse mapping algorithm. These rectangles are excluded from the processing for the current frame.

In the direct mapping algorithm, those layers, which are marked by 0 and which are closer to the screen (i.e. their depth is smaller) than other layers, are excluded from the processing. In a different implementation, the screen is subdivided into relatively small parts (sprites) and each part is processed separately. Those parts, which are covered by not moving layers, which are closer to the screen (i.e. their depth is smaller) than other layers, are excluded from the processing.

VIM Representation of Three Dimensional Objects and Scenes

In the VIM representation, as disclosed in PCT applications PCT/IL01/00946, PCT/IL02/00563 and PCT/IL02/00564, depth value can be associated to each of the CORE/VIM elements, thus making the image three-dimensional. In a preferred implementation depth value is added to the coordinates of each of the control points of the splines, representing characteristic lines, to the center coordinates of patches and to the coordinates of the background points. Alternatively, depth values are associated with the Color Cross-section parameters of the characteristic lines.

According to VIM description in PCT/IL02/00563 and in the Provisional applications, VIM layers may have a common boundary. This boundary is formed by Lines, which are contour Lines for each of the adjacent layers.

In some embodiments of the invention, in order to represent in VIM structure a full 3D object, its surface is subdivided by certain lines into pieces, in such a way that each piece is projected to the screen plane in a one to one way. (This subdivision process can be performed by conventional 3D graphics tools).

Each subdivision piece is represented by a VIM layer, according to the method, described in PCT/IL01/00946, PCT/IL02/00563 and PCT/IL02/00564. The boundary lines are marked as the contour Lines of the corresponding layers. Finally, a bit is associated to each layer, showing, what side of this layer is the exterior side of the object surface and hence is visible. (In most cases this information is redundant and can be reconstructed from the rest of the data).

In particular, polygonal surfaces, used in conventional 3D representation, satisfy the above restriction. Hence they can be used as the “geometric base” of the VIM 3D objects. The visual texture of these polygons is optionally transformed into VIM format.

Usually the proposed method gives serious advantages in representation of 3D objects and scenes. First of all, the number of layers in the above described VIM representation is usually much smaller than the number of polygons in the conventional representation. This is because VIM layers have a depth—they are not flat, as the conventional polygons.

The second reason is that the boundary Lines of the VIM layers on the surface of the 3D object usually depict visually significant features of the object: they coincide with the object's corners, with the edges on its surface, etc. In the VIM structure these Lines serve both as geometric and as color elements, that reducing significantly the data volume.

The VIM structure fits exactly to the structure of the rendering process, as described above. The VIM player accepts the VIM data as the input and back-plays it in an optimal way.

Semi-Automatic Object Separation (Cut-Out)

In some embodiments of the invention, an animation authoring tool is used to generate images and/or to generate animation sequences based on one or more images. The authoring tool may optionally run on a general purpose computer or may be used on a dedicated animation generation processor.

In some embodiments of the invention, the authoring tool is used to separate a character or other object from an image, for example a scanned picture. Thereafter, the character may be used in generating a sequence of images. The separated character optionally includes a pattern domain from the original image which becomes a sub-image on its own. In some embodiments of the invention, the separated character is filled to a predetermined geometrical shape (e.g., a rectangular) with transparent pixels.

It is known that the visual impression at any point on the image is determined by a vicinity of this point and not only by the point itself. Therefore, in some embodiments of the invention, the authoring tool stores the character with identification of boundary characteristic lines, as described in the Patent applications quoted above. First, characteristic lines, being much more flexible visual tool, than conventional edges, usually provide a much more coherent definition of object contours. This makes contours tracing much easier, and allows for an automatic tracing.

Second, characteristic lines capture most complicated visual patterns, which may appear as object contours. This includes different camera resolutions and focusing, illumination, shadowing and various optical effects on the objects visible contours. Complicated contour patterns, as tree leaves, animal fur etc, are also faithfully represented by characteristic lines with appropriate signatures.

For a pattern domain bounded by characteristic lines, the separated image retains these bounding lines, along with the corresponding signatures (cross sections or Color Profiles in U.S. patent application Ser. Nos. 09/716,279 and 09/902,643 and PCT application PCT/IL02/00563). The signatures, which represent semi-local visual information, maintain the integrity of the visual perception after the pattern domain separation. If necessary, a margin of a “background image” can be kept in conjunction with the separated domain.

Therefore, in one embodiment, the separation of a pattern domain is performed by the following steps:
1. Marking contour characteristic lines,
2. Closing gaps in contour characteristic lines,
3. Forming the separated image (in a raster on in a VIM format).
   Marking Contour Characteristic Lines

The marking of contours is optionally performed as a combination of automatic and human operations. In some embodiments of the invention, using the mouse, the operator marks a certain point on a central line of the characteristic line, bounding the object to be separated. This marking is automatically extended to the interval of this line between the nearest endpoints or crossings. If the extension stops at a crossing, the operator (referred to also as the user) marks a point on one of the characteristic lines after the crossing, and this marking is automatically extended to the interval of this line till the next endpoints or crossing. When this part of the procedure is completed, the pieces of the boundary characteristic line are marked.

Closing Gaps in Contour Characteristic Lines

The gap closing is optionally also performed as a combination of an interactive and an automatic parts. First the operator closes the gap in a central line of the characteristic line, using the conventional drawing tools. The curve drawn is automatically approximated by splines. Then the Color Profile is automatically interpolated to the inserted segments from their ends. In this way all the gaps are subsequently closed. Usually the gaps in boundary characteristic lines are relatively small. Closing these gaps the operator follows the visual shape of the object to be separated.

Forming the Separated Image

This operation is optionally performed in two modes: in the conventional raster structure, and in VIM structure.

The separated raster image is formed in a rectangle, containing the separated pattern and the boundary Line, together with its characteristic strip. For all the pixels inside the interior contour of the characteristic strip of the boundary Line their original color is preserved. To all the pixels inside the characteristic strip the color of the Line Color Profile is assigned. Finally, the pixels outside the exterior contour of the characteristic strip of the boundary Line are marked as the transparent ones. This procedure eliminates the undesired visual effects, related to a pixel-based separation.

In the VIM image mode all the VIM elements inside the boundary Line are marked, and a VIM layer is formed, containing the boundary Line together with all the marked elements.

Alternatively, to displaying characteristic lines of the image to the user, so that the user can follow the lines in defining the boundary, in some embodiments of the invention, the user does not see the boundary Lines at all. The image is represented on the screen in its usual form. The operator follows approximately the desired contour. The authoring tool automatically identifies the nearby lines and shows them to the operator as the proposed start or continuation of the contour. The operator indicates acceptation of the proposed parts (or selects one of a plurality of proposed parts), which are marked accordingly. In each case, where the possible continuation is unique (i.e. until the next crossing), the authoring tool selects the line portion automatically. After crossing, the authoring tool optionally suggests to the operator possible continuations, following the approximate contour, drawn by the operator. In some embodiments of the invention, both geometric proximity and color consistency are taken into account. In case where no one of the proposed continuations is accepted (or there are no continuing Lines at all) the operator draws interactively the desired continuation. Small gaps are closed automatically, following the approximate drawing by the operator.

In another embodiment of the invention, the operator uses an appropriate Mold (or Molds) from the Molds library, fits approximately the Mold to the object to be separated, and applies automatic operations of improved fitting and cut-off, as described below.

Animation Based on Molds

Most modern imaging applications, such as advertising, computer games, computer-based education and training, web libraries and encyclopedias use animation. In some embodiments of the invention, the authoring tool uses one or more base images and/or a video-sequence in generating animations and/or virtual worlds.

In some embodiments of the invention, the authoring tool includes a library of simple “models” (called molds). The molds allow for an easy intuitive fitting to most of specific photo-realistic characters, given by still images or video-sequences. In some embodiments of the invention, molds are provided with a library of previously prepared animations. Optionally, the mold library includes for one or more types of objects, a plurality of molds designating the same object from different directions. For example, for humans, the library may include between about 4-10 molds viewing the human from different angles. These molds may be generated from each other using rotation techniques known in the art. If desired, a plurality of images of a single character, taken from different angles may be used with respective molds to generate a set of different angle embodiments of a single character.

Optionally, in preparing an animation, the authoring tool receives one or more still images which are displayed to the user. The user optionally searches in the mold library for an appropriate mold in the library. The user then, optionally with automatic aid of the authoring tool, fits the mold to the actual character. The character from the image can then be operated with movements from the library of previously prepared animations.

The adaptation and/or fitting of the mold to the character optionally includes moving the Mold in space, resealing it, moving one or more limbs of the mold, changing the mutual positions of the limbs within the pre-defined kinematics and, if necessary, directly perturbing Mold's contour. In some embodiments of the invention, after the Mold has been approximately fitted to the actual character, the authoring tool automatically completes the fitting, separates the character from its base image, divides the character into Layers and provides the mold's animation to the character. Optionally, the operator, on each step, can correct interactively any of the automatic decisions and/or may choose to perform one or more of the steps manually.

In one embodiment, a Mold is a 3D wire-frame, allowing for an easy adjustment to an actual character or object on the image (of the same type as the Mold). Being adjusted, the Mold captures the character and brings it with itself to the animated 3D virtual world. Optionally, in this embodiment a Mold is a combination of one or several three-dimensional closed contours, representing a typical character or object to be animated, as it is seen from a certain range of possible viewer positions. It is furnished with a kinematics, providing the user a possibility to control interactively its 3D position. In particular, various types of Skeletons can be used for this purpose. Especially efficient is a three dimensional VIM Skeleton, as described in PCT patent application PCT/IL02/00563. Any motion of the Skeleton implies the corresponding motion of the Mold. This allows (through the appropriate motion of the skeleton) for changing relative positions of the Mold's limbs (pose), and for transformations, corresponding to a change in the Mold's 3D position (in particular, scaling, rotation and translation).

On the plane of a given still image, the Mold appears as seen from a certain viewer position, i.e. as a combination of one or several two-dimensional contours. Being positioned on a still image, the Mold “captures” the part of the image it encloses: each contour of the Mold memorizes the part of the image it encloses, and from this moment the captured part of the image moves together with the contour. Combining changes in its 3D position and changes in its pose, the Mold can be roughly adjusted to any character of the same type as the Mold. Then the Mold allows for a fine fitting of its contours to the actual contours of the character.

Some parts of the character on the image may be occluded. After being accurately adjusted to this character, the Mold allows for completion of the occluded parts, either automatically, by continuation from the existing parts, or interactively, by presenting the operator exactly the contour to be filled in.

Preparation of a Mold

In some embodiments of the invention, molds are prepared interactively. An operator optionally produces the contours of the Mold in a form of mathematical splines (for example, using one of conventional editing tools, like Adobe's “Director” or Macromedia's “Flash”). In the same way the Skeleton is optionally produced and inserted into the mold. The three-dimensional structure of the mold is optionally determined by the operator interactively (for example, using one of conventional 3D-editing tools.)

In some embodiments of the invention the mold is associated with a “controller” computer program, relating the position of the Skeleton with the position of the mold's Contours, and allowing for an interactive changes in the 3D position of the Skeleton and in relative positions of its parts. A type of the controller is normally chosen in advance for all the Mold library. As required, it can be constructed specially for any specific Mold, completely in the framework of one of conventional 3D-editing tools). In an embodiment, a VIM Skeleton, as described in the PCT patent application PCT/IL02/00563, is used, providing, in particular, the required controller.

Normally, Molds are constructed, starting with an appropriate character (given by a still digital image). The contours of the character, are represented by splines (using, for example, Adobe's “Photoshop” and “Director”). Conventional edge detection methods can optionally be used in this step. The initial contours, produced in this way, are completed by the operator to the desired Mold contours. This completion is performed, according to the requirements of the planned animation: each part of the character, which can move completely independently of the others, is normally represented by a separate Mold contour. However, the parts, which are connected in a kinematical chain with bounded relative movements, like parts of a human hand, are optionally represented by one contour per chain.

Alternatively, Molds can be constructed, starting with a computer-generated image, with a hand drawing etc. An important class of Molds comes from mathematical geometric models. They serve for imposing a 3D-shape onto geometrically simple object on the image. For example, the Mold, given by the edges of a mathematical parallelepiped in 3D space, allows to impose a 3D-shape to a “cell-like” object, or (from inside) to an image of a room-like scene. Simple polygonal Molds further extend this example. The Skeleton in these cases may consist of one point, thus allowing only for rigid 3D-motions of the object.

Animation of Characters into Virtual 3D-Characters

To animate a certain character, presenting on the input image, the operator optionally finds a similar “Mold” in the library of the pre-prepared Molds. If no such Mold exists in the library, the operator optionally creates a new Mold for this character (or object), by the process. Then the operator optionally adjusts the chosen Mold's size, pose and relative position to that of the character. Finally, the Mold's contour is accurately fitted to the actual contour of the character to be animated (Many of these operations can be performed completely or partially automatically, as described below).

In some embodiments of the invention, as the adjustment of the Mold is completed, the character is separated from the initial image, and carried together with the Mold into any desired space position and pose. In some cases completion of the occluded parts of the character is necessary. The operator performs these completions, using the structure of the Mold as follows: the occluding contours are moved into a position, where they open completely the occluded parts of other contours. Then the operator fills in the image texture on these occluded parts, using conventional tools, like Adobe's Photoshop.

An animation of the character can be prepared now in a very easy and intuitive way: just by putting the character into the required subsequent key-frame positions, using the possibility to change interactively both the space position and the pose of the Mold (Mold's controller). In a preferred implementation this is done simply by picking a required point of the skeleton with the mouse, and then moving it into a desired position. The created motion is automatically interpolated to any required number of intermediate frames. Any pre-prepared animation of the used Mold (these animations are stored in the library per Mold) can be reproduced for the character.

It is noted that:
1. A mold, created for a photo-realistic object or character, given by a still image, represents this object or character, as seen from a certain fixed position. However, this mold, inserted into the 3D-space, and then rendered, provides, in fact, a faithful representation of the initial object or character, as seen from any nearby position, and not only from the initial one.
2. A visually reasonable change in a mutual position of the mold's contours creates a photo-realistic effect of a change in a “pose” of the character.
   Together these two facts allow one to reduce the number of different molds, necessary to represent in a photo-realistic way any reasonable position and pose of a character to a very few.
   Creation and Playback of Virtual Worlds

The character created as described above, together with its adjusted Mold, forms a complete virtual 3D character. The operator inserts all the desired characters and objects, prepared in this way (or taken from the library) into the virtual world under construction. Beyond photo-realistic human, animal etc. characters (or their synthetic counterparts), the photo-realistic or the synthetic background, trees, houses, furniture and other objects can be used (and included to the appropriate libraries).

The virtual worlds, created in this way, can be rendered and presented on the screen, together with their animations, as follows: in order to use conventional players, like the Flash one, the characters layers are transformed into raster layers, and their motions are transformed to the motions, recognized by the player.

In an embodiment with the VIM images and VIM Skeleton (as described in the patent applications quoted above), the virtual worlds and their animations, produced with Molds, are VIM scenes and animations. Their playback is performed by VIM players, as described in PCT/IL02/00563 and in the (First part).

Three-Dimensional Character Animation

In some embodiments of the invention, a virtual character or object, represented by a Mold, shows the original character or object, only as seen from a certain range of viewer positions. Optionally, in generating a complete 3D-animation the following acts are performed:
1. Several still images, showing the animated character from different positions, are used. (As it was explained above, normally a very few such images are required).
2. For each one of these images a corresponding Mold is found in the library (or created), and corresponding virtual characters are built, as described above, each representing the same original character from a different viewer position (and/or, if necessary, in a different pose).
3. Each time in the run of an animation or in the process of an interaction with a virtual world, as the actual viewer position moves from the range of one of the virtual characters to the range of the another one, the corresponding virtual characters automatically replace one another. The same happens as the changes in the character's poses force the replacement of their virtual “representatives”.
4. To provide continuity in the characters motion, an interpolation between the frames, corresponding to the switch of the virtual “representatives”, can be performed. Its implementation is especially easy and natural for VIM images.
5. A particular case of a representation by several virtual characters, is a “flip”. In this case only one still image of the character is used, which represents this character (or object) as seen from a side. A “flip” is optionally built by a reflection of the corresponding virtual character or object with respect to the vertical axis on the screen, as thus does not require memorizing of any additional information Normally, a flip alone is not enough to create a truly 3D representation, but assuming that the actual object looks from both sides roughly in the same way, it allows for creation of a reasonable illusion of rotated character or object in animations.
   Reducing Data Volume of Characters Created with Molds

Using Molds allows one to reduce significantly the volume of the data, necessary to store virtual objects and characters. The Mold itself is normally taken from the pre-prepared library, which is available to each user of the method and consequently is not stored per animation. To store a specific virtual object or character only the following information is stored:
1. The 3D and “pose” transformations of the Mold, necessary to adjust the Mold roughly to this specific object. This information is optionally bounded to several bytes.
2. Accurate fitting transformation of the Mold to the object. Since this transformation appears as a small correction to the initial adjustment, it can be memorized in a compact way.
3. The parts of the initial digital image, enclosed by the mold's contours. This information is encoded, using one of conventional methods (for example, JPEG or PNG compression), or using VIM coding, as described in the (First part). Also here, the actual image can be stored as a correction to the Mold's pre-prepared texture, reducing significantly the volume of the stored data.
4. Animation scenarios, being sequences of key-frame Mold's skeleton positions, are stored as corrections to the library ones.
5. If several virtual characters are used to represent a single original one (as described in section e. above), their total data volume can be significantly reduced. The geometric and the texture data of each of them can be represented and encoded as a correction to the corresponding data of the previous one. For this representation to be efficient it is important to put both the virtual characters into the same position. This can be easily done, using the properties of Molds, described above.
   Fitting of the mold Contours

One issue in animation with the help of Molds is a part of the process, where the Mold's contour is accurately fitted to the actual contour of the character to be animated. While a preliminary rough adjustment of the Mold contours to the actual contours of the character are very intuitive and easy, the last stage may require tedious work, since it concerns low scale details. It is also desired for preserving a photo-realistic quality of the image. In some embodiments of the invention, the authoring tool may completely or partially automatically perform a fine tuning of the fitting of the mold to the character. In an exemplary embodiment of the invention, this automatic fitting is achieved as follows:
1. Edge detection is performed on the character to be animated, using one of conventional methods. The resulting edges are marked.
2. The square deviation of the Mold's contours to the marked edges is computed for each contour separately.
3. This square deviation is minimized (for each contour separately) with respect to the control parameters of the splines, representing the Mold's contours.
   Normally, this minimization converges fast, since its starting point is a good initial approximation of the actual contours by the Mold, obtained interactively on the first stage of the fitting. It provides usually a very good fitting of the detected edges, and a very reasonable completion of the contours in the areas where the edge detection failed.

A simplified version of the above process can be applied:
1. A coordinate system (u,v) is associated to each contour of the Mold. Here u is the distance of a point from the considered contour and v is the coordinate of the projection of the point onto this contour.
2. An average value of the u-coordinate is computed for the marked edges for each spline element of the contour.
3. This element is shifted to the position, corresponding to the computed average.
   VIM-Based Implementation of Molds

In some embodiments of the invention, molds are implemented within the VIM structure, while applied to VIM images and scenes. Optionally, a VIM object or character can be automatically transformed to a Mold. The transform optionally includes taking the contour Lines of the VIM layers, participating in the object or character as the Mold's contours, and taking the object's or the character's Skeleton as the Mold's Skeleton, and in omitting the VIM Texture of each of the layers. In some applications (for example, in motion tracking, described below), the VIM Texture of each of the layers is preserved in the Mold. It further serves as a base for color comparison in a fitting in subsequent video frames.

In fitting the mold to a character of an image represented by the VIM representation or any other vector format, the fitting is optionally performed by the user indicating the lines of the image to serve as borders. Optionally, when necessary, the user draws border lines in cases when the image does not have border lines which entirely surround the character. Alternatively or additionally, the authoring tool automatically closes gaps between border lines.

A typical case in the Character Definition is that several Layers of the same character are defined and cut-off. A difficulty which may arise is that in order to define and cut off each Layer, its contours have to be completed in the image parts, where there are no edges (and should not be, since Layers form artificial image parts, not reflecting the actual character structure). Once more, the animator normally solves difficulties of this sort by just drawing a desired contour. Clearly, no conventional “Contouring tool” can help here. On the other hand, for typical Casts (human, animal etc.), their separation into Layers follows essentially the same patterns. Also here this “creative” solution in most of situations turns out to be generic (and hence allowing for automation). The new contours drawn normally just “close smoothly” the “ends” of the existing Layers contours, extrapolating their geometry.

The Character (Cast) layers are usually assumed to partially occlude one another. In some cases the logics of the layers partition prescribes that the color of each of the overlapping layers be taken directly from the original image. In other cases the color of the occluded layer's part has to be completed by a “continuation” of the existing image. As in the rest of the Character Definition steps, the color completion is quite generic for most typical situations: it requires only knowing the layers “aggregation diagram”, as is now described.

Layers Aggregation

To produce a Cast, layers are optionally aggregated into a system, incorporating, in particular, their mutual occlusions. (The joint kinematics of the layers is provided via their attachment to the Skeleton). An “aggregation diagram” of the Layers into the Cast is memorized in VIM via insertion of their depth. An important point here is that this “aggregation diagram” is usually fairly generic. A small number of “aggregation diagrams” (profile, en face, etc.) suffices for most of the human Casts. The same is true for animals, toys, etc. Of course, animation of a completely unconventional character will require an individual “aggregation diagram”.

Skeleton Insertion

This operation creates the desired Skeleton (or inserts a Library Skeleton), in the desired position with respect to the character. Once more, a small number of generic Skeletons are normally enough. Also insertion of the Skeleton into the Cast normally follows some very simple patterns. (For example, to specify an accurate insertion of a Skeleton into a human Cast it is enough to mark interactively a small number of points on the image—endpoints and joints of arms and legs, etc.).

Objects Preparation and Animation in VIM with Molds

As described above, one aspect of the Mold technology, (especially in its VIM based implementation) is to accumulate the generic information in the operations above (and eventually much more) into a number of typical VIM Cast Models (Molds). Then all the above operations are replaced by the only one interactive action: fitting a Mold to the Character. The rest is optionally done automatically.

Automatic Character Contouring, Guided by the Nearby Mold's Contours

This block provides an automatic character contouring, guided by the nearby Mold's contours. This block works with the VIM representation of the character. It analyses the actual Lines within the prescribed distance from the Mold contour. The geometry of these Lines is optionally compared with the Mold contour geometry. The Color Profiles of the Lines are compared with the Colors, captured by the Mold from the Character (for example, by averaging the color of the Character “under” each of the Mold's Layers). Those Lines which turn out to be closer to the Mold's contours than the prescribed thresholds, are optionally marked as the potential Layers boundary for the actual Character. If there are gaps in the identified contours, these gaps are closed by the Lines, whose geometry follows the Mold's contour geometry, and whose Color Profiles interpolate the Profiles at the ends of the gap to be closed.

Automatic “Fitting Correction” Tool

This tool allows to improve a coarse preliminary fitting of a Mold to an actual Character, and to make it as accurate as possible. It is based on an automatic minimization of a certain “fitting discrepancy” between the Mold contour and the actual Character contour. This fitting discrepancy is a weighted sum of the distance and the direction discrepancies (which are computed through a representation of the actual Character contour in the coordinate system, associated to the Mold contour, as described above) over all the Segments of the Mold. This block is described in detail in section 2.7 above. In a specific VIM-based implementation, in addition to a geometric information, also Color Profiles information is taken into account: the Lines whose Color Profiles fit the Colors, captured by the Mold from the Character (for example, by averaging the color of the Character “under” each of the Mold's Layers), obtain larger weights in the discrepancy computation.

Mold Guided Closing of “Big Gaps”

As it was explained above, in some relatively big image areas no edges may separate the Character from the background. In such situations the “big gaps” are closed as follows: first the points on the Mold contour are identified, which correspond to the end of the gap to be closed. Then the part of the Mold contour between the identified points is “cut out” and adjusted (by a rigid motion in the plane and a resealing) to fit the end points of the actual gap. The color Profiles for the new part of the Character's contour are completed by interpolation of the end values, combined with the sampling of the actual images color at the corresponding points, and by taking into account the Mold's predicted Colors, constructed as described above (for example, by averaging the color of the Character “under” each of the Mold's Layers).

A very important advantage of the Mold guided closing of “big gaps” is the following: in the difficult cases, described above, where there are no edges at all, or where the image includes a complicated edge net, not reflecting the Character's actual shape, Mold always produces a “reasonable” answer, which can be used in a further animation process.

Mold Guided Layers Definition, Aggregation and Skeleton Insertion

As all the layers contours have been completed as described above, the character layers are identified as the VIM image parts, bounded by the VIM contours, fitted to the corresponding Mold layer's contours. The character layers, created in this way, correspond in a one-to-one fashion, and geometrically fit, the Mold's layers.

The aggregation diagram of the character is taken to be identical to the Mold's layers aggregation diagram. In particular, the same depth is associated to the character layers, as in the Mold. The Mold's Skeleton is inserted into the character to be created, exactly in the position, which has been achieved by the accurate fitting of the Mold to the character, as described above.

Combination of Several VIM Characters or Objects, for Three-Dimensional Characters

Each VIM object or character represents the actual one, as seen from a certain position. Several VIM representations of the same object or character, representing it in different poses and as it is seen from different positions, are combined to capture a full 3D and motion shape of the object or character. As the viewer position and the pose in the animation change, a corresponding VIM representation is used. Since, because of 3D and animation capabilities of VIM, each VIM representation covers a relatively big vicinity of the specific pose and the specific viewer position, relatively few VIM representations are required for a full 3D and motion covering. This combination can be performed with ore without using Molds.

Content Creation Tools for Non-Professionals

In some embodiments of the invention, the authoring tool provides features for non-professional users. Optionally, a user may specify a Character type (“human”, “dog”, etc.) and mark in a sequence, a number of “characteristic points” on the Character image (say, endpoints and joints of arms and legs). In doing this, the user is optionally guided by a schematic picture of the model Character, which displays and stresses the characteristic points to be marked, in their required order. Then an appropriate Mold is automatically found in the Library and optionally automatically fitted to the Character. The animation scenario may also be produced automatically: the user has only to specify the animation type (for example, “dance”, “run”, etc.).

Mold technology allows one also to trace automatically a motion of a Character in a video-sequence. Thus it provides another key ingredient in making photo-realistic animation available for non-professionals (and dramatically simplifies a work of professional animators). This application is described in detail below.

Mold Based Motion Tracking

One application of imaging technologies is production of highly compressed Video-Clips, and in particular, “Sport” Video-Clips. The importance of this application becomes especially apparent in the world of Wireless Communications. Motion tracking is one of the most important components in the production process of Synthetic Video Clips (in particular, of VIM animations). In some embodiments of the invention, a method for motion tracking, combining Mold technology and VIM technology is provided.

Semi-Automatic Motion Tracking

This method uses as an input a video-sequence, representing a continuous motion of a certain character. The motion tracking is performed as follows:

The character is separated and transformed into the VIM format on the first video frame (or any other frame, where the character is presented in the best way). Then this character is transformed to a Mold, as described above. Subsequently this Mold is fitted onto the same character, as it appears on the subsequent video frames.

This fitting is performed automatically, since the Mold's position on the previous frame, together with its previous motion, usually gives a sufficiently good prediction for an accurate fitting (as described above) on the next frame. Each time, when the automatic fitting fails, the operator intervenes and helps the tool to continue motion tracking.

As it was mentioned above, in motion tracking, the VIM Texture of each of the character's layers is preserved in the Mold. It further serves as a base for color comparison in a Mold fitting in subsequent video frames.

Another possible “task division” between the operator and the automatic tool is as follows: as before, the VIM character, created on the first frame, is used as a Mold to fit the same character, as it appears on the subsequent video frames. But now the operator interactively performs this fitting for each “Key frames” (say, for each 10-th frame of the video-sequence). Then the tool automatically interpolates the Mold's motion between the Key frames, and, if necessary, performs a fine fitting.

In some embodiments of the invention, camera motion is incorporated into the procedure. For key frames, the operator may insert a camera position, and the authoring tool automatically interpolates the camera position for frames between the Key frames.

The resulting VIM character, and the resulting sequence of the skeleton positions (scenario) is the output of the motion tracking.

In motion tracking of small characters (for example, a general view of the field in football video sequence) it is not necessary to separate the actual characters and to make them VIM characters. It is enough to take an appropriate Library Model, to fit it to the actual character on the first frame, and to use it both as the Mold for Motion Tracking, and as a VIM Cast. Only clothes colors have to be corrected according to the actual characters.

One feature of the Mold Motion Tracking is that the degrees of freedom of the Mold (given by its skeleton and its 3D motions) are usually sufficient, but not redundant, for the fitting. This makes automatic fitting and tracing computationally stable.

This feature also allows one to use known conventional algorithms for motion tracking, especially, tracking of “characteristic points”. Assume, for example, that movements of the endpoints of the character's hands and legs, and of their joints can be traced. Then this information can be translated directly into the Skeleton movements of the Mold, as described above.

In some embodiments of the invention, semi-automatic motion tracking includes the following steps:
A general “VIM Video-Editor”, which allows for interactive processing of any desired frame in a video-sequence, transforming it into VIM format, moving VIM Cast and Molds from frame to frame, etc. This tool is described in detail below.
An automatic “fitting correction” tool. This tool allows to improve a coarse preliminary fitting of a Mold to an actual Character, and to make it as accurate as possible. It is based on an automatic minimization of a certain “fitting discrepancy”. It has been described above.
It is noted that the described Semi-Automatic Motion Tracking is a very important ingredient in allowing non-professionals to produce high quality animations and video-clips. Indeed, the most difficult part in any animation is, undoubtedly, the motion creation. The high-level professionals like Disney, Pixar etc. use expensive Motion Tracking tools for this purpose. The Motion Tracking method and tools, proposed in the present invention, provide Motion Tracking for non-professionals. To create a photo-realistic complicated motion animation, it is required just to ask one's friend to perform this motion, to take its movie with a video camera, and to apply the VIM Motion Tracking Tool.

In some embodiments of the invention, the motion detection is performed completely automatically without human aid. Alternatively, the motion detection is only partially automatic. In this alternative, for example, when the appearance of a character changes drastically between frames, for example because of its complicated 3D rotation, a user indicates to the authoring tool the new location of the character. Optionally, the tool calls for the operator assistance. The operator optionally creates a new character (or new parts of the old character), reflecting the new character appearance, and starts another fragment of motion tracking.

Another very important remark is that application mode of the proposed tools strongly depends on the application in mind. One of important target applications—preparing Synthetic Video Clips for the mobile phones (and for a wireless applications, in general)—provides a rather high tolerance to certain inaccuracies in capturing both the Characters and their motion. This tolerance is taken into account in fitting threshold tuning and in tuning of coding parameters.

In the case of wireless applications a typical application assumption for the proposed tools is that the processing is performed on a relatively big screen size (CIF and bigger), while the resulted clips are presented on a QCIF screen size and smaller. However, the described invention is applicable to any screen size.

Data Reduction

The semi-automatic authoring tools, described above, allow for a very easy preparation of animations and Synthetic Video clips. For example, in a specific application of Sport Synthetic Video clips for wireless distribution (and in most of the other wireless Synthetic Video applications) some special tools may be applied in order to increase essentially the data compression. Below these tools are described, with Football Video-Clips as an example. The output quality provided is sufficient for the screen size and quality of wireless applications. The operator can intervene in each stage, control the result and if necessary, correct the clip interactively.

The “Football” Clips consists usually of two parts: a general view of the field or of the gate area and a closer view of the players. The first part, with the size and quality of wireless applications, does not require individual preparation of players at all. Only the colors of the teams uniform have to be defined specifically.

So the “layers Library” can be prepared and used, together with the “Motions Library” (both specific for a sport discipline). In the same way, the Football field, the gate and the audience do not need to be prepared individually. A couple of standard models, with a possibility to change the clothes color, suffices. The use of Libraries improves also the Clips quality (although not authentically to the original sequence): for example, the audience can be inserted, more details of the field and the gate preserved etc., without a need to transmit any additional information.

Also the VIM capabilities in expressing 3D-motions via 2D Animation are naturally incorporated into the Motion Library. This approach reduces the transmitted data size of the “general view” part of the clips virtually to zero. The second part (a closer view) is represented as described above.

Semi-Automatic Tool for Motion Tracking

In some embodiments of the invention, the main parts of a semi-automatic motion tracking tool are the following:
A general “WIM Video-Editor”. It uses as an input one or several video-sequences. Each required frame of an input video-sequence can be displayed on the screen and processed interactively or automatically. The processing possibilities include transforming of the entire frame or its part into VIM format, creating VIM characters and Molds, as described above, moving VIM characters and Molds or their parts inside the chosen video frame, or from one frame to another, changing the color of the characters and their parts. In particular, moving VIM characters and Molds or their parts inside the chosen video frame is performed in two ways:
   either through interactive moving with the mouse the Skeleton (shown in a separate screen or superimposed on the character), by picking the Skeleton bones and driving them into the desired position,
   or through interactive moving with the mouse the character itself, by picking the character parts and driving them into the desired position.
An automatic “fitting correction” tool. This tool allows to improve a coarse preliminary fitting of a Mold to an actual Character, and to make it as accurate as possible. It is based on an automatic minimization of a certain “fitting discrepancy”. It has been described above.
An automatic “motion prediction” tool. This tool predicts the Mold or the character position in the next video-frames on the base of their positions in the current and in the preceding frames. The prediction is performed via the mathematical extrapolation of the Skeleton geometric parameters from the current and the preceding frames.

In one embodiment, the motion tracking tool can be used in a simple form, without Molds. The character on a certain frame is optionally created, and then this character is interactively fitted to the actual character positions in the following frames, using the Skeleton or the character interactive moving, as described above. The resulting sequence of the Skeleton positions provides the required animation.

VIM Transcoding

Some of the most important VIM applications are in the world of Wireless Communications. Here VIM representation, with its extremely reduced data volume, high visual quality and a possibility to fit various end user displays, provides very serious advantages. One of the most important VIM advantages is in a possibility to transform (transcode) other conventional formats to VIM, and VIM into other formats. Indeed, VIM provides a description on the Scene, the Objects and their motions, in a very compact and transparent vector form, and this information can be used in a clever transcoding in each direction.

Translation of popular conventional formats (like SVG, MPEG or Flash) into VIM provides a possibility to use their rich existing content and their popular authoring tools. Moreover, translation'to VIM can be used to improve quality of images and animations and to reduce their data size, as described below.

In another application, described below, combination of the structured VIM information with the original image allows one to improve quality of images and animations and to reduce their data size, while remaining in the original format.

Import of Other Vector Formats into VIM

Besides VIM unique features, allowing this format to represent in a highly compressed form photo-realistic images, animations and 3D objects, VIM format contains all the conventional vector imaging possibilities and tools, existing in other vector formats.

As a result, the content created with popular vector tools and formats, like Macromedia's Flash, Free Hand, Adobe's Illustrator, SVG and others can be automatically imported into VIM, while preserving its fill image quality and data volume.

Importing of popular conventional vector formats into VIM is important, since it allows the user of VIM to adopt a rich visual content, created in these formats, to rescale and to transmit it to wireless devices.

The following main features of VIM make importing of other vector formats into VIM advantageous:
i. Being translated to VIM, visual content can be used throughout the VIM wireless environment.
ii. In many cases translation into VIM provides higher compression, because of the superior methods of VIM geometric and motion representation.
iii. In many cases visual quality of the content, translated into VIM, can be strongly enhanced, while preserving data volume, using specific VIM tools, like Color Profiles, Area Color etc.
iv. In many cases (for example, for texts) much higher quality animations, than in the original content, can be easily added to it, using VIM automatic animation possibilities and tools.
v. Translation into VIM allows for an automatic resealing of the content—to the requirements of the wireless device used. This feature is especially important, since most of the content created, for example, in Flash, was aimed for the Internet applications. Without rescaling this content cannot be used in the wireless world.
   Translation of VIM into Other Formats

VIM represented images can be translated into various conventional formats. In particular, VIM can be translated into vector formats, like SVG or Flash, just by dropping the VIM features, not existing in these formats (in particular, Color Profiles, Area Color and Patches). Usually, this translation reduces VIM image quality, since conventional vector formats do not poses VIM representation capabilities.

A process of conversion of VIM layers into raster layers is described in detail in (First part). These raster layers can be further used in conventional raster animation formats.

VIM animations can be translated into conventional video formats (like MPEG) without quality reduction but usually with a dramatic increase in data size. However, VIM specific motion information can be used to improve MPEG compression, in comparison with the conventional MPEG creation tools, as described below.

Additional Possibilities of VIM Format

In some embodiments of the invention, VIM images may be rescaled to any desired size by mathematically recalling the geometric parameters of the VIM elements. Optionally, when desired for reducing storage space and/or smoothness of view, a filtering of the VIM elements that become visually insignificant in the new screen-size, is performed.

Optionally, in adapting a VIM image to a specific display size, the authoring tool performs both a rescaling and a special image enhancement for the new (small) screen size, as described below.

The VIM format optionally combines CORE images and their parts into a virtual 3D animated world. Optionally, no additional structures, except the CORE images themselves, are used to represent three-dimensional geometry and movements of the objects in the VIM virtual world. Depth information is optionally associated with the CORE models themselves, and thus CORE representation of a visual object serves both as its geometric model and as its “texture chart”. Animation of a CORE object is just a coherent motion of its CORE models. In some embodiments of the invention, compact mathematical expressions of geometry and motion, are incorporated into VIM format. In particular, basic geometric primitives for a 3D—geometry and “skeletons” for objects animation are included into VIM).

Rendering of a VIM virtual world, as seen in a certain moment from a prescribed position, is very efficient, since it involves only CORE data (which represent images, depth and motion data in a strongly compressed form). This includes, in particular, computation of actual position of the objects on the screen, occlusion detection and “z-buffering”. In the process of a construction of the VIM virtual world the depth and the motion information can be either inserted interactively by the operator, or captured automatically, using any conventional depth detection and motion tracking tools.

Transcoding of Motion Images

The aim of a transcoding is to provide the best fitting of the original image or motion sequence to the intended transmission mode and to the target play-back device. This concerns the transmitted data volume, the image size and quality, the number of frames in a motion sequence, etc. One of the most important applications concerns transcoding of motion image sequences to various kinds of wireless devices, specified by a very small screen size, by strong limitations of the processing power and by a very low transmission bit-rate.

The present invention provides an efficient method for transcoding of motion image sequences, based on identification of the image areas, where a relative motion from frame to frame is small. Then the motion in the identified areas is neutralized, and a new image sequence is produced, containing only “large” motions. The decrease of the visual quality is usually small especially for small screens of wireless devices.

Using this new sequence as an input to conventional motion compression methods, like MPEG or Animated GIF, strongly improves the images quality and compression ratio.

Notice, that for main conventional motion image formats, like MPEG or Animated GIF, geometrically small motion may produce a serious drop in compression and in image quality. Consequently, elimination of small motions in many cases strongly improves compression and visual quality.

Alternatively, or in combination with a small motion elimination, a sequence with a smaller number of frames can be produced, which conveys in the best way the original motion.

Specific Implementations of the Small Motion Detection

If the input motion sequence is given in VIM/CORE animation format, the motion analysis is optionally performed on the level of the VIM/CORE motion parameters. In particular, the parts of the Skeleton can be identified, whose motion is smaller than a certain threshold. Then the motion of these skeleton parts is neutralized, which causes a required neutralization of the pattern motion in the corresponding parts of the image.

This method can also be applied when the input motion sequence is given in one of the conventional vector formats, like Flash, SVG, VRLM, MPEG-4 AFX etc. Namely, the relative change of the motion parameters is analyzed. If it is smaller than a certain threshold, then the change of these specific parameters is neutralized, which causes a required neutralization of the pattern motion in the corresponding parts of the image.

If the input is AVI, Animated GIF or any other raster format, then an identification of the image parts with a small motion is optionally performed by any conventional motion detection method. The identified motion vectors are compared with a certain threshold, and those, that are smaller than the threshold, are marked. The corresponding image areas are identified as the “small motion” regions.

In some embodiments of the invention, the following steps are performed in detecting motion:
Identification of the parts of the screen, where the motion of image patterns between one frame to another is relatively small.
Replacement of the corresponding parts of the subsequent frames with the parts, taken form the first frame in the sequence.
At each part, identification of the moment (frame), when the accumulated motion becomes relatively big.
Restoring of the actual frame parts at such moments

These steps produce a new image sequence, where relatively small motions of the patterns are “neutralized”. This new sequence may be either:
Used as it is.
Coded with one of conventional methods (MPEG, Animated GIF, etc.).
Sub-sampled, in order to produce a sequence with a smaller number of frames, which conveys in the best way the original motion.
   Alternatively, in each step of the above process, the next frame can be compared with the new frame, created in the previous step.
   VIM/CORE Based Small Motion Detection in Raster Video-Sequences

In a preferred implementation of the method the motion identification is based on transforming the subsequent frames to the VIM/CORE format, and identification of a relative motion of each VIM/CORE Elements. Specifically the method comprises the following steps:
Transforming the subsequent frames to the VM/CORE format
For each VIM/CORE Element on a certain frame, searching for a similar Element on the subsequent frame. The search is restricted to a relatively small area, bounded by the maximal allowed Element replacement. Both geometric and color parameters of the candidate Elements are compared with those of the original one, to improve reliability of the identification
Identifying the Element's motion vector, on the base of comparison of the geometric and color parameters of the original Element and the “moved” one, identified on the next frame
Marking all the VIM/CORE Elements, for which the identified motion vector is smaller than the fixed threshold
Identifying the image areas, containing only marked Elements, as the “Small Motion Areas”
Optionally, the “backward comparison” of the next frame with the previous one can be performed, and “backward motion vectors” can be created. Then the “Small Motion Areas” are identified, taking into account both forward and backward motion.

Motion vectors, found for certain VIM/CORE Elements, can be used as a prediction, to simplify a search for the other Elements.

Identification of the “Motion Rectangle”

It may be important not only to identify the “Small Motion Areas” on the image, but also to enclose the “Big Motion Regions” inside a possibly small rectangle. Then in many motion image formats (in particular, VIM/CORE, MPEG4, SVG, Animated GIF etc.), only this rectangle can be transmitted and refreshed, instead of the entire frame, thus providing for a serious data volume reduction.

As the “Small Motion Areas” and the “Big Motion Regions” have been identified, the “Motion Rectangle” can be found by the following procedure: the “Big Motion Regions” are scanned (via a certain grid, for example, the original pixel grid). In the scanning process the maximal and the minimal values of the screen coordinates are memorized and updated at each grid point. The final values of these maximal and minimal values of the screen coordinates form the coordinates of the contour of the Motion Rectangle.

In another implementation not one, but possibly several Motion Rectangles can be identified. While one Motion Rectangle is better adapted to Animated GIF and other similar compression schemes, several Motion Rectangles are well adapted for MPEG and similar compression formats.

Finding “Representing Frames”

“Representing Frames” are those where the accumulated motion of a certain image region is bigger than a predetermined threshold.

Each of the methods described above for a “Small Motion Detection”, can be applied also to finding “Representing Frames”. In vector formats the frame is identified as a “Representing” one, if the relative change of one of the vector motion parameters (in particular, of the Skeleton), in comparison with the previous “Representing Frame”, is larger, than a certain threshold. In raster formats, motion between consequent frames is found by one of the methods, described above: Than the accumulated motion between the current frame and the previous “representing Frame” is found. If in a certain area this accumulated motion exceeds the threshold, the new “Representing Frame” is chosen.

VIM based Small Motion Detection

As explained above, VIM/CORE motion detection is based on comparing positions and parameters of VIM/CORE Elements in subsequent video frames. This approach involves a search of candidate “moved” Elements on the next frame around the original Element on the current frame. However, for “small motion” detection, the search can be restricted to a relatively small area, bounded by the maximal allowed Element replacement. Another important simplification comes from the fact that in cases where no similar Element has been found, the original one is marked as having a “big motion”. This allows one to avoid a difficult comparison between distant Elements.

In some embodiments of the invention, subsequent frames are transformed into the VIM/CORE format in a straightforward way. Optionally, in order to simplify the comparison of the VIM/CORE Elements between frames, the same tuning parameters of the VIM Transformation are used in adjacent frames.

For each VIM/CORE Element on a certain frame, a search is performed for a similar (moved) Element on the subsequent frame. The search is optionally restricted to a relatively small area, bounded by the maximal allowed Element replacement.

In some embodiments of the invention, the search is performed in stages. First, a “filtering” operation is performed. Only “strong” VIM/CORE Elements are allowed to participate in the search. “Strong” are those Elements, whose color differentiation from the background is sufficient. For Patches, their central color optionally differs from the background more than by a fixed threshold. For Edges the difference between the colors on both sides is compared with the threshold, and for Ridges the difference of the central color from the background is compared with the threshold. Too short Edges and Ridges may be also excluded from the search.

Then, for each Element of the current frame, all the elements of the same type (Edges, Ridges or Patches, respectively), whose distance form the original Element does not exceed a fixed threshold S, are identified on the next frame. For Edges and Ridges this is done locally, via scanning a sequence of points on the Line. For each identified “candidate” Element on the next frame, its parameters are compared with the parameters of the original one, to improve reliability of the identification. This concerns geometric parameters: direction of the Line, width of the Color Profile, and color parameters of the Profile. If the discrepancy of the parameters is within a fixed threshold D, for Patches the procedure is completed, and the candidate Patch on the next frame is marked as a motion of the original one. For Edges and Ridges the local procedure is “expanded” along the Line, and the parts of the Lines are marked, which are considered as a motion of one another. In some embodiments of the invention, the motion vectors produced for the previously processed elements, are used in processing the new ones: the search is first performed in the area, predicted by the motion vectors of the previously processed (neighboring) elements.

Identifying Element's Motion Vectors

Identifying the VIM/CORE Element's motion vectors is performed on the base of comparison of the geometric and color parameters of the original Element and the “moved” one, identified on the next frame. For Patches, the motion vector is the vector, joining the center of the original Patch with the center of the “moved” one. For Edges and Ridges, multiple motion vectors are constructed along the Line. Locally, at each “scanning point” on the original Line, a point is found on the “moved” Line, where the geometric and color parameters are most similar to those at the original point.

Marking VIM/CORE Elements According to Their Motion

Marking is performed for all the processed VIM/CORE Elements. For those VIM/CORE Elements, for which the “moved” Element has been found on the next frame, the motion vectors are compared with the fixed threshold M. If the identified motion vector is smaller than M, the Patch, or the scanning point on an Edge or on a Ridge, is marked as “Small Motion Element”.

The VIM/CORE Elements, for which no “moved” Element has been found on the next frame, are marked as “Big Motion Elements”. The same marking get the Elements, for which the “moved” Element has been found, but the motion vector is larger than M. As far as Characteristic Lines are concerned, only some parts of them may be marked as “Big Motion Element Parts”.

Completion and Filtering of the Identified Motion

Some filtering of the detected motion can strongly improve the performance of the method.

An entire Characteristic Line, or its major part, may be marked in this step as a “Big Motion Element Part”, or a “Small Motion Element Part”, according to the relative length and density of the originally marked “Big Motion Parts”. This step eliminates “disconnecting” moving objects.
An entire image region may be marked in this step as a “Big Motion Region”, or a “Small Motion Region”, according to the relative length and density of the marked “Big Motion Parts”. This step neutralizes small motions in dense image areas, like the background in sport movies.
Conversely, a relatively small motion of a long line can be marked as a “Big Motion”, according to the specifics of a human visual motion perception.

Small motion and big motion images are optionally identified as the image areas, containing only Elements, marked as the “Small Motion Elements” or “Big Motion Elements” respectively. Identifying the Motion Rectangles is performed, as described above.

Producing Motion Rectangles and motion cancellation on the rest of the image, as described above, may produce undesired discontinuities inside the images. In some embodiments of the invention, to eliminate this effect, an image warping is performed in a strip around each of the Motion Rectangles. Geometrically, this warping follows the direction of the Characteristic Lines on the image. The parts of these lines inside the Motion Rectangles move according to their detected motion, while their parts on the rest of the image are still. The parts of these lines inside the above strip interpolate this motion, and the warping optionally follows these parts.

Using Motion Information to improve MPEG Compression

Motion information, obtained, as described above, can be used in two ways in order to improve MPEG video-compression (as well as the performance of other video-compression methods, based on motion estimation).

First, the original video-sequence can be replaced by the new one, as described above, and then the compression is applied to a new sequence. Elimination of “small motions” and a “motion noise” usually strongly increases the compression ratio of MPEG, GIF and similar methods of video compression.

Second, the motion information, obtained, as described above, can be used directly in the “motion estimation” part of MPEG compression. It provides a very important motion information near edges (where the conventional methods usually fail), and in this way strongly increases visual quality of the compressed video-sequences and the compression ratio.

Independent Use of VIM Elements

VIM image representation, as described in Patent Applications mentioned above, gives a powerful tool for various image processing, coding, transmission and rendering operations. Each separate element of VIM represents a serious innovation and can bring serious imaging benefits, being used separately from other elements of VIM, or in combination with not-VIM conventional imaging tools. The Characteristic Lines, together with their Signatures (Color Profiles), are disclosed in the U.S. patent application Ser. No. 09/716,279. The U.S. patent application Ser. No. 09/902,643 and the PCT Application PCT/IL02/00563 disclose the CORE image representation, and specifically VIM representation and format, which, in addition to Characteristic Lines, use the Proximities and the Crossings of Characteristic Lines, as well as the Background and the Patches. As understood from these patent applications, each of these elements may used separately from other elements of VIM, or in combination with non-VIM conventional imaging tools.

Characteristic Lines and Color Profiles (Cross-Sections)

Visual Effects at the Line Visual Patterns

Cross-section of a characteristic line captures brightness (or color) pattern in a vicinity of the line. These cross-sections are decisively important in a visually faithful reconstruction of high quality images. In particular, cross-sections, as a part of CORE (VIM) representation, provide solutions to the following problems:
1. Accurate capturing and reconstruction of a width and a sharpness of an edge (or of another characteristic line).
2. Accurate capturing and reconstruction of additional important visual patterns along edges, like those produced by high-pass and low-pass filters and “un-sharp masking”.
3. Anti-aliasing. Elimination of aliasing effects in CORE representation is a byproduct of a use of correct cross-sections of characteristic lines.
4. Compensation for background changes: use of cross-sections eliminates a “cartoon-like” visual appearance of an object cut-off and moved to a new background.
5. Compensation for zoom-in and zoom-out: use of cross-sections allows us to keep natural shape and sharpness of edges and other characteristic lines in these operations.
6. Image adaptation to special viewing requirements: a proper tuning of cross-sections optimizes a visual appearance of images on very small (cellular phones) or very big (highway advertising) screens, as well as in other specific visual conditions.
7. Accurate capturing and reconstruction of illumination and shadowing effects along the visible contours of three-dimensional objects.
8. Accurate capturing and reconstruction of visual effects along the visible contours of three-dimensional objects, resulting from a 3D-motion (rotation etc.).
   Each of these capabilities can be used either for a visually faithful representation and reconstruction of an actual image, or for a creation of new desired effects along the contours of objects on the image (or along any curvilinear pattern).
   In each of the mentioned above applications of Color Profiles, they can be applied either in a framework of a complete CORE (VIM) representation, or in a combination with not-VIM conventional imaging tools. In particular, the entire Image may be represented by a bitmap, while its edges are represented by Characteristic Lines with Profiles. Merging these two representations can be achieved by a weighted sum of them, with the weight function of the Characteristic Lines equal to one in their neighborhood of a prescribed size, and decreasing to zero in a larger neighborhood.
   Alternatively, completely synthetic images can be created by using conventional tools like SVG “color gradients”, while the boundaries are represented by VIM Edges with appropriate Color Profiles. All the effects and capabilities, described above, are relevant in this case. Various “intermediate” variants can be used.
   CORE technology provides tools for a very accurate detection of actual cross-sections of characteristic lines, for their compact representation, as well as for easy and intuitive interactive manipulation of cross-sections.
   Illumination and Shadowing Effects

The illumination and shadowing effects of the VIM lines may be used even without other VIM elements and/or formats, for example with conventional non-VIM tools. Proper tuning of the cross-sections of the boundaries of the illuminated and the shadowed areas allows a user to create various rather subtle but visually important effects, like light refraction, optical “caustics” etc. The fact that visually meaningful CORE models represent by themselves the three-dimensional geometry of the VIM objects allows for easy interactive or automatic creation of “fine scale” illumination and shadowing effects, which are very difficult for capturing by conventional tools. For example, illumination and shadowing of leaves in the wind can be easily produced in the VIM structure, since each leave is typically represented by a combination of separate CORE models, and their approximate mutual position and occlusion relations can be reconstructed from the CORE image. Another example is a complicated pattern of clothes folds. Its CORE representation by itself allows for an easy interactive reconstruction of the 3D geometry with accuracy, sufficient to produce realistic illumination and shadowing effects. In some embodiments of the invention, these patterns are used locally, at prescribed parts of the image, while in other parts of the image, other representation methods are used.

Dithering

One operation in preparation of images for a display on a very small screen is dithering: it allows one to translate a color or a gray scale image with an image with only white and black colors per pixel (or in any required image type with a smaller number of bits per pixel).

In some embodiments of the invention, the VIM information of the image is used to improve image quality. In one embodiment, the following steps are performed during dithering of an image:
1. VIM Lines are filtered according to their length and color profile. Only the Lines longer than a prescribed threshold are preserved, while the other are deleted. Then the Lines are filtered out, whose Color Profile has a jump of the color (brightness) between the two sides and between the sides and the central color (brightness) smaller than a prescribed threshold.
2. If the Line is Edge, on the dark side of the Edge, black color is chosen for pixels, while on the brighter side of the Edge the white color is chosen (up to a prescribed distance from the Edge. For pixels outside this distance one of the conventional dithering schemes is applied).
3. If the Line is Ridge, the color (brightness) is separately chosen also for the pixels inside the characteristic strip, according to the central color (brightness) of the Color Profile.

Alternatively, on the sides of the Lines more complicated brightness and color patterns are used (and not only black and white pixels), according to the limitations of the display. Experiments show that stressing the “sell-expressed” Lines, as described above, strongly improves visual quality of small size images.

In dithering operation the Lines of the VIM representation are used in combination with a raster (and, possibly, a very law quality and size) image. In the same way the information, provided by other VIM elements, can be used in dithering. In one embodiment the pixels color (brightness) is stressed near “well-expressed” VIM Patches.

Proximities and Crossings

Proximities and Crossings are disclosed in U.S. patent application Ser. No. 09/902,643 as one of the components of the CORE (VIN) representation. Proximities and Crossings of conventional lines (for example, Curve2D of MPEG-4, or of other types of curves, appearing in Imaging applications) can be used independently of the other elements of VIM.

It is well known that human visual sensitivity to the geometric shapes is much higher for “geometrically near” visual patterns than for isolated ones. Rather strong geometric distortions in a position of a line, passing far away from other patterns, will not be perceived at all, while even a small distortion of one of a couple of closely neighboring lines immediately “pops to the eyes”. This fact is taken into account in the VIM structure already in the explicit definition of the Crossings and Proximities of the Lines. It explicitly appears in the VIM Coding, as disclosed in the (first part). The geometric parameters of the Terminal Points, representing Proximities, Crossings and Splittings, are stored with a higher accuracy than that of the usual Line Points. In Advanced Coding mode the “Aggregated Crossing” and the “Aggregated Color Profile” are used, which capture the most common cases of VIM elements visual aggregation. Also in Lines quantization their mutual position can be taken into account. All these techniques can be applied also to non-VIM curves, improving their visual quality and compression.

Patches

Patches can be used with any other type of images, creating various visual effects and improving image resolution and quality. In particular, Patches can be combined with conventional raster or vector images, providing, in particular, the following effects:
Creating fine scale textures
Improving quality and resolution of “natural” or “synthetic” textures
Producing new types of “Procedural Textures” (as those used in MPEG4)
Serving as “Radial Gradients” (similar to used in SVG), as their size is not assumed to be small
   Background (Area Color)

CORE (VIM) Background can be used for a representation of image areas with a relatively slowly changing color. However, the resolution of the VIM Area Color is much higher than that of conventional synthetic tools, like “Gradients” of SVG or of MPEG4. As a result, VIM Area Color (Background) can be applied separately or in combination with conventional imaging tools, as follows:
It can be used for a representation (or a creation) of intermediate scale images, without any other CORE (VM) Model. The resulting images are typically very strongly compressed.
It can be combined with conventional raster or vector images, in order to correct the color in the image areas with a relatively slowly changing color.
It can be used as a Procedural Texture (or as a part of Procedural Texture).

It can be used to solve a “Blocking Effect” problem of JPEG or (basic profile) MPEG.

Indeed, the “Blocking Effect” appears as a result of a quantization of the low frequencies Fourier Coefficients on the basic 8×8 pixels (or 16×16 pixels) blocks of JPEG and MPEG compression. Since the human visual perception is very sensitive to image distortions along regular patterns, as the grid of 8×8 pixels (or 16×16 pixels) blocks, the quantization error “pops to the eyes”. The following procedure solves this problem: first, the image is represented by CORE (VIM). The background (Area Color) of this representation is subtracted from the original image, and the difference is represented by JPEG (MPEG for a video-sequence). Since the subtraction reduces significantly the dynamical range of the low frequencies Fourier Coefficients, their quantization becomes much less dangerous.
This method can be further improved by applying a “mask”, which forces the difference image to be zero (or small) in a prescribed neighborhood of the Edges and Separating Lines. This is done in order to compensate for possible geometric inaccuracies in the Edges and Separating Lines position. These inaccuracies (being visually insignificant) may cause for a big difference between the image and the Area Color in a neighborhood of the Edges and Separating Lines,
   Interaction of VIM with Other Image Formats

Vector formats like SVG and Macromedia's Flash contain vector image elements, which can be used in combination with one or several VIM elements, or in combination with the entire VIM representation. This includes, in particular, “Gradients” and “Procedural Textures”, as described above, but also the Curves and Vector Animated Characters of these formats. In particular, using VIM Color Profiles can dramatically improve the quality of the vector Characters and of their animations, by the means described above.

Images, using VIM format or some parts of it, can be produced in various ways. In particular, such images can be produced by conventional graphic tools in combination with interactive or automatic addition of VIM Elements. Usual Edges (or synthetic lines) can be combined with VIM Color Profiles, providing high quality synthetic image elements.

Synthetic VIM images or combinations of Synthetic VIM with other formats may be used. An important example is geographic maps, which normally can be represented with only a part of VIM elements (ines and Profiles and, in some cases, “Gradients”). VIM representation of geographic maps is achieved directly from their symbolic representation, without passing through raster images. The same concerns CAD-CAM images, where 3D VIM representation can be achieved directly from the CAD-CAM data.

Cartoon-Like animations produce another example, where partial VIM implementation (using only Lines with Color Profiles and Gradients) is very efficient. This restricted VIM format normally provides a very low bit rate of animations, while maintaining higher visual quality than in conventional formats.

VIM image representation can be implemented in the framework of MPEG-4 Format. Main VIM Elements are implemented by different MPEG Nodes (Curve2D, MPEG Point Sets, Gradients, BIFS, Skeleton and others). This provides a possibility to use them as a full VIM, or separately, or in combination with other MPEG elements, “Gradients”, bitmaps, video, animations, compression, sound, etc.

This implementation is important since it provides a natural framework, where VIM Elements can be used in various combinations with MPEG tools or other complying tools. This provides a specific implementation of each of the techniques, described above.

In addition, in the framework of the VIM implementation in MPEG-4, all the MPEG data compression tools can be applied to VIM elements (curves, point sets, animations etc.). All the MPEG animation tools can be applied to VIM elements. They can be combined with all the MPEG profiles, like video, animations, Sound and others.

In some cases there may exist certain overlapping between VIM Elements, that is, two or more different types of vector elements may be used to represent the same image representation. For example, Patches may be rather accurately represented by short Ridges (although this causes a decrease in compression). Short Ridges can be captured by Patches, with a better compression. Consequently, in some embodiments of the invention, a simplified VIM structure (for example, without Patches), is used. Also Color Profiles of Ridges and Edges may have some redundancy: Edges profiles can reasonably capture a Ridge, and a Ridge profile may faithfully capture an edge.

It is noted that the term “first” used herein, for example in the claims, is used to represent a specific object and does not necessarily relate to an order of objects. For example, a “first frame” may include and frame of a sequence of frames and may appear in s video stream after a “second frame”.

The term brightness used above refers to both gray scale levels in black and white images and to any color components of color images, in accordance with substantially any color scheme, such as RGB. It is noted that the present invention is not limited to any specific images and may be used with substantially any images, including, for example, real life images, animated images, infra-red images, computer tomography (CT) images, radar images and synthetic images (such as appearing in Scientific visualization).

The above description brings a specific implementation of the aspects of the present invention with relation to the VIM vector representation. It is noted that this example is brought only by way of example and that the present invention is not limited to any specific representation.

It will be appreciated that the above described methods may be varied in many ways, including, changing the order of steps, and/or performing a plurality of steps concurrently. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the limitations used in the claims. When used in the following claims, the terms “comprise”, “include”, “have” and their conjugates mean “including but not limited to”.

1. A method of generating a character from an image, comprising:
providing an image depicting a character;
identifying, automatically by a processor, characteristic lines in the image;
receiving an indication of a character to be cut from the image; and
suggesting border lines for the character to be cut from the image, responsive to the identified characteristic lines and the received indication.

2. A method according to claim 1, wherein the received indication comprises border lines at least partially surrounding the character.

3. A method according to claim 2, wherein suggesting border lines comprises suggesting based on identified characteristic lines which continue the indicated border lines.

4. A method according to claim 2, wherein suggesting border lines comprises suggesting based on identified characteristic lines which are substantially parallel to the indicated border lines.

5. A method according to claim 1, wherein the received indication comprises an indication of a center point of the character.

6. A method according to claim 5, wherein determining which pixels of the image belong to the character comprises determining based on identified characteristic lines surrounding the indicated center point.

7. A method according to claim 1, comprising displaying the identified lines overlaid on the image before receiving the indication.

8. A method according to claim 1, wherein suggesting border lines comprises suggesting a plurality of optional, contradicting, border lines.

9. A method according to claim 1, wherein suggesting border lines comprises suggesting at least a border portion not coinciding with an identified characteristic line.

10. A method according to claim 9, wherein suggesting border lines comprises suggesting at least a border portion which connects two characteristic lines.

11. A method according to claim 1, wherein the border portion which connects two characteristic lines comprises a border portion which has a curvature similar to that of the connected two characteristic lines.

12. A method according to claim 1, comprising generating a mold from the character by degeneration of the character.

13. A method of creating an animation, comprising:
providing an image depicting a character;
selecting a library mold character;
fitting the mold onto the character of the image; and
defining automatically a border of the character, responsive to the fitting of the mold to the character.

14. A method according to claim 13, wherein the selected library mold was generated from a character cut out from an image.

15. A method according to claim 13, wherein fitting the mold onto the character of the image comprises performing one or more of rescaling, moving, rotating, bending, moving parts and stretching.

16. A method according to claim 13, comprising identifying characteristic lines in the image and wherein fitting the mold onto the character comprises at least partially fitting automatically responsive to the fitting.

17. A method according to claim 13, comprising separating the character into limbs according to a separation of the mold.

18. A method according to claim 13, comprising defining a skeleton for the character based on a skeleton associated with the mold.

19. A method according to claim 13, comprising identifying the character in at least one additional image in a sequence of images.

20. A method according to claim 19, comprising identifying a movement pattern of the character responsive to the identifying of the character in the sequence of images.

21. A method according to claim 19, comprising identifying the character in at least one additional image of the sequence using the identified movement pattern.

22. A method of tracking motion of an object in a video-sequence, comprising:
identifying the object in one of the images in the sequence;
cutting the identified object from the one of the images;
fitting the cut object onto the object in at least one additional image in the sequence; and
recording the differences between the cut object and the object in the at least one additional image.

23. A method of creating an image, comprising:
generating, by a human user, an image including one or more lines;
defining, by a human user, for at least one of the lines, a color profile of the line; and
displaying the image with color information from the defined color profile.

24. A method according to claim 23, wherein defining the color profile comprises drawing by the human user one or more graphs which define the change in one or more color parameters along a cross-section of the line.

25. An image creation tool, comprising:
an image input interface adapted to receive image information including lines;
a profile input interface adapted to receive color profiles of lines received by the image input interface; and
a display adapted to display images based on data received by both the profile input interface and the image input interface.

26. A method of compressing a vector representation of an image, comprising:
selecting a plurality of points whose coordinates are to be stated explicitly;
dividing the image into a plurality of cells;
stating for each cell whether the cell includes one or more of the selected points; and
designating the coordinates of the selected points relative to the cell in which they are located.

27. A method according to claim 26, wherein selecting the plurality of points comprises points of a plurality of different vector representation elements.

28. A method according to claim 26, wherein dividing the image into cells comprises dividing into a predetermined number of cells regardless of the data of the image.

29. A method according to claim 26, wherein dividing the image into cells comprises dividing into a number of cells selected according to the data of the image.

30. A method according to claim 26, wherein dividing the image into cells comprises dividing into a hierarchy of cells.

31. A method according to claim 26, wherein stating for each cell whether the cell includes one or more of the selected points comprises stating using a single bit.

32. A method of compressing a vector representation of an image, comprising:
dividing the image into a plurality of cells;
selecting fewer than all the cells, in which to indicate the background color of the image; and
indicating the background color of the image in one or more points of the selected cells.

33. A method according to claim 32, wherein dividing the image into a plurality of cells comprises dividing into a number of cells selected according to the data of the image.

34. A method according to claim 32, wherein selecting fewer than all the cells comprises selecting cells which do not include lines of the image.

35. A method according to claim 34, wherein at least one of the lines states a color of the area near the line, in addition to the color of the line itself.

36. A method according to claim 32, wherein selecting fewer than all the cells comprises selecting cells which do not include other elements of the image.

37. A method according to claim 32, wherein indicating the background color of the image in one or more points of the selected cells comprises indicating the background color in one or more predetermined points.

38. A method according to claim 32, wherein indicating the background color of the image in one or more points of the selected cells comprises indicating the background color in a single central point of the cell.

39. A method according to claim 32, comprising explicitly stating the selected cells in a compressed format of the image.

40. A method according to claim 32, wherein a compressed format of the image does not explicitly state the selected cells.

41. A method of compressing a vector representation of an image, comprising:
receiving a vector representation of the image, including one or more lines;
dividing the line into segments; and
encoding one or more non-geometrical parameters of at least one of the segments of the line relative to parameters of one or more other segments.

42. A method according to claim 41, wherein encoding one or more non-geometrical parameters comprises encoding color information of a profile of the line.

43. A method according to claim 41, wherein dividing the line into segments comprises dividing into segments indicated in the received vector representation.

44. A method according to claim 41, wherein dividing the line into segments comprises dividing into segments which minimize the resulting encoded parameters.

45. A method according to claim 41, wherein encoding one or more parameters of at least one of the segments comprises encoding relative to a single other segment.

46. A method according to claim 41, wherein encoding one or more parameters comprises encoding a parameter of the color of the line.

47. A method according to claim 41, wherein encoding the one or more parameters comprises encoding a parameter of a profile of the line.

48. A method according to claim 41, wherein dividing the line into segments comprises dividing the line into a plurality of different segment divisions.

49. A method according to claim 48, wherein dividing the line into a plurality of different segment divisions comprises dividing the line into a plurality of segment divisions with different numbers of segments, in accordance with a segmentation hierarchy.

50. A method according to claim 48, comprising encoding at least one parameter of the line relative to segments of both the first and second divisions into segments.

51. A method according to claim 48, comprising encoding at least one first parameter of the line relative to segments of the first division and at least one second parameter relative to at least one segment of the second division.
